(19) United States
(12) Patent Application Publication
(10) Pub. No.: US 2004/0059802 A1
(43) Pub. Date: Mar. 25, 2004

(54) Modeling states and/or transitions in a computer system

(76) Inventors: Christian Jacquemot, Saint Germain Le Corbeil (FR); Dave Penkler, Claix (FR)

Correspondence Address: WAGNER, MURABITO & HAO LLP, Third Floor, Two North Market Street, San Jose, CA, 95113, US

(21) Appl. No.: 10/606,063

(22) Filed: Jun. 24, 2003

(30) Foreign Application Priority Data
Jun. 24, 2002 (FR) 0207798

(51) Int. Cl. G06F 15/177; G06F 12/00

(52) U.S. Cl. 709/220; 707/203

(57) ABSTRACT

Embodiments of the present invention provide a system and method of modeling a computer system. The computer system is modeled by a plurality of components and a plurality of interface enabling interactions between the components. A searchable tree data structure defining the components and the interactions between the components is generated. The method of modeling the computer system further comprises qualifying the searchable tree data structure as defining valid combination of the components.

The present invention relates to the modeling of a computer system, e.g. a networked computer system.

In published patent application WO/0184313 (and/or corresponding US 2002/0007468 A1), the applicant company has proposed a system and method for achieving high availability in a networked computer system. It has also proposed a system and method for using high-availability-aware components to achieve high availability in a networked computer system.

It has now been found of interest to model the platform and/or the applications which run on it, totally or partially. This invention offers various aspects of such a modeling, which is applicable independently of the high availability aspects. This invention also offers applications of such a modeling, optionally, as it will be seen hereinafter.

Generally, in one of its aspects, this invention offers a program product, comprising:

groups of data, in a common software language, each group of data comprising:

first data modeling components (software and/or hardware), and interactions between such components (e.g. interfaces),

second data modeling a software load, comprising a set of components and a set of interactions, as defined in said first data, and

first software code capable of interacting with the first and second data, for qualifying said second data as defining a valid combination of components.

The first data may include “version” data for the interaction data, and “version range” data related to component data, with the first software code checking that the version of an interaction lies within the version range of both components (e.g. a client and a server) cooperating through that interaction.

In another aspect, said group of data may comprise generic entities for the components, interactions and software load; the generic entities have predefined members; and the first and second data using such generic entities for representing the components, interactions and software load.

In still another aspect, the group of data (or a relevant portion of it) may be stored in accordance with a common tree structure. Third data may be provided for modeling configuration values for loading a software load as defined in the second data.

In still another aspect, fourth data may comprise platform update data for designating a configuration update, having has an update level, and the program product further comprises third software code capable of determining whether a transition to such a configuration update is authorized. A rollback may also be provided for.

All the data may be based on a common software language, which may be a markup language, e.g. XML.

Other alternative features and advantages of the invention will appear in the detailed description below and in the appended drawings, in which:

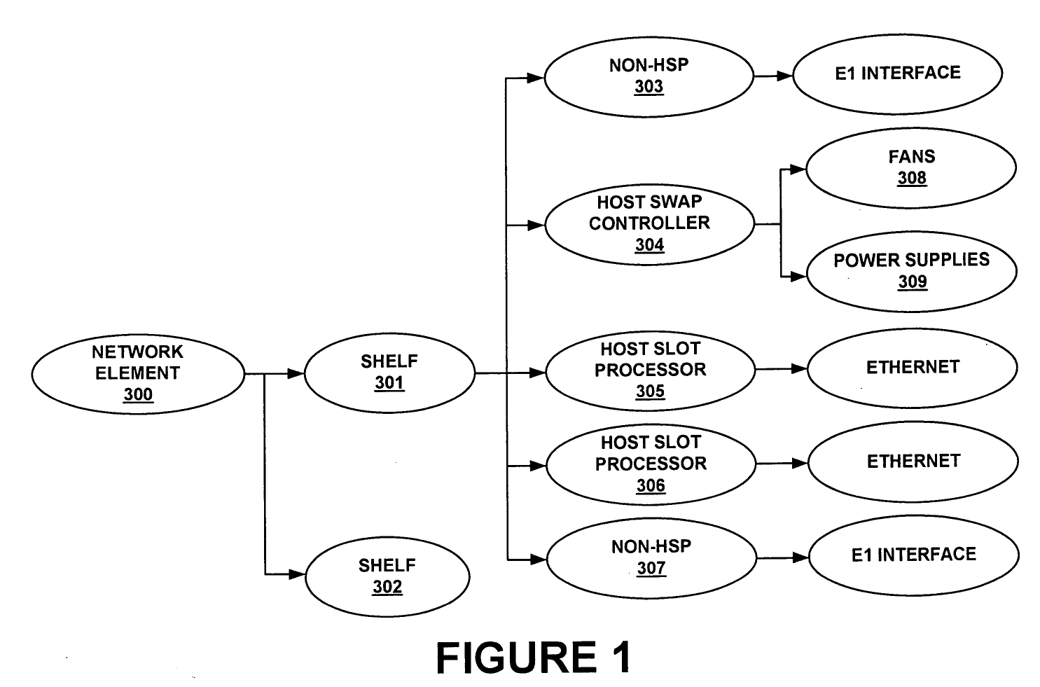

FIG. 1 is a tree diagram depicting an exemplary physical component hierarchy among hardware components in a networked computer system;

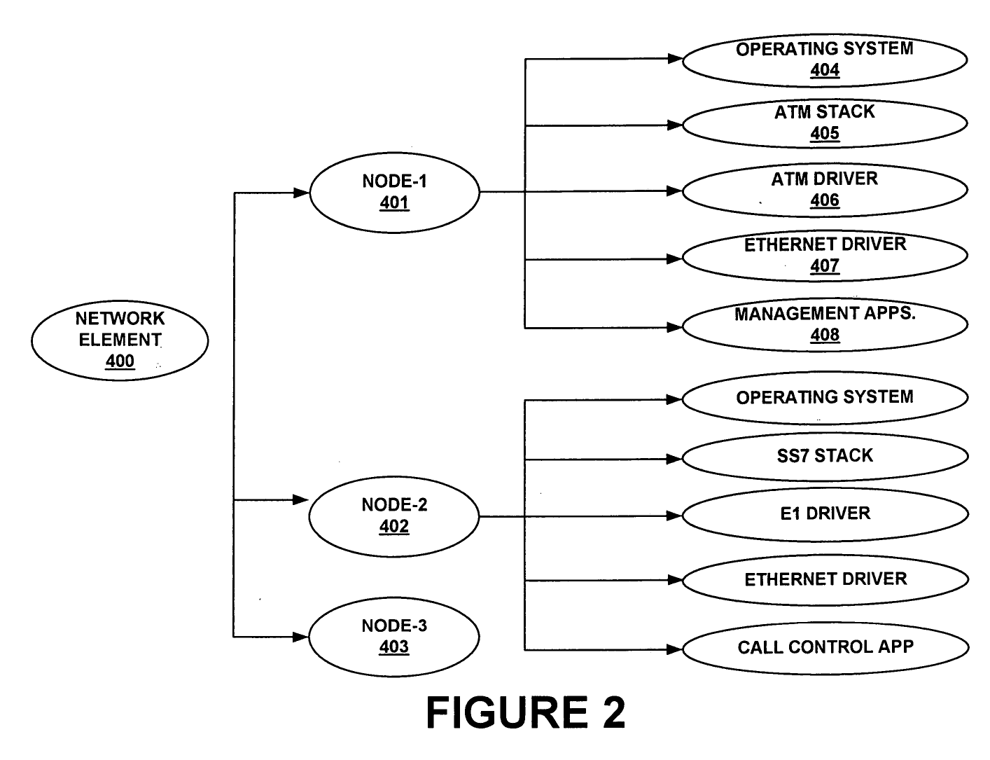

FIG. 2 is a tree diagram depicting an exemplary software component hierarchy among software components in a networked computer system;

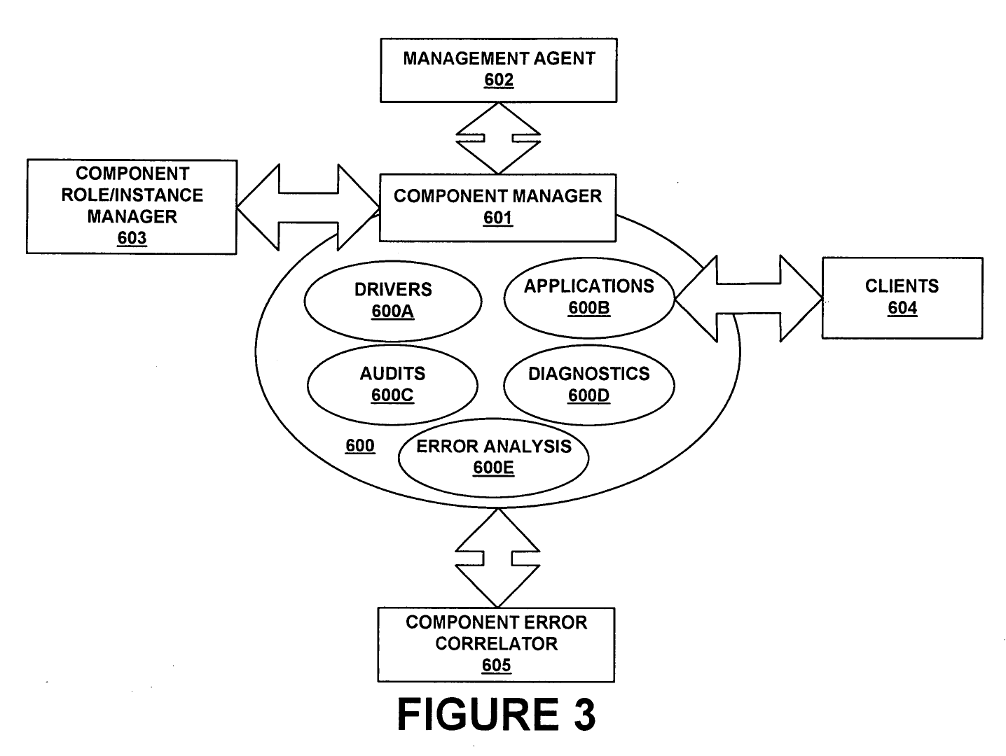

FIG. 3 is a representational diagram of an exemplary component that may be used in an embodiment of the present invention;

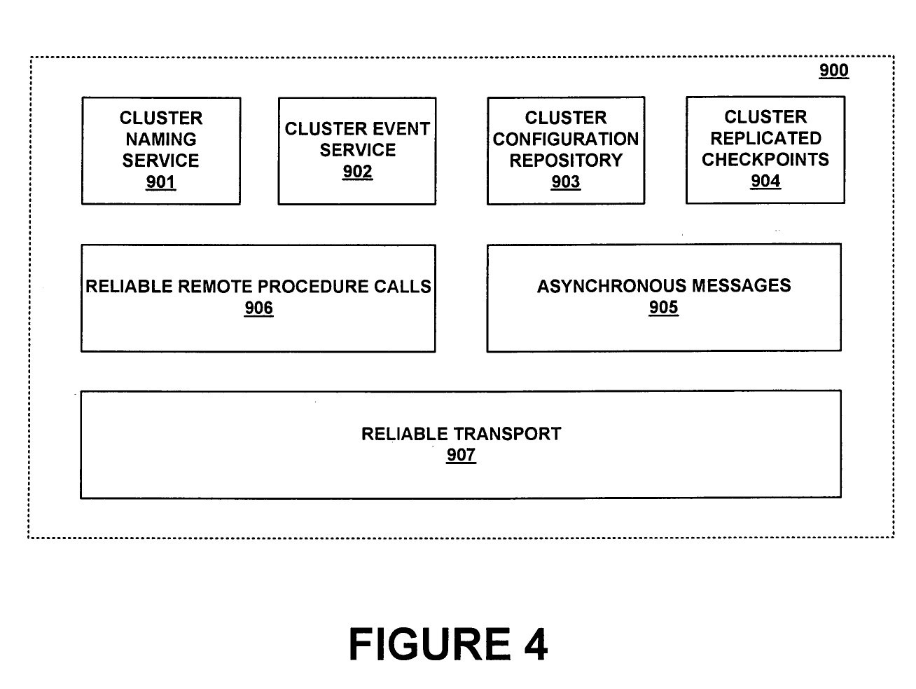

FIG. 4 is a representational diagram of one embodiment of distributed system services that may be used in an embodiment of the present invention;

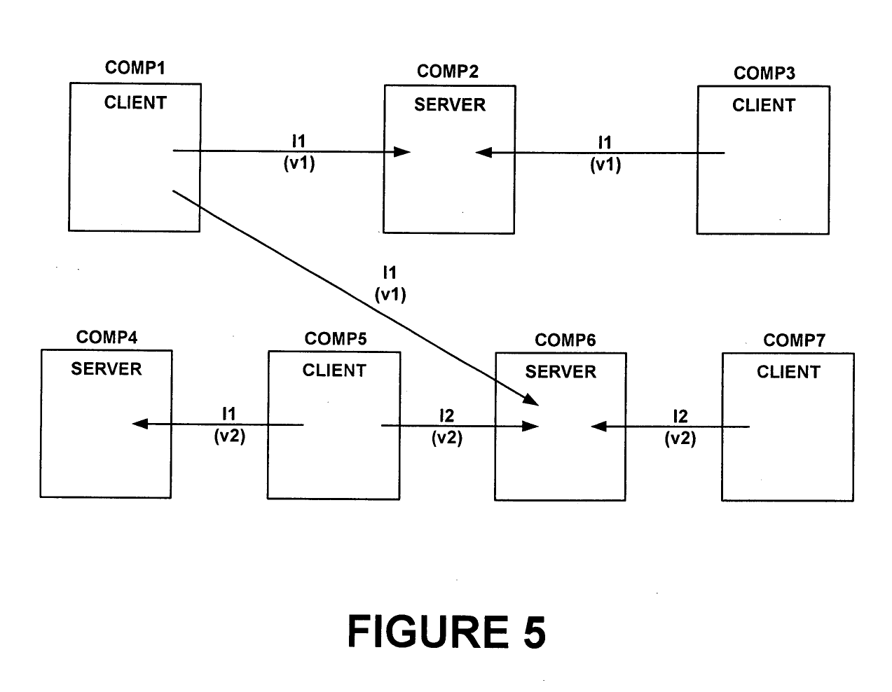

FIG. 5 illustratively shows software components, forming client/server combinations;

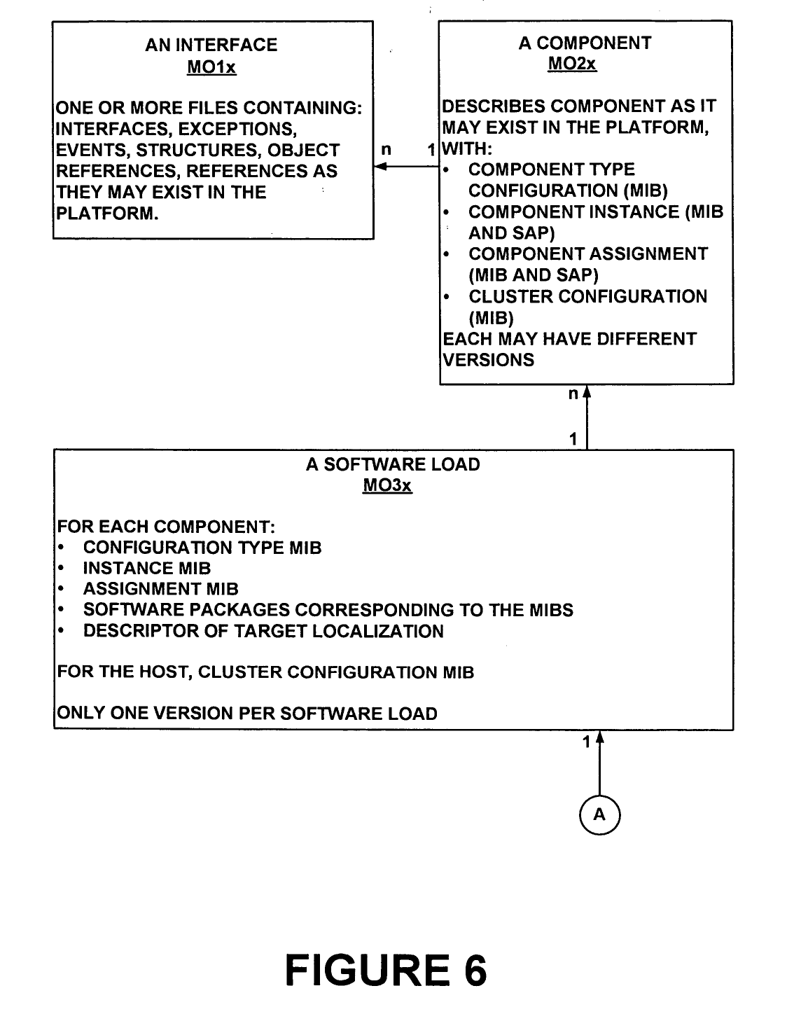

FIG. 6 shows an exemplary organization of model data, in an embodiment of this invention;

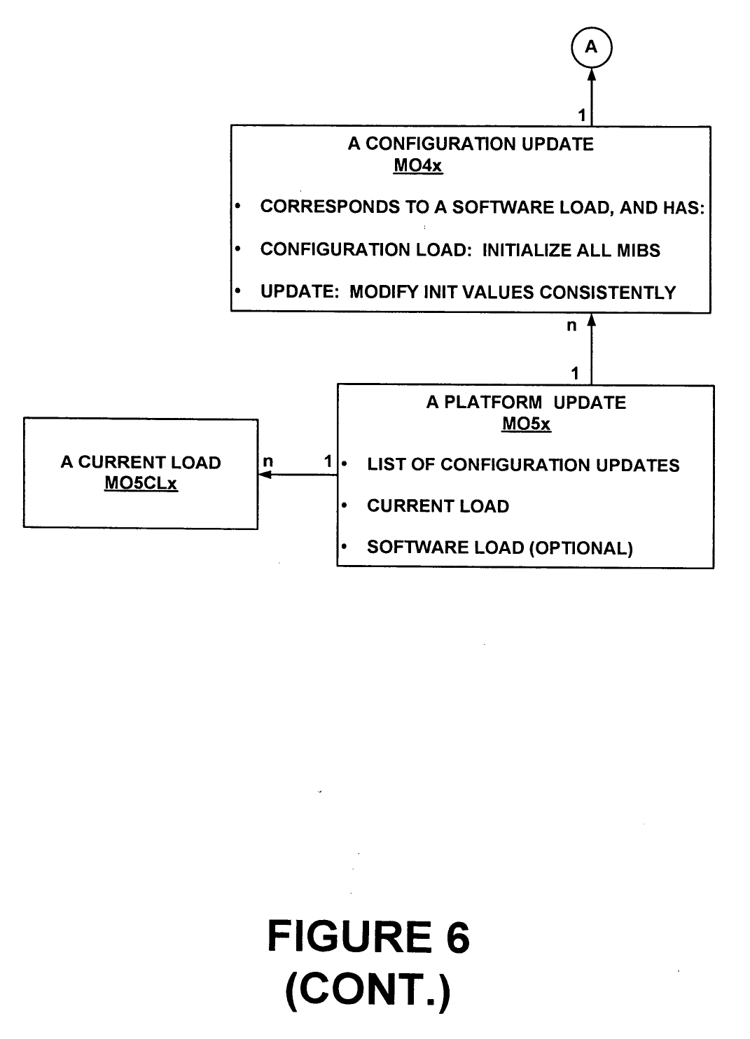

FIG. 7 is a flow-chart of an exemplary version attribute checking tool;

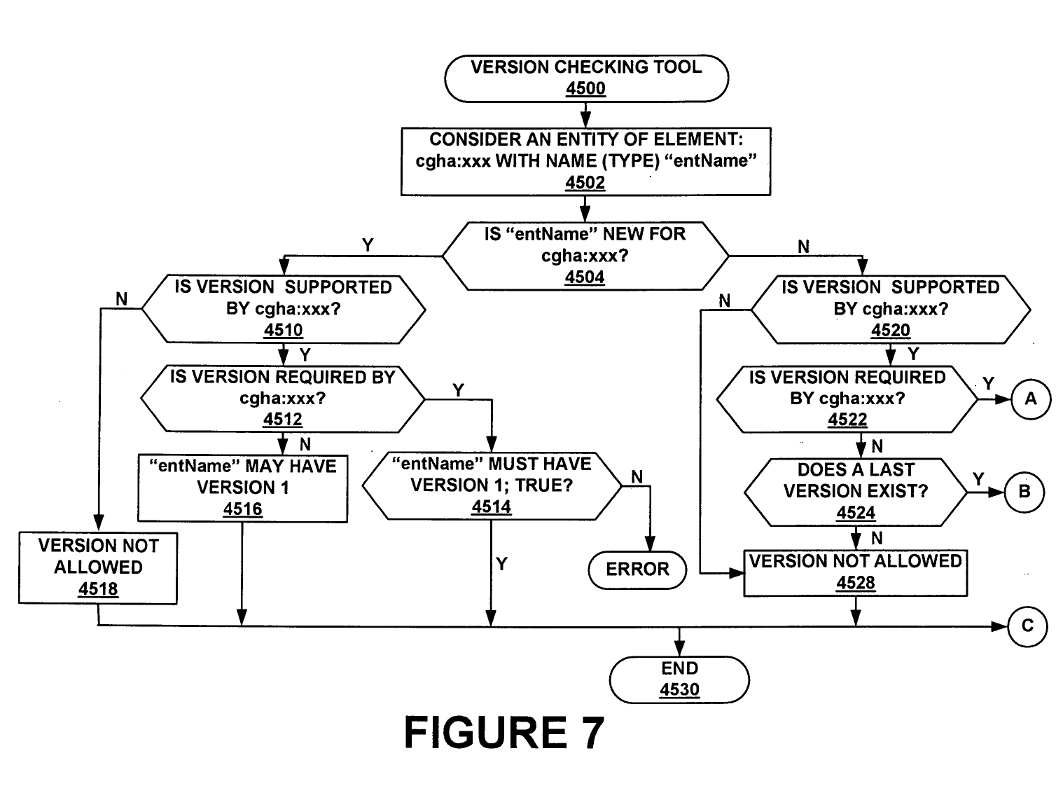

FIG. 8 shows an exemplary naming tree;

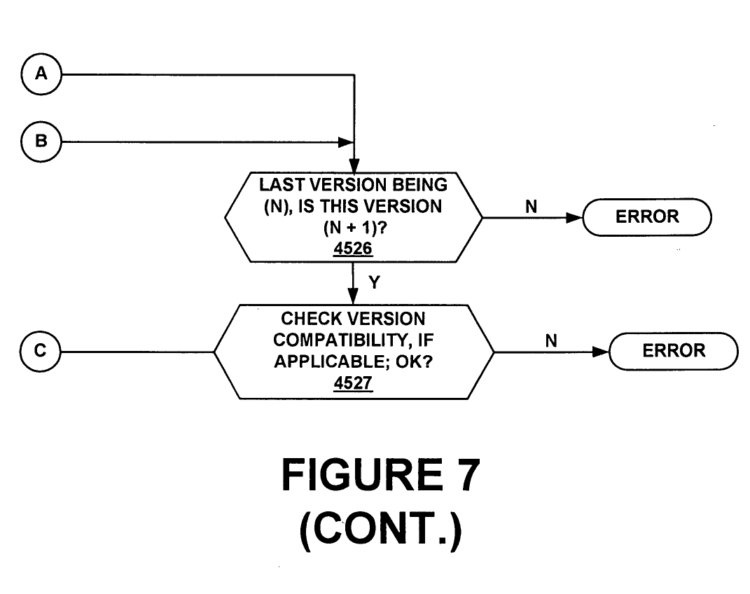

FIG. 9 is a block diagram of an embodiment of this invention, at the design level;

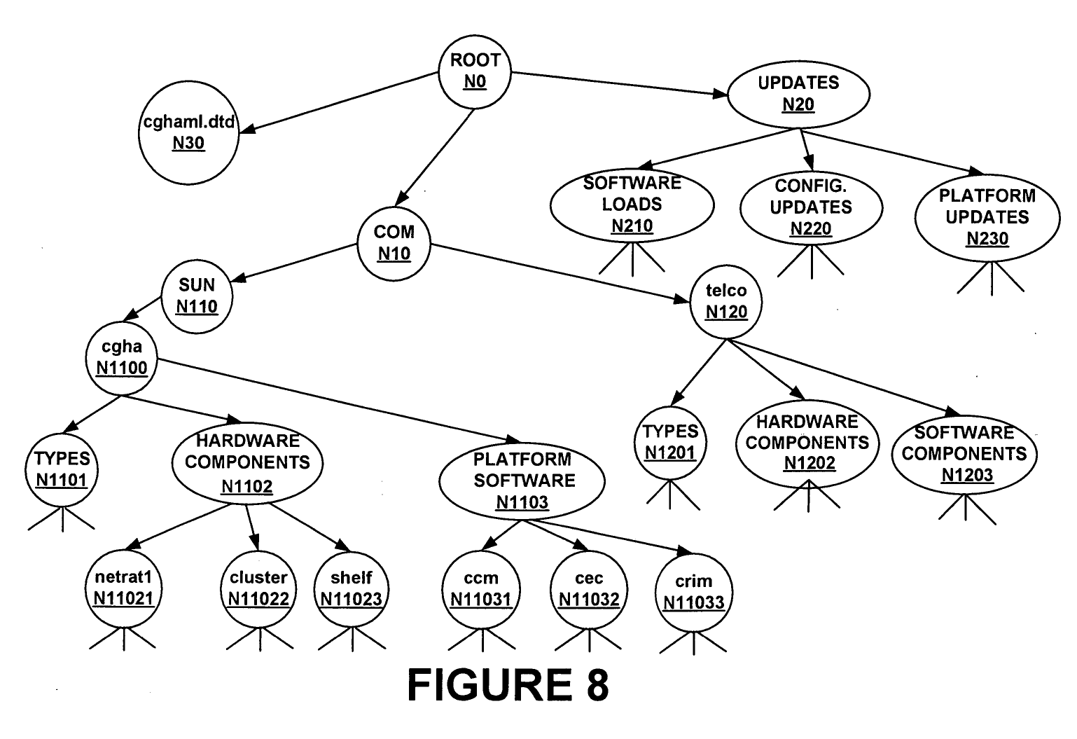

FIG. 10 is a block diagram of an embodiment of this invention, at the operational level;

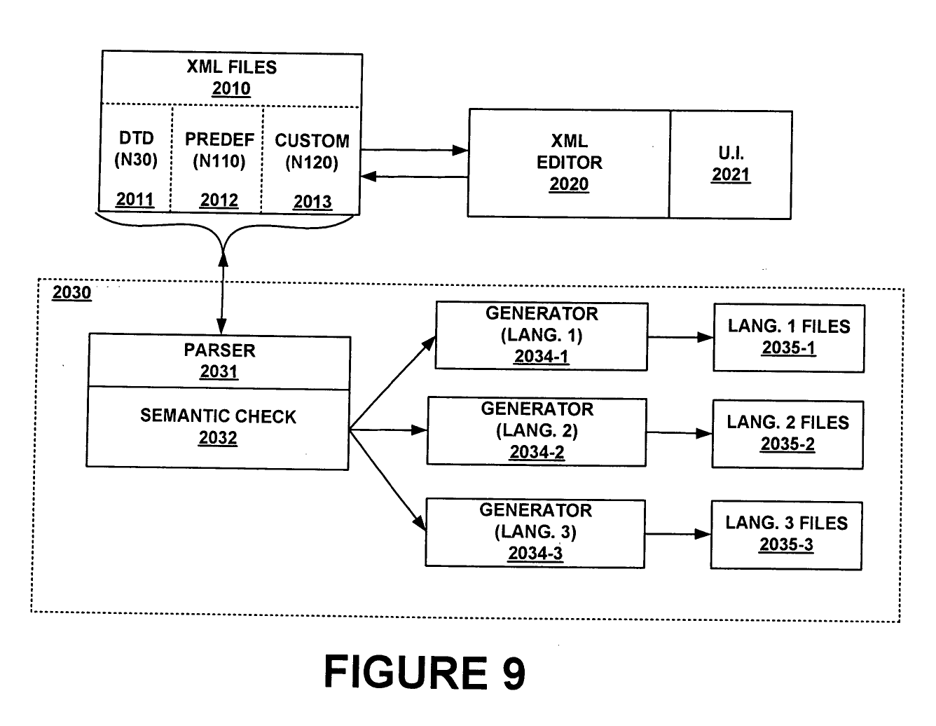

FIG. 11 is a flow chart of an exemplary tool for checking the accuracy of version value intervals;

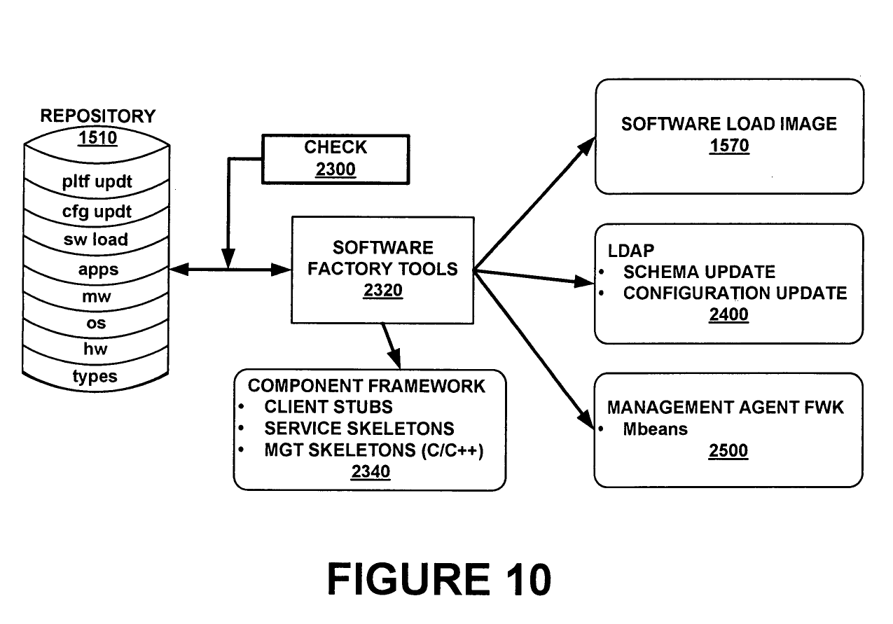

FIG. 12 is a flow chart of an exemplary tool for checking version consistency;

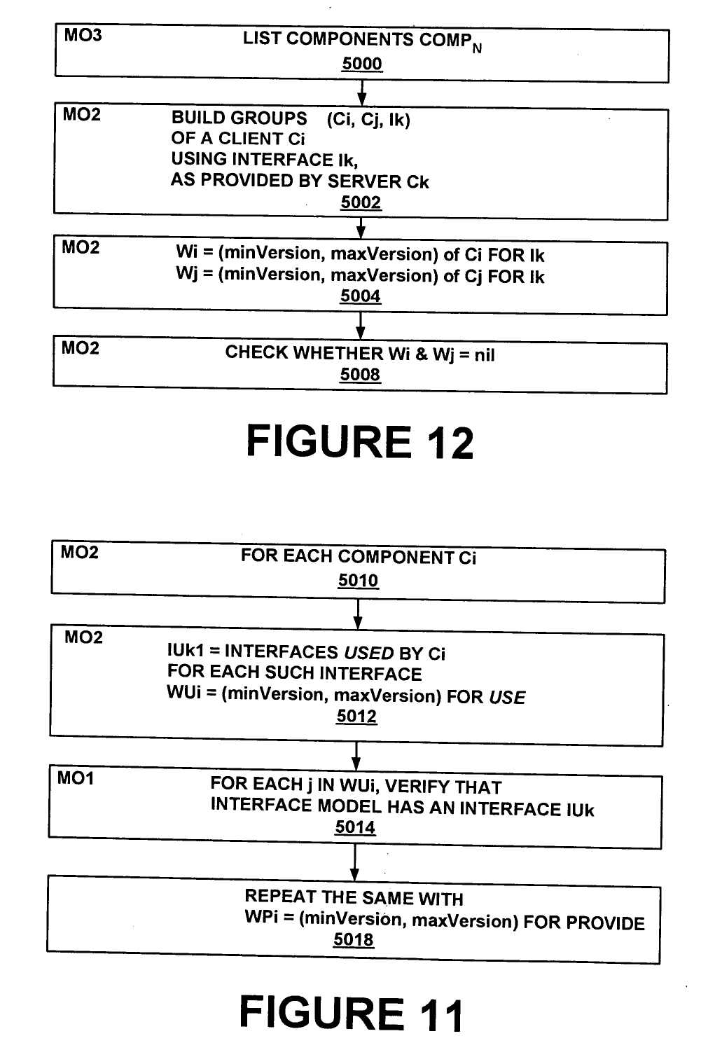

FIG. 13 is a flow chart of an exemplary tool for checking a configuration update;

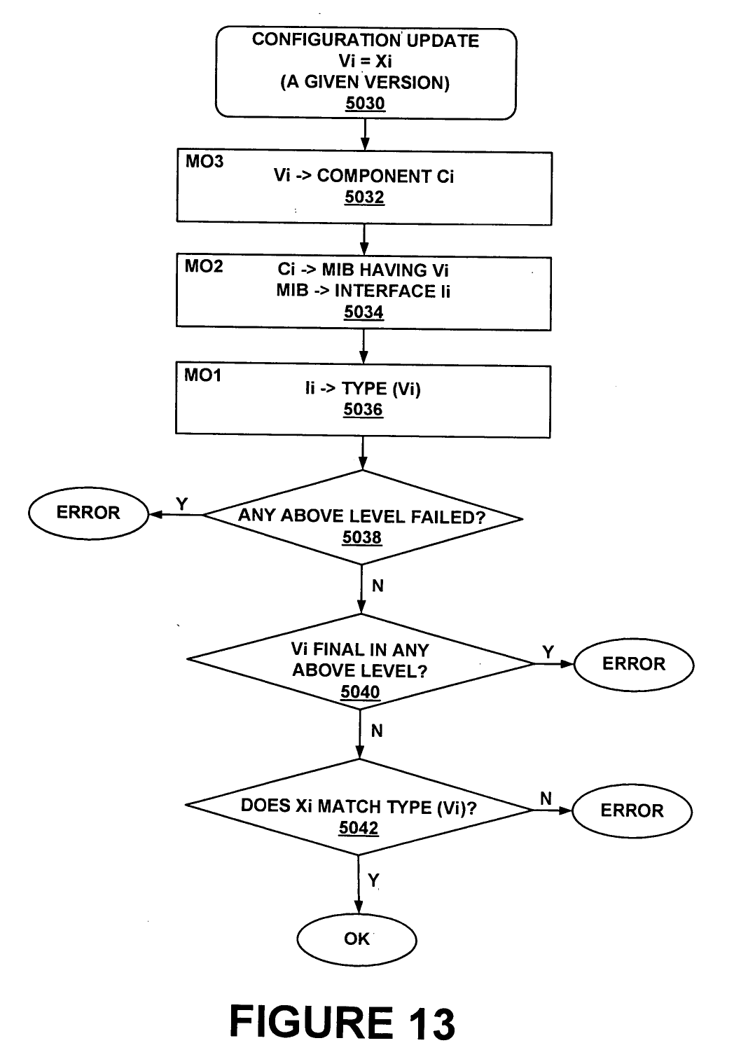

FIG. 14 is a “file-oriented” form of the flowchart of FIG. 13;

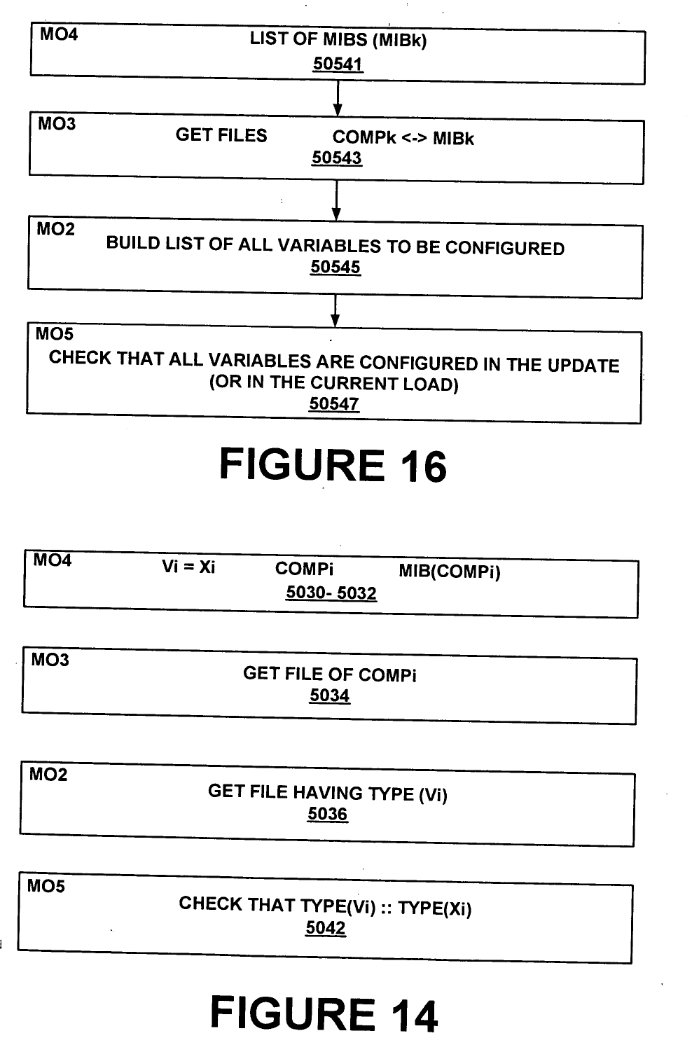

FIG. 15 is a flow chart of an exemplary platform update;

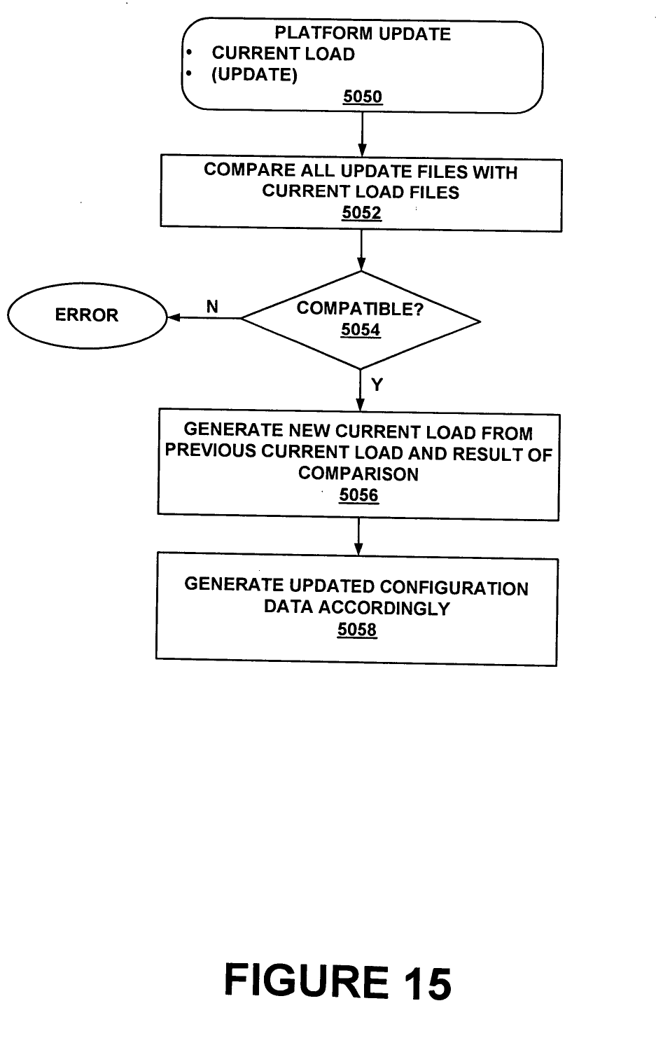

FIG. 16 is a flow chart of an exemplary tool for checking the compatibility of an update set;

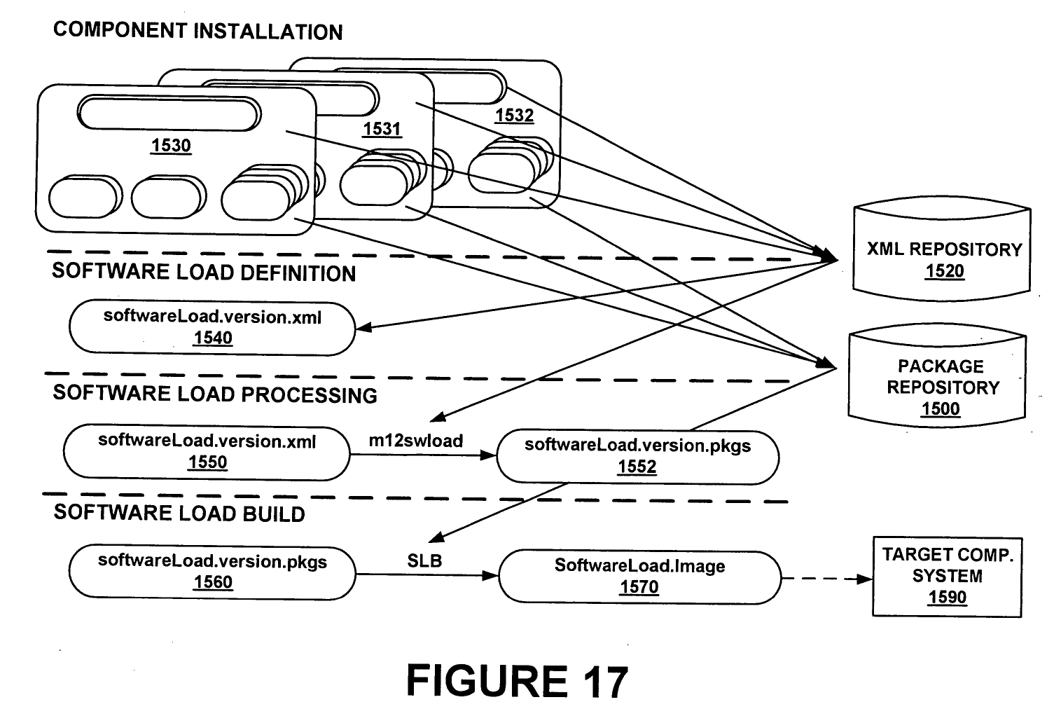

FIG. 17 diagrammatically shows a “software load life cycle”;

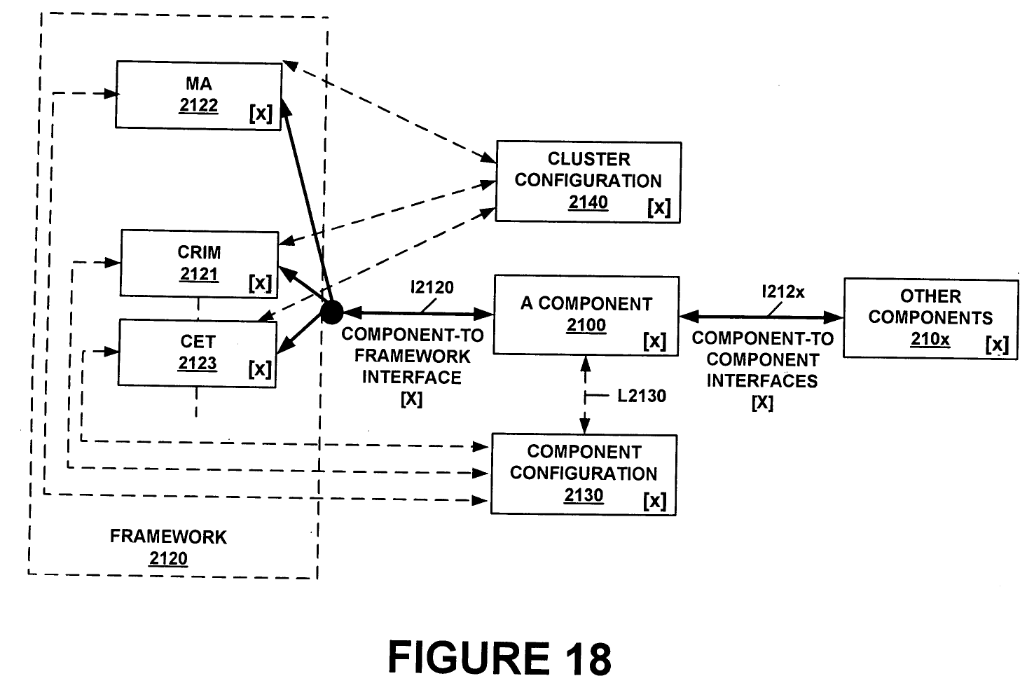

FIG. 18 is an exemplary block diagram showing how a given (hardware or software) component may interact with its surroundings, at the design level;

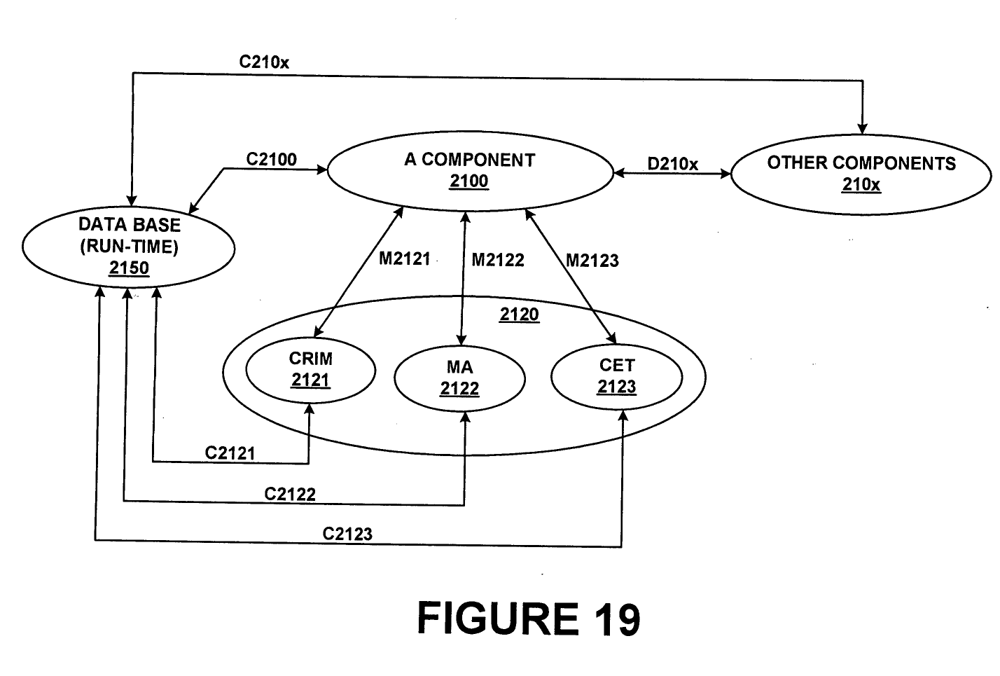

FIG. 19 is an exemplary block diagram showing how a given (hardware or software) component may interact with its surroundings, at the runtime level;

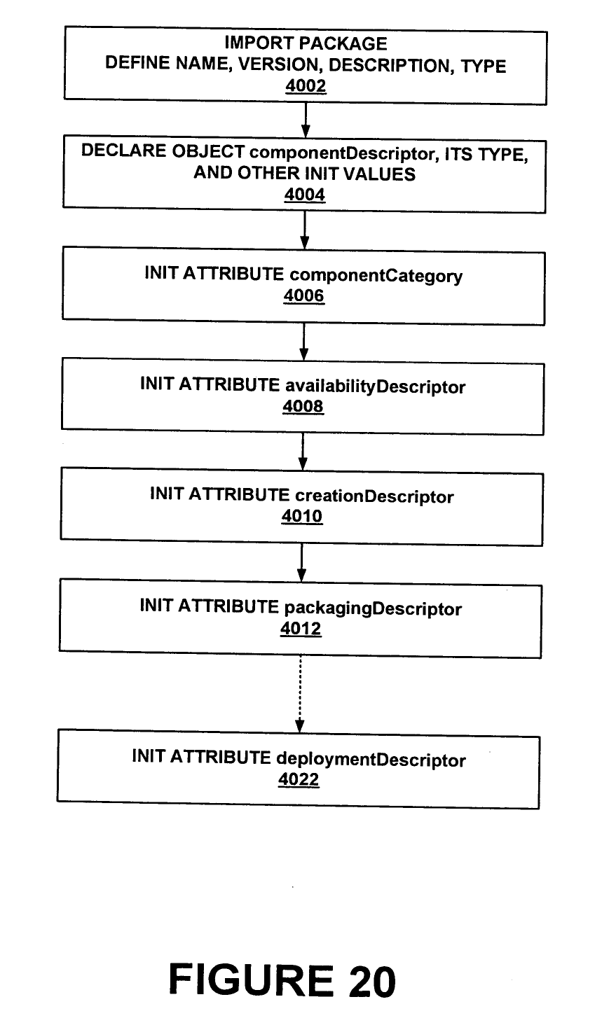

FIG. 20 is an exemplary flow chart showing how a component type configuration MIB may be used when developing a component;

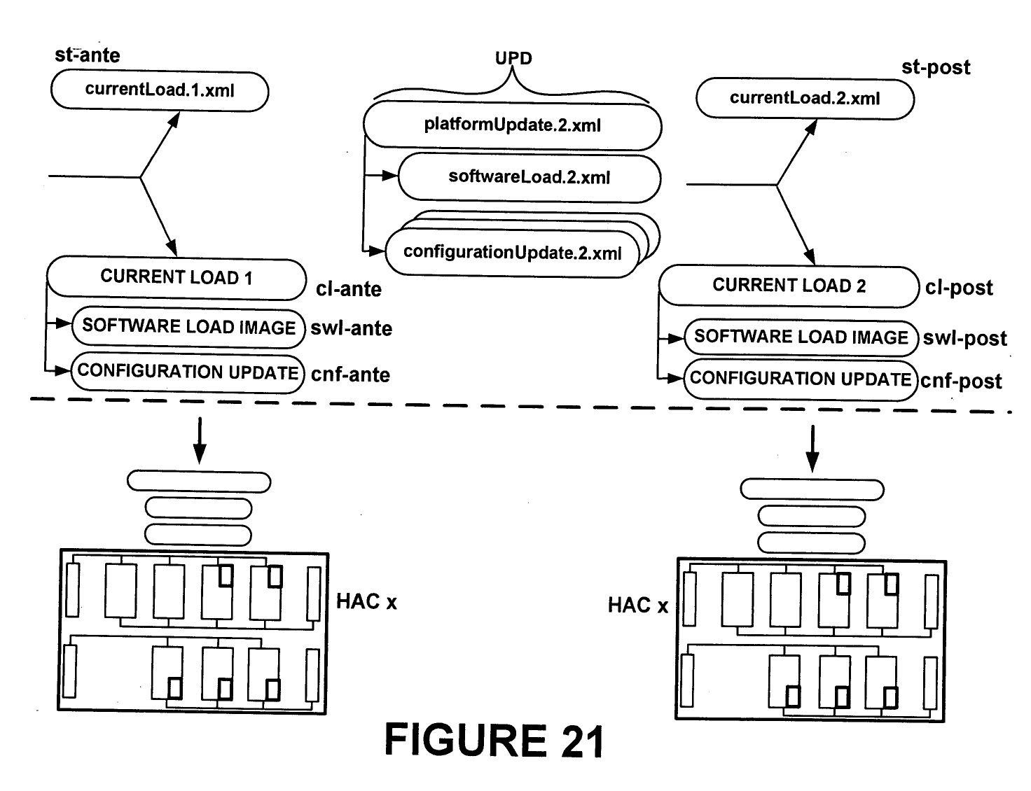

FIG. 21 is an exemplary diagram showing a platform update operation;

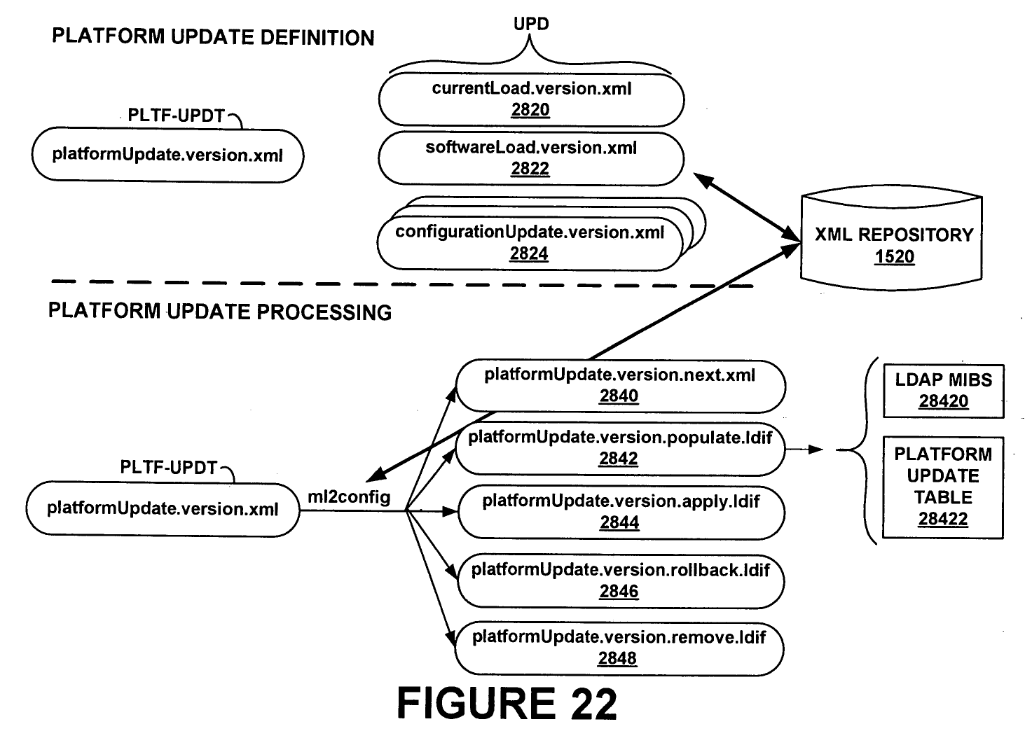

FIG. 22 is another exemplary diagram showing a platform update operation, in a different view;

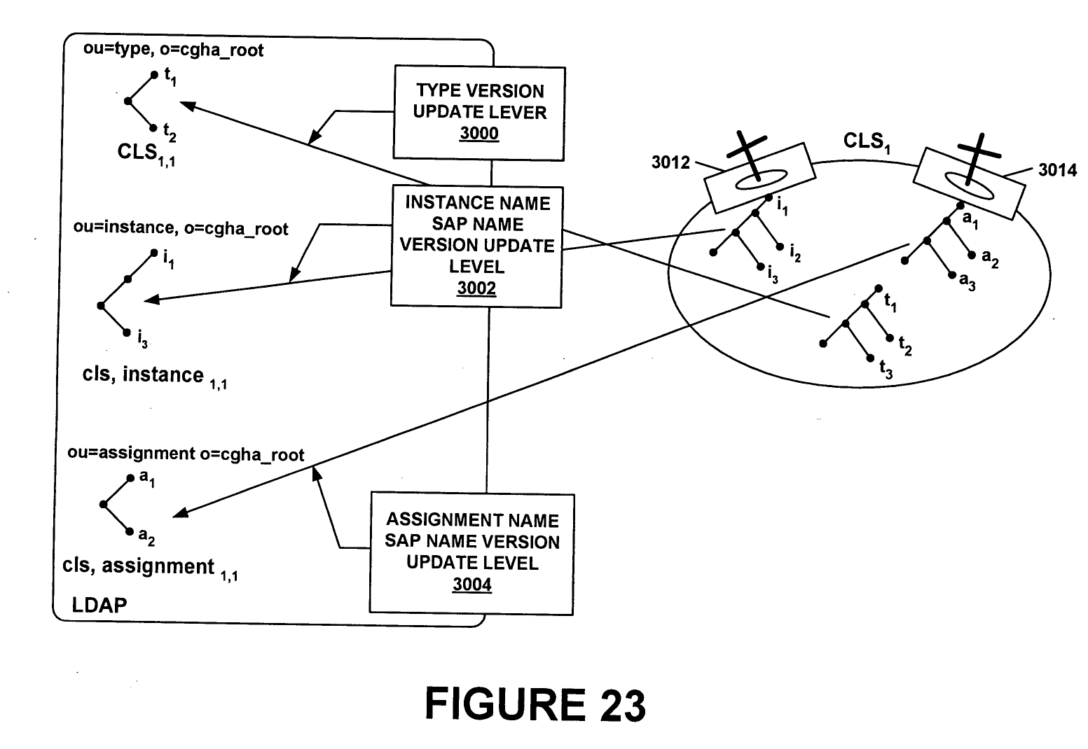

FIG. 23 is an exemplary diagram showing the configuration of a component;

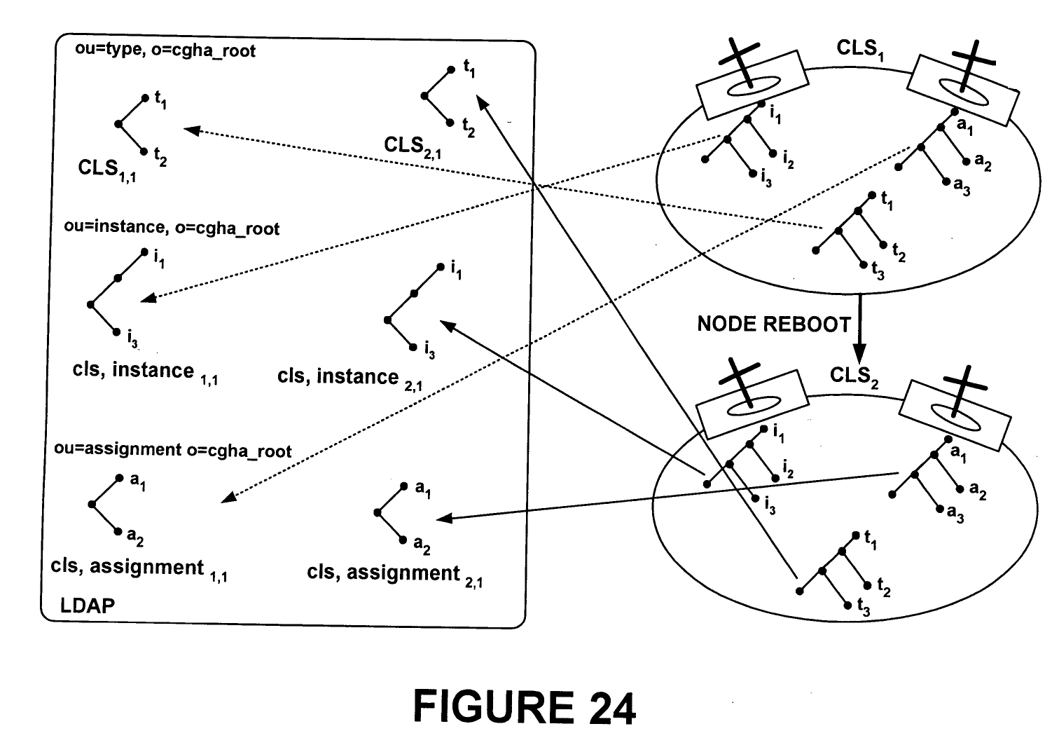

FIG. 24 is an exemplary diagram showing a software update;

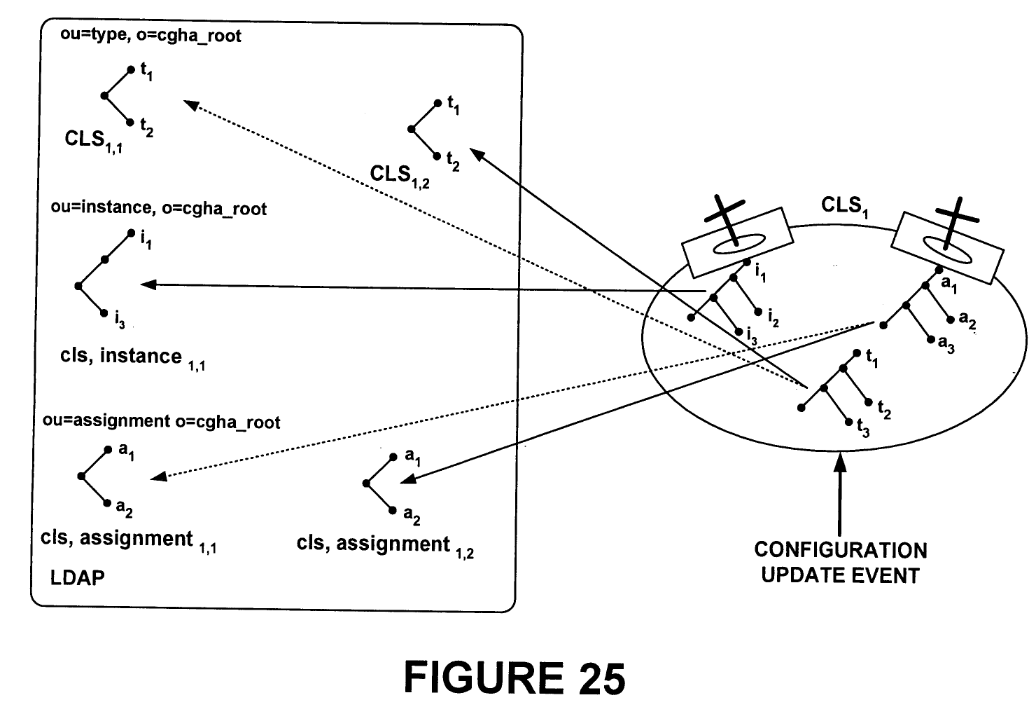

FIG. 25 is an exemplary diagram showing a configuration update, made in response to a configuration update event;

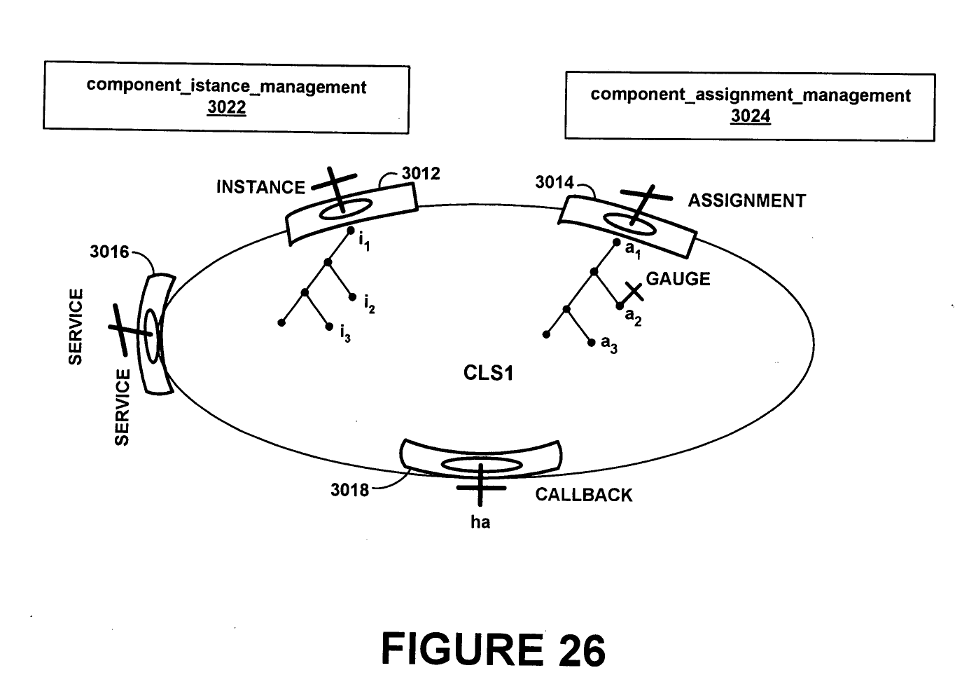

FIG. 26 is an exemplary diagram showing a component, and its interactions with its surroundings; and

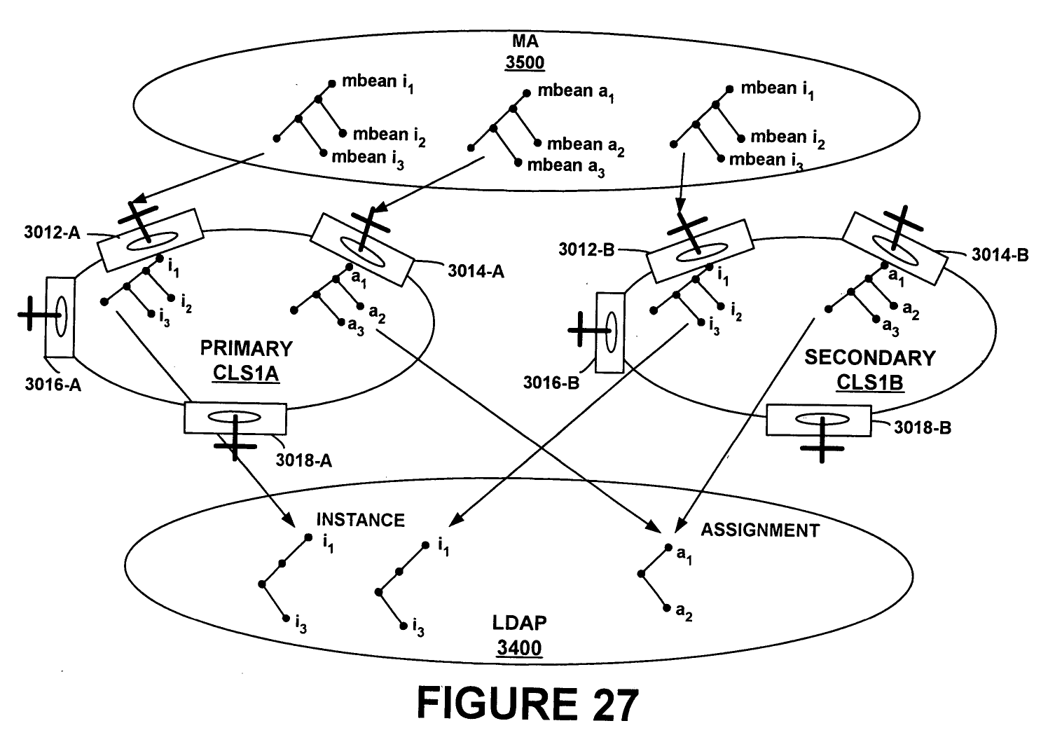

FIG. 27 is an exemplary diagram showing the operation of two redundant components, and their interactions with the surroundings.

As they may be cited in this specification, Sun, Sun Microsystems, docs.sun.com, Answerbook, Answerbook2, Solaris, Java, EmbeddedJava, PersonalJava, JavaBeans, Java Naming and Directory Interface, JDBC, Enterprise JavaBeans (EJB), Jini, Sun Spontaneous Management, Java 2 Enterprise Edition (J2EE), JavaServer Pages (JSP) and I-planet are trademarks of Sun Microsystems, Inc. SPARC is a trademark of SPARC International, Inc.

A portion of the disclosure of this patent document contains material which may be subject to copyright protection. The copyright owner has no objection to the facsimile reproduction by anyone of the patent document or the patent disclosure, as it appears in the Patent and Trademark Office patent file or records, but otherwise reserves all copyright and/or author's rights whatsoever.

Additionally, the detailed description is supplemented with the following Exhibits:

Exhibit Eh1 contains an exemplary Document Type Definition or DTD in XML;

Exhibit Eh2 comprises explanations on XML, and tables summarizing elements of the DTD of Exhibit Eh1;

Exhibit Eh3 is a description of the elements in the exemplary DTD of Exhibit Eh1;

Exhibit Eh4 shows exemplary CGHA-ML code or “CGHA-ML definitions”;

Exhibit Eh5 comprises tables for use in connection with Exhibit Eh4;

Exhibit Eh6 shows exemplary tables of mapping from CGHA-ML;

Exhibit Eh7 shows exemplary LDAP configuration objects;

Exhibit Eh8 contains illustrative tables;

Exhibit Eh9 contains an exemplary LDAP object, i.e. a component type configuration MIB.

In the foregoing description, references to the Exhibits are may be made directly by the Exhibit or Exhibit section identifier: for example, Eh7-O1 would refer to section O1 in Exhibit Eh7 (the prefix designating the Exhibit may be omitted if there is no ambiguity). The Exhibits are placed apart for the purpose of clarifying the detailed description, and of enabling easier reference. They nevertheless form an integral part of the description of the present invention. This applies to the drawings as well.

Now, making reference to software entities imposes certain conventions in notation. For example, in the detailed description, Italics (or the quote sign “) may be used when deemed necessary for clarity. However, in code examples:

quote signs are used only when required in accordance with the rules of writing code, i.e. for string values.

an expression framed with square brackets, e.g. [property=value]* is optional and may be repeated if followed by *;

a name followed with [ ] indicates an array.

Also, <version> may be used to designate a value for the entity named “version” (or version).

The reader is assumed to be familiar with object oriented programming in general, more specifically with Java. Details may be found at http://docs.sun.com. and http://Java.sun.com and/or in the corresponding printed documentation, e.g. “The Java Language Specification”, J. GOSLING, Bill JOY, Guy STEELE, Addison Wesley, 1996, ISBN 0-201-63451-1. Other printed documentation is currently available at:

http://www1.fatbrain.com/documentation/sun.

The reader is also assumed to be familiar with the extended Markup Language (XML) specification, available from W3C at http://www.w3.org/TR, and/or from the booklet “XML Pocket Reference”, Robert ECKSTEIN, O'REILLY, U.S.A, October 1999.

The reader is further assumed to be able to map from a model in UML to a programming language such as Java or C++, and to be familiar with client-server applications written in C. The Unified Modeling Language, or UML, is defined inter alia in Appendix D of the Common Information Model (CIM) specification, available on the web site of the Distributed Management Task Force (DMTF), http://www.dtmf.org/, or in the corresponding printed documentation.

The reader is again assumed to be familiar with LDAP (Lightweight Directory Access Protocol). A detailed description of LDAP may be found at www.openldap.org/devel/admin/, and in the corresponding printed documentation.

A number of concepts described in the above cited WO/0184313 may be of interest in understanding the context and principles of this invention. Accordingly, the descriptive portion of WO/0184313 and/or US 2002/0007468 A1 is incorporated by reference in this application. Alternatively, reservation is made for the inclusion of their FIGS. 1 through 11, together with their description [i.e. paragraphs [0037] through [0174] of US 2002/0007468 A1 or the corresponding text in WO/0184313), as an additional attachment to this application.

The above described system may be used in a variety of applications. One of these is High Availability Platforms (HA platforms), as used in real time non stop computer networks. In the field of telecommunications, the applicant company has such a project, named Carrier-Grade High Availability Software Platform (CGHA Software Platform).

FIG. 1, FIG. 2, FIG. 3 and FIG. 4 here correspond to FIG. 3, FIG. 4, FIG. 6 and FIG. 9, respectively, in WO/0184313, with the same drawing labels, and will be shortly described here as an exemplary computer platform. Further details may be found in WO/0184313 and/or US 2002/0007468 A1.

FIG. 1 is a tree diagram depicting an exemplary physical component hierarchy (or physical containment relationships) among hardware components in a networked computer system. A network element 300 includes shelves 301 and 302. The shelf 301 further includes non host system processors or NHSPs 303 and 307, host system processors or HSPs 305 and 306, and a hot swap controller HSC 304. The components that comprise the shelf 301 may themselves contain additional components. For example, the HSC 304 includes fans 308 and power supplies 309.

FIG. 2 is a tree diagram illustrating exemplary non-physical containment relationships or software component hierarchy among software components in a networked computer system. A network element 400 includes a node-1 401, node-2 402, and node-3 403. Each node may contain additional components. For example, the node-i 401 includes an operating system 404, Asynchronous Transfer Mode (“ATM”) stack 405, ATM driver 406, ethernet driver 407, and management applications 408.

Components may be viewed as a fundamental unit of encapsulation, deployment, and manageability. When new applications and devices are added to a networked computer system, they are typically added as new components.

To prevent service outages during normal operation, components may accept dynamic changes in their configuration. It is common for the configuration of network-based applications to change during normal operation. To prevent frequent outages due to these configuration changes, components may be held responsible for recognizing that their configuration has changed and taking this change into account by operating based on the new configuration.

As shown in FIG. 3, a component 601 might contain physical devices and their drivers 600A, applications 600B, diagnostic applications 600D, applications for conducting audits 600C, and error analysis applications 600E.

By providing standard class-interfaces through which components interact with management agents and other applications, components may allow developers greater freedom in structuring and implementing components. In FIG. 3, a component manager 601 may function as an interface to a management agent (“MA”) 602 and a component role and instance manager (“CRIM”) 603. The component 600 may also interface with a component error correlator (“CEC”) 605 and clients 604.

If newly-supplied components fully support all of the interfaces associated with their class and/or sub-class, they would automatically be manageable within various management contexts.

In an embodiment, distributed system services (“DSS”) may be used—the DSS may include a collection of location-independent mechanisms that enable applications to interact with one another. The DSS may enable applications to interact with one another without knowing where they are running, or where the other applications with which they are communicating are running. Using the DSS, all applications may see the same messaging, event, and configuration services, independently of which node they happen to be running on. In other words, the DSS may allow applications to communicate regardless of their relative locations.

Application services may also interact with their clients through the DSS, allowing them to migrate from one node to another without affecting their clients. The DSS may also facilitate load-sharing and system expansion by allowing work to be distributed among multiple processor nodes.

As an Example, FIG. 4 is a representational diagram of one preferred embodiment of DSS. In FIG. 4, a DSS 900 provides at least seven types of services and/or mechanisms-a cluster naming service (“CNS”) 901, cluster event service (“CES”) 902, cluster configuration repository (“CCR”) 903, cluster replicated checkpoints (“CRC”) 904, reliable remote procedure calls (“RRPC”) 906, asynchronous messages (“AM”) 905, and reliable transport 907.

The RRPC 906 may provide a mechanism for basic intra-cluster or intra-system communications. Using this mechanism, for example, a client may issue a request to any server in the system without regard to their respective locations and await a response. The RRPC 906 may be suitable for services that require positive acknowledgments for robustness, require distinct requests to be serialized, or offer an automatic retry in case of a server failure.

The AM 905 may also provide a mechanism for basic intra-cluster or intra-system communications. The AM 905 may require responses and may be suited for services that require minimum latency and overhead, do not require explicit acknowledgment or serialization, or can operate properly despite occasional silent failures.

The RRPC 906 and AM 905 may also send calls and/or messages from exactly one sender to exactly one receiver over a pre-arranged point-to-point communication channel.

The CNS 901 may be used to provide a cluster-wide, highly available naming service. Servers may register communication handles (and other things) under well-known names in a hierarchically structured name space provided by the CNS 901. Clients may look up the names for services they want, and obtain communication handles (or other objects to support the exchange of services). Handles for both the RRPC 906 and AM 905 may also be registered and obtained from the CNS 901.

The CES 902 may automatically distribute events from a publisher to all processes in a cluster that have subscribed to that type of the event. Using the CES 902, a publisher may not need to establish an explicit channel with all possible subscribers. Similarly, subscribers may not need to establish an explicit channel with a publisher.

It has now been found of high interest to model such a platform and/or the applications which run on it, totally or partially. This invention offers various aspects of such a modeling, including a new, polyvalent, software language, which may not only be used for theoretical modeling as such, as other modeling languages do, but also is “operational”, i.e. may be accessed by software processing tools, like generators or compilers, other than user interface for edition of the model. Such an Operational Modeling Software Language is hereinafter generically noted in short “OMSL”.

In WO 01/44934, the applicant company has described the preparation of a software configuration, using an XML type programming language. In one of its aspects, the present patent specification now comes to propose a concept for at least partially modeling a platform and/or the application running on it. “At least partially modeling” indicates that the modeling may be restricted to what is required to maintain the platform in operation.

Broadly, the OMSL language being proposed may provide a single description of the interfaces, management information and deployment configuration for application software, system software and/or hardware. This description may also be used by middleware. “Middleware” here refers to various software codes (e.g. the so-called “glue code”) existing between the operating system and the application software.

FIG. 5 illustratively shows seven software components COMP1 through COMP7, which are servers or clients (the version aspects of FIG. 5 will be considered later). Server COMP2 provides interface I1 which is used by both clients COMP1 and COMP2. Server COMP6 provides both interface I2 which is used by client COMP7, and interface I1, used by COMP 1. Client COMP5 uses both interface I1, provided by server COMP4, and interface I2, provided by server COMP6. The case of a component being both client and server is a simple extension of the scheme.

The model data may be organized as shown in FIG. 6, which will be described first, to help in understanding the description of the OMSL language.

The Interface model MO1 comprises sets of interface data MO1x (e.g. files), representing interfaces like those of FIG. 5. The component model MO2 comprises sets of component data MO2x, based on interface data MO1x. The software load model MO3 comprises sets of software load data MO3x, defining a given arrangement of components and of their interfaces in a platform. The configuration update model MO4 comprises sets of configuration data MO4x, which may be viewed as “settings” as required by the platform when a corresponding given arrangement of components is in operation. Finally, the platform update model MO5 comprises sets of platform update data MO5x, each of which defines possible evolutions of the platform, with reference to a “current load” MO5CL (which may be viewed as separate from model MO5, or included in it).

As shown in FIG. 6, up to five models may be supported. This is exemplary only, and the invention may apply as well where only some of these models would be used, and/or some are mixed together.

In certain flowchart drawing boxes, the identifier of the relevant model is shown in the upper leftmost corner of the box.

The OMSL language may be based on eXtended Markup Language (XML), or on a similar modeling language.

Exhibit Eh1 shows an exemplary document type definition (DTD). As known, the DTDs are one of the current possibilities offered by XML for defining the language rules, and many tools exist to exploit them. However, alternative possibilities offered by XML, like XML schemas, may be used as well. Also, other language rule definitions may be used when using modeling languages other than XML, which may further be converted into XML, if desired. For example, UML may be converted into XML using XMI.

When reading the DTD, attention should be paid to the word type, which may have different meanings:

the type e.g. of a constant, as usual in computer software,

an extended meaning, where type is associated with an identifier, and refers to the nature of the entity to be represented with that name. The type identifier itself is thus a name, but that name further implies consequences as to the nature of the entity being named. In other words, a type defines some kind of specimen of an entity. Usually, a type identifier will have to follow certain rules, e.g. those related to versioning, to be described.

The OMSL language defined by the DTD of Exhibit Eh1 has been termed “CGHA Markup Language (CGHA-ML)”, since it intends to serve in an HA or CGHA platform. Thus, with a view to facilitate understanding, reference may be made here to the system and to its constituents with the label or prefix “CGHA”. It must be clearly understood, however, that “CGHA” or “CGHA-ML” is used here as a convenient label, and that its use does not involve any intended limitation to a CGHA platform, and/or to telecommunication applications, and/or to the exemplary embodiment of CGHA-ML being described.

Turning to the Document Type Definition or DTD shown in Exhibit Eh1, those skilled in the art will appreciate that such a DTD defines a set of tools for modeling various platforms, i.e. hardware and/or software systems. For those being not familiar with XML, Exhibit Eh2 recalls the main concepts of XML, and has tables describing most elements of the DTD of Exhibit Eh1 in natural language.

Exhibit Eh3 describes the syntax and semantics of how to construct the above models when using e.g. the exemplary DTD of Exhibit Eh1.

All of the above models may support versioning. In the example, the version attribute is a positive integer. Other “incrementable” definitions may be used as well, with or without letters and/or separators.

When in use, versioning may be implemented e.g. as follows: a file defining an entity called <Entityname> may be named: <Entityname>.xml, if the entity has no version, or <Entityname>. <version>.xml, if the entity is versioned, with <version> being e.g. 1, 2, 3.

In the exemplary Component Model, at least one ELEMENT has minVersion and maxVersion attributes. As shown in Table Eh2-1, the example shows in fact two such ELEMENTs:cgha:use, and cgha.provide, which may be used to offer two different functionalities:

the cgha:use element (C2) may be used to declare the versions of an interface that are used by a component, considered as a client.

the cgha:provide element (C5) may be used to declare the versions of an interface that are provided through a SAP, by a component considered as a server.

In each case:

minVersion specifies the oldest version of the interface that is used/provided, i.e. the version with the lowest version number.

max Version specifies the most recent version of the interface that is used/provided, i.e. the version with the highest version number. The value of this attribute must be greater than or equal to the value of the minVersion attribute (for the same entity created from use or provide).

It will be appreciated that a number of objects or ELEMENTs in the DTD admit a “version” attribute, which may be required or optional. This is summarized in Table Eh2-2. The fact that version is optional in certain case is an implementation choice, which may reflect the fact that certain ELEMENTS will rarely change. In fact all ELEMENTS might be versioned.

In the exemplary embodiment, versioning is mandatory:

in the interface model, for interfaces and object references, and also for event and the publish aspects, if implemented,

in the other models, for the components, the platform update, configuration update and software load models.

Each versioned “ELEMENT” may be used as an attribute in another ELEMENT, using the cgha:attribute.

The flow-chart of FIG. 7 shows an example of how version attribute checking (4500) may be made, when creating an entity, e.g. by a dedicated tool which may be incorporated in an OMSL compiler. The entity derives from an ELEMENT generically noted cgha:xxx, where xxx may be one of the elements of the DTD. The type identifier or entity name is “entName” (4502) Operation 4504 determines whether “entName” already exists, or not. This may use the naming tree to be described in connection with FIG. 8.

In the case of a new name, if version is supported by cgha:xxx (4510) and mandatory, i.e. “required” (4512), operation 4514 verifies that version 1 is created (starting at any integer version might also be allowed). If version is not supported, no version number is allowed (4518). If version is supported, but not required, anything is possible (4516).

In the case of an existing name, if version is not supported by cgha.xxx (4520), it is not allowed (4528), like for 4518. If it is allowed and required (4522), a last version is sought (4526), and the entName should be supplemented (4526) with a version indication incremented by 1 (or any version number representing a non existing version, preferably a higher version). Then, at least for certain entities, compatibility between version may be checked, optionally (4527). If version is supported, but not required, operation 4524 determines whether a last version exists for entName; if so, the required path of operations 4526 and 4527 is taken, otherwise the “unversioned” operation 4528 applies.

At 4527, checking compatibility between versions may be implemented, e.g. for the following CGHA-ML entities along the following exemplary rules:

interface:

Two versions of the same interface must not have an operation, an attribute or a constant with the same name and a different signature. The signature of an operation consists of the number and types of its arguments, its return type and its declared exceptions. The signature of an attribute or a constant is its type (plus its version, if implemented). Note that two attributes with the same name must have the same type. This may be verified by the OMSL compiler.

For a number of other entities whose versioning is optional (e.g. structure, enumeration), there may be no need to mandate any compatibility between two versions of such an entity.

Whatever its internal operation is, a software entity or component is known of other software entities essentially by what it exchanges with them. This may be broadly termed its “interfaces”; however, in practice, a difference is made between interfaces as such, examples of which have been discussed with reference to FIG. 5, and other software “beings”, like the exceptions and events.

First, by using such an OMSL, it is possible to define a collection of interfaces, attributes (in the target software platform, not XML attributes), structure members, parameters, objects or contexts. Each of these can be defined by a group of data having a type, like simple type or structure. Examples of such groups of data are:

a map, which is an unordered set of pairs (key, value), where the key is an arbitrary string and the value is of a base type. All values have the same base type in a given map. A map is specified by setting the map attribute to “yes”.

an array, which is an ordered list of elements of the same base type, indexed by integers. An array is specified by setting the array attribute to “yes”.

The interface model makes it possible to describe sophisticated parameters, as they exist in the interactions of components within a computer platform, and thus to define models of that platform. The models may be represented by OSML files, which are XML files in the example. Other representations may be used as well, e.g. the LDAP representation to be described. Thus, OMSL files (files in the OSML language) may be constructed by platform architects, and stored in a repository (hereinafter called OSML or XML repository).

Except where versioning and update level applies, two different items should have different names (or identifiers). To facilitate this, the repository may be organized as a hierarchical tree, which reflects the structure of the OMSL package hierarchy, also in connection with the naming of OMSL packages, if desired.

An exemplary organization of the OMSL Repository on a customer platform will now be described with reference to FIG. 8. (Note the OMSL is CGHA-ML in the drawings.)

After a main “root” node N0, there are three sub-trees with their roots in N10, N20 and N30. Then:

the subtree stemming from nexus N110 (com/sun) may be arranged with a sub-nexus N1100 (cgha) forming a path to contain predefined OMSL files describing types (interface model) and components (component model). It may be arranged with sub-nexus to distinguish standard OSML Software Platform types (N1101) and internal system components (N1102 and N1103). This may be called the “system repository tree”.

the tree stemming from root N120 (con/telco) contains customer-specific OMSL files describing the customer platform and applications (“telco” is used here as a generic name for a customer organization). Its nexus N1201, N1202 and N1203 may follow an organization similar to those of the system repository tree (N1101, N1102 and N1103). However, other organizations may be chosen as well. For example, the customer-specific portion of the repository could be named fr/telco, or it could be located elsewhere in the file system.

the tree with root N20 (updates in the example) may contain OMSL files describing successive platform updates of the customer application. These files follow the software load model, the configuration update model or the platform update model.

finally, root N30 (cghaml.dtd) contains the unmodifiable file or files which define the OMSL syntax, e.g. the Document Type Definition or DTD.

In the exemplary system Repository tree (com/sun sub-tree), only final directories, e.g. N1101, contain actual OMSL files (leaves of the tree). The directory N110 contains standard types and system components:

directory N1101 contains common interfaces and standard types used in the Software Platform. These “leaf” files follow the OMSL interface model. Subdirectories of N1101 may be used to receive files describing types specific to system components, for example ccm (N11031), cec (N11032), and crim (N11033).

directory N1102 contains files defining hardware components. All files related to a hardware component may be located in a subdirectory, which contains the definition of the component as well as optional, specific component types and interfaces. For example, the following hardware component subdirectories may be defined: netrat1 (N11021), networkelement (N11022), shelf (N11023).

The platform software N1103 directory contains files defining system components of the Software Platform. All files related to a system component may be located in a corresponding subdirectory. This subdirectory contains a file defining the component (component model). It may also contain files defining types and interfaces specific to the component, using the interface type model. For example, the following system components may be defined: bootserver, ccm, cec, ces, cet, chm, cls, cmm, crcs, crim, csum, ma, oscm, slim, sltm.

Turning now to FIG. 9, a repository 2010 contains the model files, which may comprise the DTD 2011, predefined files 2012, and custom files 2013. The custom files may be prepared using an XML editor 2020, with a user interface 2021, e.g. the “XML mode” of the GNU “emacs” editor of the GNU.

The rest of FIG. 9, i.e. the frame in dashed line 2030, may be called OMSL compiler, or, in short, compiler. It may include XML language editing tools, which may use a catalog file, e.g. an XML parser 2031, with a semantic analyzer 2032 (and, optionally, a syntactic analyzer, not shown). Then, one or more generators 2034 may be used to build files 2035 in other languages and/or formats. Three different languages lang.1, lang.2 and lang.3 are shown, by way of illustration only. In practice, the languages may range from Java and C/RPC to LDAP, HTML, while using corresponding mappings as necessary. Generators 2034 may also be used for other purposes, e.g. with the software load mapping.

Reference is now made to FIG. 10, which shows a system embodying several other inventive aspects.

The repository 1510 may comprise various software packages (XML files and package files), amongst the following: platform update, configuration update, software load, applications, middleware, Operating system, hardware, and types. These may be checked at 2300, e.g. as described with reference to FIG. 9. At 2320, software factory tools may be used to build:

component framework code 2340, which may comprise e.g. client stubs, service skeleton code, and management skeletons code, for example in C or C++;

one or more software load images 1570,

LDAP data 2400, e.g. for use when the target system will internally need information about its own status and constitution, e.g. at runtime, and

a Management agent framework 2500, e.g. using Mbeans, and the applicant company's JDMK, i.e. java.

The models of FIG. 6 will now be reviewed in more detail, with reference to the corresponding sections of the exemplary CGHA-ML in Exhibit Eh3, and to the example of FIG. 8.

The interface model MO1 (Eh3.2) basically describes interfaces, and may also involve e.g. events, and/or exceptions. A given set of modeled interfaces will comprise the the interfaces that may exist in (be provided or used by) components of the platform, or a given part of it. Each interface defines the services that will be provided by, or supplied to, a component (subject to the capability of the component to have that interface).

The interface model MO1 (used e.g. in N1101) may basically support the specification of Interfaces. It may also support Events.

In the embodiment, other auxiliary entities are also put in the interface model MO1 Exceptions, Structures, Object references, References, Enumerations.

Certain items of MO1 may have attributes, e.g. configuration attributes, for which the given set of modeled interfaces may define default values.

Typically, a file might contain one interface, together with the related exceptions and the structures necessary to define this interface. They may be grouped semantically, so that, for example, everything related to one call mechanism will be grouped in one file. However, various interface items may be mixed in the same file.

The interface model MO1 comprises the same level of functionality as CORBA IDL or Java RMI, with support for inheritance and exceptions. It has new features to cope with versioning, synchronous/asynchronous mode of communication and configuration.

Now, the component model MO2 (Eh3.3) represents components, using the above mentioned interface items. A component may be represented by a “component type”, together with the interfaces it provides and the interfaces it uses.

The representation of components may use a tree structure, e.g. a hierarchical naming tree where each leaf is an object that implements an interface type. Furthermore, one may associate an object with each node of the naming tree. This is termed a Management Information Base, or MIB.

A dedicated MIB may handle the configuration associated with the component type (e.g. a network element or cluster). A MIB is associated to its container, which may be e.g. a SAP (Service Access Point), a component type, or a cluster. In the MIB, it is possible to override the default value of the configuration, coming from the interface model.

SAPs are used to specify particular aspects of a component, for example management, high availability or service. Each SAP provides a set of interfaces and an optional MIB.

A given set MO2x of modeled components may have the form of component model files, which may be located in the directories stemming from N1102, N1103, N1202, N1203. In a simple embodiment, an XML file may contain only one component.

In more general terms, the component model defines component types which may be used on a cluster (whether hardware or software). In the case of software, component instances define the component types which are presently available; component assignments define if and how the component instances are assigned roles dynamically in the Software Platform (this may be also applied to controllable aspects of hardware).

In the example, the versioning follows simple basic rules:

a given entity myEntity created from use (client) or provide (server) must have two version values for its minVersion and maxVersion attributes, respectively;

it is not entitled to offer an interface (or other versioned item) whose version value is denoted <version> unless two conditions are met:

<version> is equal to or greater than the min Version value of myEntity

<version> is equal to or lower than the max Version value of myEntity

If desired, the accuracy of the [minVersion, maxVersion] intervals of the use and provide OMSL elements may be checked, e.g. as shown in the flow chart of FIG. 11. For each component Ci in the component model (5010), operation 5012 gets the interfaces used by Ci, and, for each such interface gets the [minVersion, maxVersion] interval WUi for use. Operation 5014 checks that the Interface model indeed has an interface for each version within interval Wui. Operation 5018 indicates that the same is done with [minVersion, maxVersion] interval WPi for provide.

Other mechanisms may be constructed, using the version, on the one hand, and the [minVersion, maxVersion] interval, on another hand, based on similar principles.

The software load model MO3 (Eh3.4) specifies the software loads that are deployed on a given portion of the software platform, for example a Network Element, hereinafter termed a cluster by way of simplification. A software load represents a set of components (software and hardware). Along the exemplary embodiment, multiple versions of the same component are not allowed in a given software load (this would induce a more complicated processing).

In a given software load:

Each component is represented by:

its definition in the OMSL model, in the example a component type configuration MIB, an instance MIB, and an assignment MIB,

a list of software packages, and

a descriptor of its target localization.

The configuration associated with the Network Element or cluster (hosting the components) is handled through a dedicated MIB, called cluster configuration MIB.

The flow chart of FIG. 12 shows how version consistency may be checked, e.g. within a given software load MO3x. Starting from a list of coexisting components (5000) in the software load MO3x, the component model is used (5002) to build groups each of which may be viewed as a client component Ci using Interface Ik provided by a server component Cj. Operation 5004 gets the [minVersion, maxVersion] interval Wi of Ci for Ik as “use”, and the [minVersion, maxVersion] interval Wj of Cj for Ik as “provide”. The components can cooperate if the intersection of Wi and Wj is not nil, as checked by operation 5008.

A software load defines ingredients of a software platform. A given condition of the settings in a software platform is termed a “configuration”. The interface model MO1 and the component model MO2 define two levels of default configuration settings. However, further settings may be made at the time the software load occurs.

Thus, the configuration update model MO4 (Eh3.5) defines the configuration of a given software load (“configuration load”), and any modifications being made to that configuration. When initially loaded, a configuration is initialized, and then it may be updated.

Each configuration load may be seen as applying to a specific software load. A given configuration load specifies the configuration of all the components of the software load it aims at. Configuration values are applied in terms of type, instance and assignment, and also the configuration of the Network Element, including deployment descriptors, redundancy schema and component relationships (to the extent applicable).

The configuration load section of the configuration update model allows the initialization of a n-uplet of items, which, in the example, is a quadruplet: a cluster configuration, a component type configuration, a component instance configuration and a component assignment configuration. This implies that each component instance and component assignment should be named in a unique fashion, in the above described naming tree.

The Configuration update model basically gives values to variables (in the broadest meaning of the word variable); this has the form Vi=Xi, for a given version, as shown in operation 5030 of FIG. 13. The Software load model is then accessed to know the component Ci being concerned by variable Vi (5032). The component model in turn indicates which MIB is concerned, and hence, which interface Ii is concerned (5034). And the interface model indicates the type of variable Vi (5036). An error is generated (5038) if any of the above level failed. A different error is generated (5040) if Variable Vi was found final in any of these levels (except 5030). Finally, Vi=Xi is accepted if the type of Vi, as found in the interface model, matches the type of Xi, as defined at 5030.

FIG. 14 is a “file-oriented” form of the flowchart of FIG. 13.

The platform update model MO5 (Eh3.6) provides the specification of a platform update. A platform update may be processed by the software factory tools as shown in FIG. 15. It may comprise (5050) a “current load”, which corresponds to the software load that is currently deployed on the Network Element, and its associated configuration. It may also comprise a list of configuration updates (from zero to N in number), and, optionally, a new software load, if any, that may be loaded on the Network Element in substitution of the current load and the associated configuration.

The simplest role of the platform update model MO5 is to change the configuration. First, all files involved in the update (and including configuration statements, in the form Vi=Xi) are compared (5052) with the corresponding files in the current load. If they are compatible (5054, to be developed), the generation of a new current load is allowed (5056). The new current load may be obtained by simply applying the configuration values being modified, as they were found at operation 5052. The other configuration values are kept. Then, updated configuration data are generated (5058).

FIG. 16 shows an exemplary way of checking the compatibility of an update set MO5x at operation 5054. Operation 50541 builds the list of MIBs (MIBk) being involved in the update (the current load is assumed to have been checked previously in a similar fashion, and to be correct). Operation 50543 accesses the files comprising those MIBs and the corresponding components. Operation 50545 builds the list of all variables to be configured for these. Operation 50547 checks that all these variables are effectively given configuration values in the intended update (or in the current load).

Thus, a Platform Update Model may provide support:

for controlled and deterministic configuration updates to the current software load running on the Network Element.

for upgrading the software running on the Network Element from one release to a different release.

In other words, the Platform Update Model defines the Software Load and the Configuration Updates that are applied on a Network Element. In a configuration quadruplet (cluster, type, instance and assignment), each entity may have an associated update level. Thus, modification of the configuration is made possible without having to build a new Software Load.

The Software Factory tools 2030 may be used for managing this notion of update level. The update level is incremented (or otherwise differentiated) after the update has been checked and authorized. The resulting configuration information may thereafter be provided to each running component instance being “re-configured”.

Let entity be an item in the above mentioned quadruplet: cluster configuration, component type configuration, component instance configuration and component assignment configuration. The configuration of such an item of a component is defined by:

its name <entityName>

its version, e.g. 2, and

its update level, e.g. 3.

The version is known at compilation time. The name is defined when the component entity is created. Conversely, such an entity may be informed that its configuration has changed in an asynchronous fashion by an event, which may indicate the most recent update level. In response, the entity will change its configuration, e.g. by re-booting, which forces it to re-acquire its configuration data; “softer” reconfiguration processes may also be applied, subject to adequately determining the status of the relevant portion of the platform.

To check the consistency of a software load and/or a configuration update in respect of what has been deployed on a Network Element, and to generate the appropriate update levels, the Platform Update Model supports the definition of the current load.

A current load defines the components that have been deployed on a Network Element, defining for each component its type, its version, its instances and its assignments with the associated update levels and configuration. For the cluster, the current load defines its version, its update level and its configuration.

The Software Factory tools generate for each Platform Update the resulting state of the Network Element, using the cgha:currentLoad element. This resulting state should be used as the current load in order to define the next platform update of the Network Element.

Files containing a software load, a configuration update and/or a platform update may be located in an updates subtree (N20). Each file should contain only one definition, named <definitionname>, which can be a software load, a platform update or a configuration update.

Now, rules and guidelines may be established to govern how a platform and its components will be defined in the OMSL language. This concerns both the organization of the files and their actual content. The rules and guidelines may have the following aspects:

the organization of the repository 1520 and the rules to be enforced when naming the software and/or hardware entities.

the rules that must be followed when defining a component.

Further rules that should be followed when defining a cluster may be added, to correctly feature the hardware, and its redundancy features.

OMSL models may be used as such, when conceiving an application (part or all of a system). They may also be mapped to programming languages, e.g. C or Java. This allows to link an application to other components and to the Software Platform, and/or to provide remote manageability of the platform.

Tables Eh6-1, Eh6-2 and Eh6-3 in Exhibit Eh6 show examples of mappings to Java, C/RPC, and LDAP, respectively. Mapping from the OMSL to Java and/or C/RPC may be considered similar to mapping from other modeling languages to Java and/or C/RPC, and therefore will not be described in further detail. By contrast, mapping to LDAP will be described in more detail hereinafter.

It will now be appreciated that the OMSL language has following capabilities, which, of course, may be used only partially:

establish a formalized description of a Software Platform (“information model”). In fact, the OMSL language may be used to model not only the applications that run on the HA Software Platform, but also the constituent entities of the platform itself (hardware, operating system and/or middleware).

use of various user-oriented tools, e.g. validation tools, when establishing that formalized description.

possibility to build a set of specifications and tools to assist developers with the design of components.

the formalized description in turn may be used by various “operational” tools, for example when developing components or when constructing software loads, and their configuration. This may go up to the deployment of the components and of the platform on which they run.

The above defined models apply within what may be called a “software load life cycle”. This concept will now be illustrated with reference to FIG. 17. The notations used in FIG. 17, e.g. to the extent they refer to an XML embodiment of this invention, are purely exemplary. In the tree hierarchy, the top level is “platform update” (N20, FIG. 8), which comprises a software load and a configuration.

FIG. 17 shows:

a package repository 1500, which may store in any appropriate data format, e.g. a file system, the software code to be used in connection with a particular platform, both at the hardware level, e.g. drivers, and at the software level, e.g. application programs. Middleware may also be included, as desired.

an OMSL repository, e.g. an XML repository, 1520, which may store in any appropriate data format, e.g. a file system, sets of the model data to be used, in the OMSL language.

Thus, a typical software load life cycle may involve:

the installation of one or more components 1530, 1531, 1532, which may use both repositories 1500 and 1520;

the definition of a software load 1540; this may use model repository 1520 only; and produces a representation of the software load, e.g. a softwareLoad version.xml file;

the processing of the software load 1550 may involve a tool, named e.g. ml2swload, which uses that representation, in connection with both repositories 1500 and 1520, to generate a corresponding list of packages 1552, named e.g. softwareLoadversion.pkgs.

the final software load build 1600, which converts the set of packages into a SoftwareLoad image 1570. The SoftwareLoad image 1570 comprises data loadable in memory for operating a computer system, e.g. 1590. This uses a Software Load Build Tool also denoted SLBT.

FIG. 17 is made in the form of interconnected blocks, for more clearly showing the interactions between its elements. It will be appreciated that it may also be viewed as a flow chart, having operations 1530 through 1570. The separation in a plurality of levels of operations is purely illustrative. For example, operations 1550 through 1570 might be considered as a single level of operations as well.

The Component Definition Rules will now be considered.

To begin with, FIG. 18 shows how a given (hardware or software) component 2100 is seen by its surroundings. It has a variety of component-to-component interfaces I210x with other components 210x. (the x reflects the fact the other components are plural). It also has a component-to-framework interface I2120 with the framework 2120.

The framework 2120 may comprises e.g. the following runtime tools:

the Component Role Instance Manager (CRIM) 2121, which defines the instances and assignments of components,

the Management Agent (MA) 2122, which may be used to manage software,

the Component Executor and Terminator (CET) 2123, in charge of having components being put in execution, or, on the contrary, terminated.

Additionally, the component may be associated (L2130) with a component configuration element 2130. Also, the framework 2120 may be associated (L2140) with a cluster configuration element 2140. The interactions L2130 and L2140 may be separate for each element of the framework, as shown in dashed lines.

In an exemplary embodiment, the items marked by an [X] in FIG. 18 may be defined using the OMSL.

FIG. 18 is a “model view” of a component and its surroundings. As shown, it is centered on a given component; however, a similar view may be made centered on another component as well.

At runtime, there corresponds to the model view of FIG. 18 a “runtime view”, e.g. as shown in FIG. 19. Component 2100 and others components 210×interact as shown at D210x to execute their tasks. They have access to a database 2150, containing configuration data (“configuration” is taken here in its broadest sense), via C2100 and C210x. The component 2100 being considered works under control of the framework 2120, e.g. the CRIM, MA and CET, as shown by links M2121, M2122, M2123. The elements of the framework 2120, e.g. the CRIM 2121, MA 2122 and CET 2123, may also access the data base 2150, as shown at C2121, C2122, C2123.

In fact, the framework 2120 will play a similar role for the other components. This is not shown on FIGS. 18 and 19, since they are centered on a given element 2100.

Having thus defined how a component may be viewed, modeling a component in OMSL will now be considered.

Modeling may comprise defining at least one mandatory MIBs (Management Information Base) at the Component Model level, together with a corresponding SAP. (It is reminded that a MIB may be attached to a SAP, which uses the MIB to deliver information corresponding to the SAP's “mission”). By so doing, the component having such MIB and SAP follows some sort of “contract” with other components and other surrounding functions.

An exemplary set of MIBs and SAPs will now be described.

The exemplary set of MIBs is set forth in Exhibit Eh4. The SAP names, object names and corresponding object types are summarized in tables Eh5-1, Eh5-2 and Eh5-3 of Exhibit Eh5. It should be clear that these examples and the MIB/SAP names are illustrative, and should not restrict the scope of this invention.

The example involves three mandatory MIBs/SAPs:

whether it is hardware or software, a component will have a component type configuration MIB, to give the framework access to the configuration data of the component.

a software component additionally has a component instance MIB, and a component assignment MIB. Roughly, the instance is how the software component exists; assignment is the role it is currently playing. This distinction between instance and assignment (or role) is of interest in redundant systems. In other systems, a single MIB could be used for both instance and assignment.

Generally, each of these MIBs comprises a well-defined collection of objects, as required for correct platform operation. The fact these MIBs are defined correctly may be checked by the user who models a component and/or by the compiler 2030.

The objects in the MIBs may be used by the platform services (e.g. items of framework 2120) to orchestrate platform behavior correctly. Concerning the names of the mandatory SAPs, of the mandatory objects defined by the MIBs, and the corresponding types of the mandatory objects, those should be predefined by the platform architect, and not be changed thereafter. Now, there may be provided application-specific values to object attributes.

The Component Type Configuration MIB is a collection of software objects which describe the configuration of a component type

Predefined interfaces types may be defined. In the example:

a generic ComponentDescriptor interface, which has three attributes, as shown in table Eh5-4 in Exhibit Eh5. The OMSL description of the attributes of the Component Descriptor interface type may be as shown in Eh4-1.I has two children:

a SoftwareComponentDescriptor, used for software components (Eh4-10); it has two additional attributes: creationDescriptor,deploymentDescriptor, which may be used to describe the component type configuration as required by the CET.

a HardwareComponentDescriptor, used for hardware components (Eh4-11), which is empty, i.e. defines no additional attributes.

One object must be included in the component type configuration MIB. It is a simple object with the name componentDescriptor. The componentDescriptor object implements one the above children of the ComponentDescriptor interface, depending upon it is a hardware of software component. The generic ComponentDescriptor interface type defines the component type configuration required by the framework services 2120.

For both hardware and software components, the componentDescriptor object describes component type configuration data, e.g. the component category and redundancy model required by the CRIM. It also describes component packaging. For a software component, it additionally describes configuration data, e.g. those needed by the CET to start up and deploy a component. The user needs to define his own attribute values for the componentDescriptor object.

Thus, the componentDescriptor object defined by the Component Type Configuration MIB (N11011) gives the framework (2120) access to values for the configuration object attributes. For example, some configuration data is needed by the CRIM, such as the availability model of the component. The MIB (N11011) may be extended to hold other objects specific to an application.

Type configuration may be required for each component by the framework entities exploiting the OMSL language, as it will now be described.

In the example, the Component Role and Assignment Manager (CRIM or 2121) requires the following component type configuration:

a component category, defined by the componentCategory attribute (Eh4-2),

a redundancy model, defined by the availabilityDescriptor attribute (Eh4-3)

a switchover escalation (see Eh4-4), which consists of count and time window, and tells the CRIM that if the component has been restarted “count times” during the past “time window” period (in seconds), and the component still experiences errors, then the unsuccessful restart recovery should be escalated to the node switchover. The switchover escalation count and switchover escalation time window are defined by the availabilityDescriptor attribute.

a time out (in seconds) for a component to respond to CRIM requests. This is defined by the availabilityDescriptor attribute.

a restartable attribute, a boolean indicating whether the associated component type is restartable and can be recovered from some types of errors by restarting.

In the example, the component type configuration required by the CET (Component Executor and Terminator is provided by the creationDescriptor attribute, and specifies (Eh4-5):

The creation time out of the component. This is the time out value for the component to respond back with initialization completed after the CET has started up the component.

The binarypath of the component, required to start up the component.

The termination time out of a component. This is the time out value for the CET to receive a component termination acknowledgment, after the CET has requested the component to terminate.

The user id and the group id of the component. This is needed by the CET when starting up the component.

A Software Load Build Tool or SLBT may be used. The SLBT requires information regarding the component packages and the target platform and OS. A tool (identified as ml2swload, in the example) may provide this information for the SLBT, using the following component type configuration as input (Eh4-6):

The packaging descriptor, which describes component packages. The platform, OS, and package type (documentation, runtime or development) are described for each package that has a package name.

The deployment descriptor, which describes the target platform and OS on which to deploy a component.

The example in Eh4-20 shows how the component type configuration MIB may be used when developing a component. The predefined object name (e.g. componentDescriptor) and its corresponding type should be respected; its attribute values may be changed to be specific to a given application.

This example will be described in more detail, with reference to the operations in the flowchart of FIG. 20, and to the sub-sections in the code of example Eh4-20:

operation 4002 (Eh4-20A) imports the relevant package for the types (version 1) of a SoftwareComponentDescriptor, and then defines the name of the component type (here “SoftwareComponentExample”), its version, type and description.

in the MIB, operation 4004 (Eh4-20B) declares the object componentDescriptor, with its type as defined above. Then, one may initialize the desired attribute values for the componentDescriptor object, setting the values according to the platform application to be represented by the MIB.

operation 4006 (Eh4-20C) initializes the componentCategory attribute.

operation 4008 (Eh4-20D) initializes the availabilityDescriptor attribute, a structure having various members.

operation 40010 (Eh4-20E) initializes the creationDescriptor attribute, another structure.

operation 40012 (Eh4-20F) initializes the packagingDescriptor attribute, an array of structures, the contents of which will be understood bty those skilled in the art.

operation 40022 refers to the deploymentDescriptor attribute, another array of structures, which is initialized later, at the software load.

The instanceManagement SAP gives remote clients access to the corresponding mandatory MIB associated with the component instance. This MIB consists of a collection of objects whose role is to provide necessary information associated with a component instance. One can extend the MIB with objects specific to a given application, while respecting the mandatory objects, as shown in example Eh4-21.

A distinct assignmentManagement SAP may be used to give remote clients access to the component assignment MIB. This information may be used by the HA management services, such as the CRIM. One can extend the MIB with other objects specific to an application. The interface type defines attributes related to the assignment management, for example, the usage state.

The OMSL definition of that interface may be as shown in Eh4-30. There is one mandatory object in the component assignment MIB. As the interface is a singleton, the object does not have a name. This object and its related type must be respected so that the platform can function correctly. The object may provide the usage state of a component, which may be idle, or, by contrast actively in use at a specific instant, and if so, whether it has (active) or not (busy) spare capacity for additional users at that instant. The usage state may be reported by the component itself.

This state influences the decision-making aspect of platform behavior, and is required by the HA management services, in particular the CGHA availability services, so that a platform will run correctly. The component gives access to the usage state, which is that of its assignment. A component instance can have only one assignment during its primary role. An example of how to use the assignmentManagement SAP appears at Eh4-31

To sum up, a configuration, when defined by an OMSL like CGHA-ML, may be organized as a set of MIBs, specified using the cgha:mib element. A MIB is a hierarchical tree of objects and contexts, defined using the cgha:object and cgha:context elements. In fact, the OMSL language may be used to define three categories of MIB:

MIBs associated with a specific SAP. This category of MIB is contained within the cgha:sap element. SAP level MIBs are fully initialized during component instance definition or component assignment definition. Component instances and assignments are defined using the cgha:instanceConfiguration element and the cgha:assignmentConfiguration element respectively.

MIBs associated with a specific component type configuration. This category of MIB is contained within the cgha:type element. Component type configuration MIBs are initialized during component load definition, using the c gha:componentLoad element, or during component type configuration, using the cgha:typeConfiguration element.

A MIB associated with the cluster configuration. This MIB is contained within the cgha:cluster element. The cluster configuration MIB is initialized during cluster configuration, using the cgha:clusterConfiguration element.

The Software Load Model is another aspect of this invention.

The purpose of the Software Load Model is to define a set of components to deploy on a network element or cluster. This set of components is known as a software load. Thus, the output of the software load will be a list of packages (e.g. Solaris packages) defining the component part of this software load. The OS (e.g. Solaris) packages are contained in a repository and are therefore referred to by their name.

The exemplary software load model defines three elements:

cgha:softwareLoad, which is mapped to the package list file. The cgha:softwareLoad element is the top element defining a software load and identifies the software load.

cgha:cluster, which is not mapped to the package list file. The cgha:cluster element is used to define the cluster on which the software load will be deployed.

cgha:componentLoad, which is mapped to the package list file. A cgha:componentLoad element defines a component which is part of the software load. The cgha:componentLoad element first generates comments lines in the package list file identifying the component to be added. For a specific component, if no package names can be found, or if only package names common to all platforms and OS are found, a warning message is displayed to the user. The package list is verified to ensure that each package appears once and only once.

A standard ComponentDescriptor interface may be used for:

defining whether the package is specific to one platform and one OS, or common to every platform and every OS (intermediate situations may be covered). When writing the Component Model, the user specifies which package will be on which platform and OS. The targeted platform and OS are defined by their names (for example, sparc and solaris), or the word “common” can be used to point to all platforms and/or OS. Different types of packages may be used, e.g. RUNTIME, DEVELOPMENT or DOCUMENTATION.

defining the platform and OS on which a component will be deployed (these are also known when writing the Software Load Model). This information may be stored in a ComponentDescriptor standard interface, using the initialization clause of the cgha:componentLoad element.

When compiling the Software Load Model, the compiler will look for the ComponentDescriptor standard interface to retrieve information regarding the platform and the OS on which the Software Load will be deployed. With this information, package names will be found. Finally, only package names with RUNTIME type are retained.

AsoftwareLoad Description file maybe used to describe a software load in OMSL, in the following way:

It first shows the description element, then a list of imports needed to use components and interfaces already defined.

It then defines a cluster. Since this definition is not part of the OMSL to Software Load mapping, it is not considered here.

Finally, each component part of this software load is enumerated.

For some components, the platform and OS are initialized (for example the CRIM component).

The Component Descriptor will now be considered. By looking at the Component Model for every component included in the software load previously defined, it is possible to see which package names will be output. For example:

in a BootServer Component, no package names are declared, the structure PackagingDescriptor is not initialized. No package names will appear in the package list.

a CEC component defines package names for every platform and OS, but the platform and OS are not initialized in the software load. Thus, no package names appear in the package list.

there may be package names defined specifically for each platform and each OS, plus some package names that are common to every platform and OS. The software load does not initialize the platform and the OS, but the common package names are output.

turning to the CRIM Component, there may be package names defined specifically for each platform and each OS, plus some package names that are common to every platform and OS. In this example, the software load initializes platform and OS to Sparc and Solaris.

The platform update model is now considered again.

Reference is now made to FIG. 21, which shows how an OMSL language facilitates a platform update operation. In this example, a HA-cluster HACx is considered.

Before the update, cluster HACx is in a previous state st-ante, with a Current Load 1 (denoted cl-ante), comprising software load image swl_ante, and configuration update cnf-ante. This is reflected in the currentLoad.1.xml file or package in the OMSL language, e.g. CGHA-ML.

The update itself is defined in the platform Update. 2.xml file or package. In the example, it comprises softwareLoad.2.xml and configurationUpdate.2.xml.

From these files, the status st-post after the update may be:

defined, by currentLoad.2.xml file or package in the OMSL language, and

prepared to have Current Load 2, denoted cl-post, comprising software load image swl_post, and configuration update cnf-post, which may be loaded into cluster HACx.

As shown in FIG. 22, a platform update may be entirely defined from an XML package PLTF_UPDT, stored in repository 1520, generically named platformUpdate.<version>.xml, and comprising:

a currentLoad.<version>.xml (2820),

a softwareLoad <version>.xml (2840),

one or more configurationUpdate.<version>.xml.(2860)

Furthermore, the XML data may be used by a tool (denoted ml2config in the example), to produce a platformUpdate.<version>.next.xml (“next” here means “next current”) at 2840.

The tree structure used with OMSL may be conveniently represented in a directory system like LDAP. Thus, FIG. 22 additionally shows LDAP data, e.g.:

platform Update.<version>.populate.ldif at 2842

platform Update.<version>.apply.ldif at 2844

platform Update.<version>.rollback.ldif at 2846

platform Update.<version>.remove.ldif at 2848

The LDAP data may be stored at 2400 in FIG. 10, as another representation of the OSML tree, which may be readily accessed at runtime. The aspects of mapping from OMSL to a directory system like LDAP will be described hereinafter. For the time being, the parallel OMSL and LDAP trees are considered commonly as an “OMSL/LDAP tree”.

A platform update process may have different forms:

i) it may update just the configuration associated with a MIB. Such an update of the configuration alone is reflected by incrementing the update level of the MIB.

Ii) it may update both the structure and the configuration associated with a MIB. An update of both structure and configuration is reflected by incrementing the version of the MIB container (cluster or component).

It should be noted that the version and update level are also part of the OMSL/LDAP naming tree.

If the MIB has been updated, then during the platform update process, there are simultaneously two different MIB configurations, with two corresponding sub-trees in OMSL/LDAP, respectively. One corresponds to the MIB configuration before starting the update process, (st_ante in FIG. 21) and the other corresponds to the MIB configuration after the update process (st_post in FIG. 21).

The platform update table may be a part 28422 of item 2842 in FIG. 22, together with the LDAP MIBs 28420.

To have access to its configuration, a component must know the update level corresponding to each MIB. When a component is running, the update level can change. A uniform mechanism is available to access MIB configuration at runtime, using the platform update table. This platform update table provides a mapping between a MIB container name and the associated configuration tree. The table contains the identifiers (e.g. LDAP Distinguished Names or DNs) of all the MIBs that are defined. A new platform update table is generated for each new platform update. The platform update table is accessed indirectly by means of the version of the software load. Each software load contains the DN of the appropriate version of the platform update table.

To summarize, the Platform Update mechanism is organized in the following way:

Each MIB is fully defined by its container (cluster, component type, SAP), the version of the cluster or the component type and its update level.

A platform update table, containing the identifiers (e.g. LDAP DNs) of all the MIBs defined, is provided for each platform update version.

The identifier (e.g. DN) of the appropriate platform update table is provided for each software load version.

The OMSL/LDAP trees are used in FIGS. 23 through 27, in which the LDAP information is diagrammatically shown.

FIG. 23 considers the configuration of a component, here a cluster CLS1, which has an instance “i” and an assignment interface “a”. In FIG. 23:

a component type configuration MIB 3000 reflects the type of the component in the OMSL (e.g. CGHA-ML), and is mapped into a corresponding LDAP sub-tree “CLS1,1”.

a component instance MIB 3002 has access to the MIB 3000 (as defining the LDAP sub-tree CLS1,1 which corresponds to the “internal” type of the component). It defines the “instance” of the component using a “SAP name”. This is reflected both internally in the component at 3012, which is shown as an interface, and is mapped in a corresponding LDAP sub-tree “cls,instance1,1”. Other components, and management functions, may thus be aware of what component CLS1 can do.

a component assignment MIB 3004 has access to the MIB 3002 (as defining what the component can do). It defines the “assignment” of the component using a “SAP name”. This is reflected both internally in the component at 3014, which is shown as another interface, and is mapped in a corresponding LDAP sub-tree “cls,assignment1,1”. Other components, and management functions, may thus be aware of what component CLS1 actually does.

Thus, a software update may take place as shown in FIG. 24 (The MIBs are not shown, for more clarity in the drawing). New “values” (in fact complete sets of data), suffixed 2,1 have been loaded in the repositories and mapped to LDAP. The component CLS1 initially working under “1,1” is rebooted, and then works as “2,1”. (In fact, as shown, this may also occur when only a node of the cluster is rebooted). Of course, the new values “2,1” need not be entirely different from the old ones “1,1”. In certain cases, they may even remain identical (reboot without change).

FIG. 25 shows a configuration update, made in response to a configuration update event (for example a “sleeping” node should be substituted to a failing node). The situation is similar to that of FIG. 24, except that there is no reboot, and the “cls,instance 1,1” and the corresponding instance MIB (not shown) is not modified.

FIG. 26 shows again the component CLS1 of FIG. 23, with its interfaces 3012 (instance) and 3014 (assignment), now under control of management functions 3022 and 3024. Interface 3016 “exposes” the services offered by the component to other components. Interface 3018 enables the “callback”, used e.g. for connection with the platform services.

Redundancy may be managed as illustrated in FIG. 27. Two “equivalent” components CLS1A and CLS1B are shown, with the same interfaces as in FIG. 26, suffixed with “A” or “B”. LDAP data 3400 have distinct sub-trees for the instances 3012A and 3012B, however the same sub-tree for the assignments 3014A and 3014B.

A management agent 3500 accesses interfaces 3012A, 3012B and 3014A, and builds e.g. corresponding Mbeans, assuming the applicant company's JDMK is being used.

Thus, by having the management agent 3500 accessing the LDAP data, the software management may be conducted with knowledge of what the component CLS1A in service can do, and actually does, and of what the “sleeping” component CLS1B can do. The management agent 3500, e.g. via the Mbeans, controls the management interfaces 3012A, 3012B and 3014A accordingly.

While the OMSL language may form a basis for organizing named objects and configuration data, a directory system may be conveniently used to make such objects and data available at runtime. This has been shown in FIGS. 22 through 27, with the directory system being an LDAP directory server in these examples.

This may make use of a mapping from an OMSL to a directory system like LDAP (Lightweight Directory Access Protocol). Such a mapping is now considered. The language being used on the directory system side is hereinafter generically termed Directory System Software Language, or, in short, DSSL.

In this OMSL-to-DSSL mapping section of this specification, reference will be made to LDAP examples as follows:

Exhibit Eh7 shows exemplary LDAP configuration objects,

Exhibit Eh8 contains illustrative tables,

Exhibit Eh9 contains an exemplary LDAP object, i.e. a component type configuration MIB.

In the examples, the directory system is based on LDAP, and the DSSL uses the LDAP Data Interchange Format (LDIF) syntax. The LDIF format is a standard way of representing directory data in a textual format. However, the LDIF format is exemplary only, and other DSSL notations may be used as well.

The diagram Eh7-0 in Exhibit Eh7 shows an exemplary LDAP layout. A corresponding LDAP Schema may adopt the overall organization reflected in the LDAP layout being shown. In accordance with another aspect of this invention, at least some of the layout items have a “version” qualifier or entry. In the example, every layout item has a “version” qualifier or entry.

In accordance with still another aspect of this invention, at least some of the layout items have an “update level” qualifier or entry. In the example, an “update level” is defined for the cluster, types, instances and assignments.

It should also be kept in mind that the LDIF format is “reversed” with respect to the “directory-like” description of a tree structure. For example:

| | |
|---|---|
| the LDIF notation | leaf_node, nexus2, nexus1, root |
| corresponds to | |
| the directory-like notation | root\nexus1\nexus2\leaf_node |

Accordingly, when converting the exemplary LDAP layout (shown in the diagram Eh7-0 in Exhibit Eh7) into in a corresponding tree structure, the respective levels of “update level” and “version” are reversed.

In other words, applying this e.g. to the examples in the diagram Eh7-0 would result into:

mib\update level\version\<referenced object>,

where <referenced object> may be:

cluster

component type\type

sap\component instance\instance

sap\component assignment\assignment

The RDN of the referenced object will be primarily defined, using e.g. the LDAP resources as defined below.

Now, it may be desirable to include in the name of the LDAP object a “version” and/or “update level” qualifier. In accordance with a further aspect of this invention, this may be made as follows:

each MIB is fully defined by its container (cluster, component type, SAP), the version of the cluster or the component type, and its update level;

for each platform update version, there is defined a corresponding platform update table, containing the DNs of all the MIBs being defined in that platform update version;

the DN of the accurate platform update table is provided for each software load version.

Now, in order to obtain the DN of a <referenced object> (as defined above), the relevant platform update table may be used to obtain the version and update level defining the relevant MIB configuration, and to concatenate that with the RDN previously defined for the <referenced object>.

The currently available platform update table may also be searched, e.g. upon a “system event” in the platform to know the names of the current configuration entities, and then read such configurations, as desired.

In an embodiment, only one set of LDAP data (or similar directory data) is available at a given time, in accordance with the current configuration of the platform, except at the time of a platform update, where a new set of LDAP configuration data is also available (e.g. mapped from a new platform update defined in OMSL). This is accompanied with a transactional processing of LDAP data, enabling “commit” if the change from the current configuration to the new one is validated, or, else, a “rollback”. Then:

in the case of a “commit”, the LDAP data corresponding to the previous configuration may be erased, with only the LDAP data of the new configuration remaining;

conversely, in the case of a “rollback”, the LDAP data corresponding to the (would-be) new configuration may be erased, with only the LDAP data of the initial current configuration remaining.

This makes it possible to avoid encumbering the LDAP data with an historical succession of configuration data, which may render it difficult to write new LDAP data, in an LDAP tree being progressively more and more encumbered.

An example of an LDAP implementation will now be described.

LDAP object classes may be defined, e.g. as shown in the rest of Exhibit Eh7. The object classes may comprise generic object classes, and object classes related to the above defined entities of the OSML. Amongst the exemplary generic object classes:

a generic object class cgha-attribute--oc (Eh7-O1) may be provided to name sub-entries corresponding to array or map attributes or to structure type attributes. This object class contains an attribute cgha-attribute-name, which is used to define the RDN of the attribute.

a generic object class cgha-member--oc (Eh7-O2) maybe provided in order to name sub-entries corresponding to map or array members, or members of structure type. This object class contains an attribute cgha-member-name used to define the RDN of the member.

a generic object class cgha-element--oc (Eh7-O3) is provided in order to name the map and array items. This object class contains an attribute cgha-key used to define the RDN of the item.

The syntax used in mapping OMSL attributes to LDAP may be as shown in table Eh8-T1 in Exhibit Eh8: the Directory String syntax may be used for attributes that are RDNs (Relative Distinguished Names), and may be tagged as single value; the Distinguished Name syntax may be used for attributes that contain a DN; the “IA5” String syntax may be used in the remaining cases.

The other object classes will be discussed hereinafter as needed. (The syntax and “value tag” of the attributes in the LDAP object classes is shown in Exhibit Eh7, and will not be commented in the following description).

Thus, an LDAP configuration (more generally, a set of directory system configuration data) may be generated, using such generic attributes and object classes. In the example, these generic entities may be grouped into a single LDIF file, which may be used to populate the LDAP server with directory entries during the initialization of the OMSL Software Platform.

In the exemplary embodiment, the directory system is used to “read” the platform configuration, from within the platform in use. Then, what has to be represented in LDAP is the platform configuration information that is described using the OMSL (e.g. CGHA-ML). Hereinafter, an OMSL entity that contains configuration information is termed “configuration-oriented” (or, in short, “configuration”). For example, a CGHA-ML attribute (cgha:attribute element) is “Configuration-oriented” if it has its configuration attribute set to yes.

The following section describes how “configuration-oriented”. OMSL entities may be mapped to LDAP entries. Other OMSL entities may be mapped to LDAP, if desired.

Generally, each entry is composed of a set of LDAP attributes, which contains the data from the OMSL object, associated with the entry. Sub-entries may also be used, as it will be understood.

As known, LDAP entries may be specified using an LDAP schema, which may be implemented as follows:

the schema of the LDAP server is reflected in an LDAP configuration tree (by contrast with a “user” tree, which contains the user data to be “read” by the platform functions);

the LDAP configuration tree should be updated with corresponding “schema” entries before importing the corresponding configuration of the platform as “user” entries in the LDAP server.

conversely, before a class can be removed from the LDAP schema, the corresponding entries should be removed.

Now, mapping OMSL entities (e.g. types) to LDAP involves generating LDAP attributes and object classes in the LDAP schema, and therefore defining their names.

The common LDAP naming schema of attributes and object classes is a single flat naming space. Thus, when mapping OMSL type identifiers to LDAP, one or more of the following rules may be used, as done in the exemplary embodiment:

certain characters are not allowed in the names of LDAP attributes and object classes. The period character (.) may be replaced in the mapping by the dash character (-). The underscore character (_) may be mapped by removing it and by converting the next character into an uppercase character.

The version of the type is taken into account when this version is provided (LDAP does not offer explicit support for versioning).

The string --oc is added to object class names in order to differentiate them from attribute names.

Each entity has an OID, which may be generated from the name of the entity, e.g. by concatenating the name of the entity in lower case with the addition of the string -oid, as currently required by LDAP servers.

The above will be referred to as “id-mapping rules”, whether taken together or in part.

The first level of mapping refers to generic constructs, which include the OMSL types.

By providing that the LDAP fully qualified name of a type is unique, it may be used as a basis for naming LDAP entities related to this type. Thus, the LDAP naming schema may be further extended to name LDAP attributes corresponding to attributes of interfaces, or members of structures. The resulting name may be obtained by concatenating the type name and the sub-entry name and separating them e.g. by the dash character (-).

Now, a OMSL attribute may be mapped in different ways: an LDAP attribute, or an LDAP entry:

an LDAP entry may be used if the OMSL attribute is of “plural nature” (structure type, or map or array). The LDAP entry is provided with sub-entries, which are used to hold that plurality (members of the structure, or the items of the map or array). In other words, if the attribute is an array or a map, each item of the array or map is mapped to a sub-entry of the entry representing the array or map (as a whole). Thus, an object class containing only the LDAP attribute is generated. The name of this object class is based on the name of the attribute completed with the string --oc.

by contrast, where an OMSL attribute is “single-valued” (simple), it may be mapped directly to an LDAP attribute, tagged as single value. The LDAP attribute may be named as described above (id-mapping rules), along the IA5 String syntax, as shown in table Eh8-T0. In other words, at the object level in the LDAP schema, if the attribute is not an array or a map, the resulting LDAP attribute is part of the object class corresponding to the interface (or other object) containing the OMSL attribute.

Table Eh8-T11 shows an exemplary mapping of OMSL attribute types to LDAP in more detail. With reference to the row labels in Table Eh8-T11:

Row1: a “simple” attribute is mapped to an LDAP attribute.

Row2: in the case of a “simple” type attribute that is an array, an LDAP attribute is created to represent the array, together with an entity adapted to represent the items of the array. The entity may be in turn an object class, containing an attribute. Then, the array items are represented as LDAP sub-entries, instantiating the object class.

Row 3: the case of an enumeration type attribute may be treated similarly: it is mapped to an LDAP attribute, which itself is an attribute of an LDAP object class corresponding to the nature of the original enumeration.

Row 4: turning now to Structure Type Attributes, an attribute of structure type is mapped to LDAP by mapping the structure to LDAP, as described hereinafter. The configuration associated with the attribute is mapped as a sub-entry in the LDAP configuration tree. The name of the attribute is used as the RDN of the sub-entry.

Table Eh8-T12 shows how various OMSL entities (GGHA-ML in the example) may be mapped to an LDAP schema.

Consider for example the case of mapping OMSL members to LDAP Schema, as shown in table Eh8-T12, row 2. A OMSL member is defined from a cgha: member element, in the exemplary CGHA-ML. Now:

If the OMSL member is part of a structure mapped to LDAP, it is itself mapped to LDAP according to its type (for example, simple type, enumeration type, structure type).

otherwise, a simple type member is mapped directly to an LDAP attribute, named as described above and tagged as single value. Concerning the “object class” level:

if the member is not an array or a map, the resulting LDAP attribute is part of the object class corresponding to the structure containing the OMSL member.

if the member is an array or a map, each item of the array or map is mapped to a sub-entry. In this way, an object class containing only the LDAP attribute is generated. The name of this object class is based on the identifier of the attribute completed with the string --oc.

a member that is itself of structure type is mapped to LDAP by mapping the structure to LDAP. The configuration associated with the attribute is mapped as a sub-entry in the LDAP configuration tree. The name of the member is used as the RDN of the sub-entry.

After having defined the mapping the generic constructs, the MIBs will now be considered.

It is reminded that a MIB or Management Information Base is associated with a OMSL entity (SAP, component type configuration, cluster configuration, in the example), and has a corresponding container (cgha:sap, cgha:type, cgha:cluster, respectively)

Each MIB may be mapped to an LDAP tree of entries, which may contain the following:

any OMSL object (when “configuration oriented”, in the example) is mapped in this tree as an LDAP entry, which may have sub-entries.

furthermore, any OMSL object having a nested object (if “configuration oriented”) is also mapped in this tree of entries.

Mapping OMSL configuration to LDAP entries may be considered in the following order:

contents of the MIBs:Maps and Arrays, Init values, Objects, contexts;

binding between the MIBs and the OMSL/LDAP configuration space: Cluster Configuration, Component Type Configuration, Component Instance Configuration, Component Assignment Configuration, and SAPs;

overall platform update configuration: Platform Update, Software Load.

OMSL elements which are designated as a map or an array are mapped to LDAP as sub-entries of the LDAP entry corresponding to the map or array. (This mapping may be used for objects, contexts, attributes and members). The map and array items may be named using the generic object class cgha-element--oc. The sub-entries belong to the LDAP object class corresponding to the type of the element which is a map or an array. If the element is of simple type, the sub-entries belong to the object class that has been created specifically.

Simple type init values are mapped to LDAP using IA5 String syntax, applied to the string that has been used as value in the cgha:init element.

Similarly, Enumeration init values are mapped to LDAP using IA5 String syntax. The string that is stored in LDAP is the value of the enumeration value (cgha:enumvalue element) that has been selected in the cgha:init element.

Mapping OMSL Structures is now considered.

Consider first reflecting in LDAP the fact that a OMSL attribute or member is of structure type. It is mapped to an LDAP entry (which may have sub-entries, e.g. if the attribute or member is an array or a map, or if one of the members of a structure is itself a structure or is an array or a map). The generic object class cgha-structure--oc (Eh7-O4) is used. Its cgha-structure-type attribute defines the fully qualified type name of the structure. A cgha-structure-version attribute holds the structure version, if the structure has a version.

Now turning to Mapping a Structure (contents), the LDAP entry of an attribute or a member which is a structure, but which is not an array or a map, is defined by:

Its DN. The identifier of the OMSL attribute or member is used as RDN.

Its generic object classes:

cgha-attribute--oc or cgha-member--oc
cgha-structure--oc.

Its generated object classes based on the type of the structure, following the mapping defined above.

Its attributes, some of which are used to store the values associated with simple type members.

Its sub-entries, used to store the values associated with structure type members.

The case of mapping an Array or a Map of Structures will now be described. The LDAP entry corresponding to a structure type attribute or member that is an array or a map is defined by:

Its DN. The identifier of the OMSL attribute or member is used as RDN.

Its generic object classes:

cgha-attribute--oc, or cgha-member--oc
cgha-structure--oc.

Its sub-entries, used to store the values associated with the items of the array or map. Each LDAP sub-entry is defined by:

Its DN. The key of the item is used as RDN.

Its generic object classes:

cgha-element--oc
cgha-structure--oc

Its generated object classes, based on the type of the structure, following the mapping defined above,

Its attributes, used to store the values associated with simple type members.

Its sub-entries, used to store the values associated with structure type members.

Mapping Object References is now considered. A OMSL attribute or member that is an object reference is mapped to an LDAP entry, which may have sub-entries, e.g. if the attribute or member is an array or a map. The generic object class cgha-object-reference--oc contains the following four attributes (Eh7-O5):

cgha-object-reference-type, which defines the fully qualified type name of the object reference.

cgha-object-reference-version, which defines the version of the object reference.

cgha-object-reference-mib-dn, which is used to store the DN of the container of the MIB (cluster, component type or SAP), without taking into account the version and update level.

cgha-object-reference-full-name, which is used to store the full name of the referenced object, as described.

Thus, the LDAP entry of an attribute or a member which is an object reference, but which is not an array or a map, may be defined by:

Its DN. The identifier of the OMSL attribute or member is used as RDN.

Its generic object classes:

cgha-attribute--oc or cgha-member--oc
cgha-object-reference--oc.

Its generated object classes based on the type of the object reference, following the corresponding mapping, as above defined.

Its attributes.

In order to obtain the DN of the referenced object, the platform update table 28422 (FIG. 22) may be used to obtain the version and update level defining the MIB configuration, and to concatenate that with the RDN previously defined for the cgha-object-reference-full-name attribute.

Mapping an Array or a Map of Object References is now considered. The LDAP entry corresponding to an object reference type attribute or member that is an array or a map is defined by:

Its DN. The identifier of the OMSL attribute or member is used as RDN.

Its generic object classes:

cgha-attribute--oc or cgha-member--oc
cgha-object-reference--oc.

Its sub-entries used to store the values associated with the items of the array or map. Each LDAP sub-entry is defined by:

Its DN. The key of the item is used as RDN.

Its generic object classes, cgha-element--oc, cgha-object-reference--oc

Its generated object classes, based on the type of the object reference, following the mapping defined above for Object References.

Its attributes, some of which may be used to store the values associated with simple type members.

Mapping OMSL References is now considered. A OMSL attribute or member that is a reference and that is part of the configuration is mapped to an LDAP entry, which may have sub-entries. Sub-entries are necessary if the attribute or member is an array or a map. The generic object class cgha-reference--oc contains the following two attributes:

cgha-reference-type, which defines the fully qualified type name of the reference.

cgha-reference-dn, which is used to store the DN of the referenced component instance or assignment.

Mapping a Reference (per se) may now be described. The LDAP entry of an attribute or a member which is a reference, but which is not an array or a map, is defined by:

Its DN. The identifier of the OMSL attribute or member is used as RDN.

Its generic object classes:

-cgha-attribute--oc if it is an attribute or cgha-member--oc if it is a member

cgha-reference--oc.

Its generated object classes based on the type of the reference, following the mapping defined above for References

Its attributes.

Turning now to mapping an Array or a Map of References, the LDAP entry corresponding to a reference type attribute or member that is an array or a map is defined by:

Its DN. The identifier of the OMSL attribute or member is used as RDN.

Its generic object classes:

cgha-attribute--oc or cgha-member--oc
cgha-reference--oc.

Its sub-entries used to store the values associated with the items of the array or map. Each LDAP sub-entry is defined by:

Its DN. The key of the item is used as RDN.

Its generic object classes:

cgha-element--oc
cgha-reference--oc

Its generated object classes, based on the type of the reference, following the mapping defined above for References

Its attributes.

Mapping Objects to LDAP is now considered.

A OMSL object (specified e.g. with cgha:object) that implements an interface containing configuration attributes is called a configuration[-oriented] object. Each configuration object is mapped to an LDAP entry, with LDAP sub-entries if the implemented interface contains map or array attributes or structure type attributes. If the object contains nested objects that are also configuration objects, they are mapped as sub-entries of the entry corresponding to the enclosing object.

The generic object class cgha-object--oc (Eh7-O7) contains one attribute cgha-object-name used to define the RDN of the object in the LDAP tree.

The generic object class cgha-interface--oc (Eh7-O8) contains the following two attributes:

An attribute named cgha-interface-type that defines the fully qualified type name of the interface.

An attribute named cgha-interface-version that holds the version of the interface.

An object that implements a singleton interface and that is a configuration object, is mapped directly in the containing SAP. This means that the generated object class is added to the list of object classes provided by the LDAP entry corresponding to the SAP (as described). If the object contains nested configuration objects and if it is not a configuration object itself, the associated entry belongs only to the object class cgha-object--oc.

Mapping an Object That Is Not a Map to LDAP is now considered. The LDAP entry that corresponds to a configuration object is defined by:

Its DN. The identifier of the OMSL object is used as RDN.

Its generic object classes:

cgha-object--oc.
cgha-interface--oc.

Its generated object class(es) based on the type of the interface(s) implemented by the object. There is an object class for the interface implemented by the object and for each of the ancestors of that interface.

Its attributes.

Its sub-entries, used to store the values corresponding to:

Structure type attributes.

Nested objects or contexts.

The generic attributes cgha-interface-type and cgha-interface-version are initialized to define the fully qualified type name and version of the interface that is implemented by the object. The LDAP attribute resulting from mapping the category attribute is initialized based on the value provided in the configuration.

Mapping a Map of Objects to LDAP is now considered. The LDAP entry that corresponds to a map of configuration objects is defined by:

Its DN. The identifier of the OMSL object may be used as RDN.

Its generic object classes: cgha-object--oc and cgha-interface--oc.

Its sub-entries, used to store the values corresponding to each item of the map. Each LDAP sub-entry is defined by:

Its DN. The key of the map item is used as RDN.

Its generic object classes cgha-element-oc and cgha-interface-oc.

Its generated object class(es) based on the type of the interface(s) implemented by the object.

Its attributes.

Its sub-entries (if any).

Mapping OMSL Contexts to LDAP is now considered.

A OMSL context (specified using the cgha:context element) that contains nested configuration objects is mapped to an LDAP entry. The nested configuration objects are mapped as sub-entries of the entry corresponding to the context. If the context corresponds to a map, the items of the map are mapped to sub-entries of the entry corresponding to the context.

The generic object class cgha-context--oc (Eh7-O9) contains one attribute, cgha-context-name, which is used to define the RDN of the entry in the LDAP tree.

Mapping a Context That Is Not a Map to LDAP is now considered. The LDAP entry that is associated with a context that is not a map is defined by:

Its DN.

A generic object class cgha-context--oc.

Its sub-entries, which are used to map nested objects or contexts.

Mapping a Context That Is a Map to LDAP is now considered. The LDAP entry that is associated with a context that is not a map is defined by:

Its DN.

the generic object class cgha-context--oc.

Its sub-entries, which are used to map the items of the map, and nested objects or contexts. Each LDAP sub-entry is defined by:

Its DN. The key of the map item is used as RDN.

Its generic object class cgha-context--oc

Its sub-entries.

Mapping OMSL Cluster Configuration to LDAP is now considered.

The cluster configuration may be mapped as sub-entries of the LDAP entry ou=cluster, o=cgha_root. The cluster configuration may be mapped taking into account its version and its update level. The cluster configuration MIB is mapped as sub-entries of the resulting entry. The first sub-entry corresponds to the version of the cluster configuration. Its update level is nested inside the version sub-entry. The MIB (hierarchical tree of objects associated with the MIB) is nested within the update level sub-entry.

The version is mapped to an LDAP entry that belongs to the generic object class cgha-cluster-version--oc. This object class (Eh7-O10) contains one attribute cgha-cluster-version used to define the version of the configuration.

The update level is mapped to an LDAP entry that belongs to the generic object class cgha-cluster-update-level--oc. This object class (Eh7-O11) contains one attribute cgha-cluster-update-level used to define the update level of the configuration.

Mapping OMSL Component Type Configuration to LDAP is now considered. Component type configuration is mapped as sub-entries of the LDAP entry ou=types,o=cgha_root.

Component type configuration is mapped taking into account the fully qualified type name of the component, its version and its update level. The component type configuration MIB is mapped as sub-entries of the resulting entry.

The fully qualified type name is mapped to an LDAP entry that belongs to the generic object class cgha-component-type--oc. This object class (Eh7-O12) contains one attribute cgha-component-type used to define the fully qualified type name of the component.

The version is mapped to an LDAP entry that belongs to the generic object class cgha-component-type-version--oc. This object class (Eh7-O13) contains one attribute cgha-component-type-version used to define the version of the component.

The update level is mapped to an LDAP entry that belongs to the generic object class cgha-component-type-update-level--oc. This object class (Eh7-O14) contains one attribute cgha-component-type-update-level used to define the update level of the configuration.

Mapping OMSL Component Instance Configuration to LDAP is now considered.

Component instance configuration is mapped as sub-trees of the LDAP entry ou=instances, o=cgha_root. Component instance configuration is mapped taking into account its identifier, the identifier of the SAP containing the configuration, the component type version and the update level of the instance configuration. The MIBs corresponding to the component instance configuration are mapped as sub-entries of the resulting entry.

The component instance identifier is mapped to an LDAP entry that belongs to the generic object class cgha-component-instance-name--oc. This object class (Eh7-O15) contains two attributes:

cgha-component-instance-name used to define the identifier of the instance.

cgha-component-type used to define the fully qualified type name of the instance.

The component instance update level is mapped to an LDAP entry that belongs to the generic object class cgha-component-instance-update-level--oc. This object class (Eh7-O16) contains one attribute cgha-component-instance-update-level used to define the update level of the configuration.

Mapping OMSL Component Assignment Configuration is now considered.

Component assignment configuration is mapped as sub-trees of the LDAP entry ou=assignments, o=cgha_root. Component assignment configuration is mapped taking into account its identifier, the identifier of the SAP containing the configuration, the component type version and the update level of the assignment configuration. The component assignment

configuration MIBs are mapped as sub-entries of the resulting entry. The identifier is mapped to an LDAP entry that belongs to a generic object class cgha-component-assignment-name--oc. This object class (Eh7-O17) contains two attributes:

cgha-component-assignment-name used to define the name of the assignment.

cgha-component-type used to define the component type of the assignment.

The component assignment update level is mapped to an LDAP entry that belongs to a generic object class cgha-component-assignment-update-level--oc. This object class (Eh7-O18) contains one attribute cgha-component-assignment-update-level used to define the update level of the configuration.

Mapping OMSL SAPs to LDAP is now considered. SAPs are defined using the cgha: sap element (as specified above). SAPs are mapped to LDAP as sub-entries of the entry corresponding to the component instance (as described above) or component assignment (as described above) that contains the SAP.

The name is mapped to an LDAP entry that belongs to the generic object class cgha-sap-name--oc. This object class (Eh7-O19) contains two attributes:

cgha-sap-name used to define the name of the SAP.

cgha-sap-access used to specify whether the SAP will be exposed to a supervisor authority, e.g. an OMC (Operation & Management Center).

The value management indicates that the SAP is exposed to the OMC. The value cluster indicates that the SAP is only exposed to cluster components.

Mapping the OMSL Platform Update to LDAP is now considered.

In order to provide a consistent view of the Network Element configuration, it is desirable to generate the list of update levels associated with all the MIBs defined in the platform update (specified using the cgha:platformUpdate element). This list is implemented in LDAP as a sub-entry of the LDAP entry ou=platform_updates, o=cgha_root. The list is implemented taking into account the version of the platform update: the version is mapped as the first sub-entry of ou=platform_updates, o=cgha_root, and the list of update levels is nested inside the sub-entry corresponding to the version. One entry in the list of update levels is generated per MIB.

The version is mapped to an LDAP entry that belongs to a generic object class cgha-platform-update-version-oc. This object class (Eh7-O20) contains one attribute cgha-platform-update-version used to define the version of the platform update.

The list of MIB update levels is implemented in LDAP as a set of entries belonging to a generic object class cgha-update-level--oc. This object class (Eh7-O21) contains three attributes:

the attribute cgha-component-update-level, which is used to define the RDN of the element in the list. Its value is the DN of the MIB including the associated version.

the attribute cgha-component-update-level-dn, which is used to define the DN of the MIB, including its update level.

the attribute cgha-updated, which is used to define if the MIB has been updated in the platform update. This attribute is set to 1 if the MIB has been updated and to 0, otherwise.

Mapping the OMSL Software Load to LDAP is now considered.

The software load version provides the means to access the correct version of the platform update table. This is implemented in LDAP as a sub-entries of the LDAP entry ou=software_loads, o=cgha_root, taking into account the version of the software load.

The version is mapped to an LDAP entry that belongs to a generic object class cgha-software-load-version--oc. This object class (Eh7-O22) contains two attributes:

cgha-software-load-version, used to define the version of the software load.

cgha-platform-update-dn, used to define the DN of the current platform update table. This current platform update table corresponds to that defined by the <prefix>.apply.ldif file (described hereinafter).

A file used to apply the platform update may contain the entry as shown in second place, which sets the current platform update DN.

Removing LDAP Entries is now considered. LDAP entries must be removed before removing object classes and attributes from the LDAP schema. The following syntax is used to remove LDAP entries:

dn: dnValue

changetype: delete

where dn: dnValue corresponds to the DN of the entry to be removed.

The Generated Files are now considered, with reference to FIG. 22. The tool (named e.g. ml2 config) may be used to map naming and configuration data to LDAP, relying on the above described mapping scheme.

The resulting LDAP information is organized into a set of files. Before initialization, these files are uploaded onto the cluster by the software load tools. The files can then be used by the OMSL Software Platform to populate the LDAP server running on each cluster during initialization.

Each file defining a platform update (using the cgha:platformUpdate element) is mapped to a plurality of files, defined below, where <prefix> is the concatenation of the identifier and the version of the platform update, separated by a period character (.). Note that <prefix> is shown as “platformUpdate.version” in FIG. 22. The files may be:

<prefix>.populate.ldif. This file contains:

The attributes and the object classes, resulting from mapping the new OMSL types provided in the platform update.

The entries, resulting from mapping the configuration provided in the platform update.

The MIB update levels table.

<prefix>.apply.ldif. This file defines the current platform update version, corresponding to the current software load. This is done by defining the current platform update table DN in the software load entries.

<prefix>.remove.ldif. This file is used to remove from the LDAP server all the information that does not belong to the current platform update.

<prefix>.rollback.ldif. This file is used to roll back the LDAP server to its state before applying the <prefix>.apply.ldif file.

<prefix>.cleanup.ldif. This file is used to remove from the LDAP server all the entries that have been added by applying the <prefix>.populate.ldif file.

<prefix>.next.xml. This file gives a brief description of the platform in order to be able to perform the next platform update.

The LDIF files can then be loaded onto the LDAP server, depending on the platform update strategy, as described below.

The OMSL Software Platform is updated in a controlled manner in order to apply a new platform update defining a software load and a configuration update to the platform.

First of all, the LDAP server is populated using the <prefix>.populate.ldif described above. The LDAP server can be populated in advance. The <prefix>.apply.ldif file provides the DN of the current platform update table, and hence the platform takes into account the new configuration update and software load. One of two possible scenarios then occurs:

The platform update is successful: the platform and all its components continue to run correctly. In this case, the OMC (Operation & Management Center) gives the instruction to commit. All the information that does not belong to the current platform update must then be removed from the LDAP server, using the <prefix>.remove.ldif file.

The platform update is unsuccessful: one or more components fail to run correctly and the OMC gives the instruction to rollback. In this case, the <prefix>.rollback.ldif file must be used to return the LDAP server to its previous state. This file provides the DN of the previous platform update table, thus enabling the platform to run using the previous configuration load and software load. Finally, in case of rollback, it is necessary to clean up the LDAP server, using <prefix>.cleanup.ldif. This removes all the entries that were added during population of the LDAP server.

In both cases, the platform returns to a stable state after the update process. In the second case, when the OMC gives the instruction to rollback, the new state of the platform is exactly equivalent to the previous one.

Basically, the OMSL-to-LDAP mapping may be applied to the MIBs. By way of example, Exhibit Eh9 shows a mapping of a component type configuration MIB.

The OMSL code (here, CGHA-ML) for the MIB is shown at Eh9-A. The MIB defines an object named component Descriptor, corresponding to version 1 of a boot server. Assuming this is update level 1 of the configuration, the corresponding LDAP (“user”) entry may be as shown at Eh9-B. The relative Distinguished Name or RDN is cgha-object-name=componentDescriptor.

It will be understood that other OMSL entities of the MIBs may be mapped to LDAP, on the basis of the above described mapping schemes. In the exemplary embodiment, only the “configuration oriented” OMSL entities are mapped to LDAP. However, other OMSL entities may be mapped to LDAP as well.

Also, there has been proposed an OMSL language (being both Operational and Modeling), and a mapping to a directory system language (or DSSL) to represent the current condition of the platform (“current load”), and, if desired, a possible new condition (“software load”).

Accordingly, this aspect of this invention allows one or more of the following:

upgrade modification of the schema defining the configuration state of the platform;

downgrade modification of the schema defining the configuration state;

upgrade modification of the configuration state of the platform;

downgrade modification of the configuration state;

commit of the configuration modification;

rollback of the configuration modification;

uniform access to the configuration.

This invention also encompasses a platform, at runtime, having the above described LDAP data, however not the OSML data from which such LDAP data have been mapped. It will also be appreciated that this includes the possibility that the DSSL be directly used as an Operational and Modeling Language, at least in part, e.g. for the configuration oriented information, as described.

This invention is of interest in the case of a redundant platform, as it has appeared from the above description. However, this should not be seen as a necessary feature, and the invention may also apply to a non redundant platform as well.

More generally, this invention covers a platform and/or its parts, whether considered at the level of design, or at runtime. It further covers various corresponding methods, as they may be extracted from the above description.

Thus, there is proposed a method of preparing loadable software for a platform, the method comprising the steps of:

a. preparing first data (e.g. at the model level of items 2010 and 2020 in FIG. 9) defining a given software to be loaded,

b. generating second data from said first data, said second data comprising identifiers of software elements to be loaded (e.g. item 2030 in FIG. 9), and

c. generating third data from said second data, and from a definition of the platform on which the third software load data is to be loaded (e.g. items 1570, 2400 and/or 2500 in FIG. 10).

There is also proposed an apparatus for aiding software load in a platform, said apparatus comprising:

a package repository,

a model repository, and

software load aiding code, interacting with the package repository and the model repository,

said software load aiding code being capable of converting an expression of a software load in a model language into a combination of code and configuration data being valid for execution in the platform.

The above method and apparatus are subject, optionally, to all the refinements described herein.

Independently, the features of a platform in operation are encompassed, as well as the methods involved in its operation. This includes, but is not limited to, the directory server and/or LDAP aspects.

This invention also covers the software code as used in this invention, especially when made available on any appropriate computer-readable medium. The expression “computer-readable medium” includes a storage medium such as magnetic or optic, as well as a transmission medium such as a digital or analog signal.

The software code basically includes, separately or together, the codes as used when writing the OSML and/or LDAP files (or equivalent), and/or accompanying executable code or macros (or equivalent), e.g. in LDAP, as well as precursors and/or generators of such codes, and as the resulting code, as applicable e.g. in a platform and/or directory server. The invention also encompasses the combinations of such codes with language dependent and/or hardware dependent code and/or data. The invention also encompasses an operating system, comprising part or all of such code.

Exhibit Eh1—Exemplary Document Type Definition (DTD)

The DTD is as shown in the right column of the following table. The identifying labels in the left column form no part of the DTD.

| | |
|---|---|
| | <?xml version=“1.0” encoding=“us-ascii” ?> |
| | <!--CGHAML DTDident “@(#)cghaml.dtd 1.34 01/07/19 SMI”--> |
| A | <!--Generic Elements--> |
| A1 | <!ELEMENT cgha:description (#PCDATA)> |
| A2 | <!ELEMENT cgha:import |
| | (cgha:description?)> |
| | <!ATTLIST cgha:import |
| | href CDATA #REQUIRED> |
| A3 | <!ELEMENT cgha:package |
| | (cgha:description?, |
| | cgha:import*, |
| | ((cgha:interface\| |
| | cgha:structure\| |
| | cgha:enumeration\| |
| | cgha:objectReference\| |
| | cgha:reference\| |
| | cgha:exception\| |
| | cgha:event)*\| |
| | cgha:component))> |
| | <!ATTLIST cgha:package |
| | name CDATA #REQUIRED> |
| B | <!--Interface Model--> |
| B1 | <!ELEMENT cgha:interface |
| | (cgha:description?, |
| | cgha:inherit?, |
| | cgha:constant*, |
| | (cgha:attribute\| |
| | cgha:operation)*, |
| | cgha:publish*)> |
| | <!ATTLIST cgha:interface |
| | type CDATA #REQUIRED |
| | version CDATA #REQUIRED |
| | leaf (yes\|no) ′no′ |
| | native (yes\|no) ′no′ |
| | singleton (yes\|no) ′no′> |
| B2 | <!ELEMENT cgha:inherit |
| | (cgha:description?)> |
| | <!ATTLIST cgha:inherit |
| | type CDATA #REQUIRED |
| | version CDATA #REQUIRED> |
| B3 | <!ELEMENT cgha:constant |
| | (cgha:description?)> |
| | <!ATTLIST cgha:constant |
| | name CDATA #REQUIRED |
| | type CDATA #REQUIRED |
| | value CDATA #REQUIRED> |
| B4 | <!ELEMENT cgha:attribute |
| | (cgha:description?, |
| | cgha:init*)> |
| | <!ATTLIST cgha:attribute |
| | name CDATA #REQUIRED |
| | type CDATA #REQUIRED |
| | version CDATA #IMPLIED |
| | array (yes\|no) ′no′ |
| | map (yes\|no) ′no′ |
| | mode (R\|RW) ′RW′ |
| | configuration (yes\|no) ′no′> |
| B5 | <!ELEMENT cgha:init |
| | (cgha:description?, |
| | cgha:init*)> |
| | <!ATTLIST cgha:init |
| | name CDATA #IMPLIED |
| | member CDATA #IMPLIED |
| | attribute CDATA #IMPLIED |
| | reference CDATA #IMPLIED |
| | key CDATA #IMPLIED |
| | value CDATA #IMPLIED |
| | final (yes\|no) ′no′> |
| B6 | <!ELEMENT cgha:operation |
| | (cgha:description?, |
| | cgha:request?, |
| | cgha:reply?, |
| | cgha:raise*)> |
| | <!ATTLIST cgha:operation |
| | name CDATA #REQUIRED |
| | mode (rpc\|oneway) ′rpc′> |
| B7 | <!ELEMENT cgha:request |
| | (cgha:description?, |
| | cgha:parameter+)> |
| B8 | <!ELEMENT cgha:reply |
| | (cgha:description?, |
| | cgha:parameter+)> |
| B9 | <!ELEMENT cgha:parameter |
| | (cgha:description?)> |
| | <!ATTLIST cgha:parameter |
| | name CDATA #REQUIRED |
| | type CDATA #REQUIRED |
| | version CDATA #IMPLIED |
| | array (yes\|no) ′no′> |
| B10 | <!ELEMENT cgha:structure |
| | (cgha:description?, |
| | cgha:member+)> |
| | <!ATTLIST cgha:structure |
| | type CDATA #REQUIRED |
| | version CDATA #IMPLIED> |
| B11 | <!ELEMENT cgha:member |
| | (cgha:description?)> |
| | <!ATTLIST cgha:member |
| | name CDATA #REQUIRED |
| | type CDATA #REQUIRED |
| | version CDATA #IMPLIED |
| | array (yes\|no) ′no′ |
| | map (yes\|no) ′no′> |
| B12 | <!ELEMENT cgha:enumeration |
| | (cgha:description?, |
| | cgha:enumValue+)> |
| | <!ATTLIST cgha:enumeration |
| | type CDATA #REQUIRED |
| | version CDATA #IMPLIED> |
| B13 | <!ELEMENT cgha:enumValue |
| | (cgha:description?)> |
| | <!ATTLIST cgha:enumValue |
| | name CDATA #REQUIRED |
| | value CDATA #IMPLIED> |
| B14 | <!ELEMENT cgha:objectReference |
| | (cgha:description?)> |
| | <!ATTLIST cgha:objectReference |
| | type CDATA #REQUIRED |
| | version CDATA #REQUIRED |
| | referencedObjectType CDATA #REQUIRED |
| | referencedObjectVersion CDATA #REQUIRED> |
| B15 | <!ELEMENT cgha:reference |
| | (cgha:description?)> |
| | <!ATTLIST cgha:reference |
| | type CDATA #REQUIRED> |
| B16 | <!ELEMENT cgha:raise |
| | (cgha:description?)> |
| | <!ATTLIST cgha:raise |
| | type CDATA #REQUIRED |
| | version CDATA #IMPLIED> |
| B17 | <!ELEMENT cgha:exception |
| | (cgha:description?, |
| | cgha:member*)> |
| | <!ATTLIST cgha:exception |
| | type CDATA #REQUIRED |
| | version CDATA #IMPLIED> |
| B18 | <!ELEMENT cgha:publish |
| | (cgha:description?)> |
| | <!ATTLIST cgha:publish |
| | type CDATA #REQUIRED |
| | version CDATA #REQUIRED> |
| B19 | <!ELEMENT cgha:event |
| | (cgha:description?, |
| | cgha:member*)> |
| | <!ATTLIST cgha:event |
| | type CDATA #REQUIRED |
| | version CDATA #REQUIRED> |
| C | <!--Component Model--> |
| C1 | <!ELEMENT cgha:component |
| | (cgha:description?, |
| | cgha:use*, |
| | cgha:type, |
| | cgha:sap*)> |
| | <!ATTLIST cgha:component |
| | type CDATA #REQUIRED |
| | version CDATA #REQUIRED> |
| C2 | <!ELEMENT cgha:use |
| | (cgha:description?)> |
| | <!ATTLIST cgha:use |
| | type CDATA #REQUIRED |
| | minVersion CDATA #REQUIRED |
| | maxVersion CDATA #REQUIRED> |
| C3 | <!ELEMENT cgha:type |
| | (cgha:description?, |
| | cgha:provide*, |
| | cgha:mib)> |
| C4 | <!ELEMENT cgha:sap |
| | (cgha:description?, |
| | cgha:provide*, |
| | cgha:mib?)> |
| | <!ATTLIST cgha:sap |
| | name CDATA #REQUIRED |
| | scope (instance\|assignment) #REQUIRED |
| | access (cluster\|management) ′management′> |
| C5 | <!ELEMENT cgha:provide |
| | (cgha:description?)> |
| | <!ATTLIST cgha:provide |
| | type CDATA #REQUIRED |
| | minVersion CDATA #REQUIRED |
| | maxVersion CDATA #REQUIRED> |
| C6 | <!ELEMENT cgha:mib |
| | (cgha:description?, |
| | (cgha:context\| |
| | cgha:object)*)> |
| C7 | <!ELEMENT cgha:context |
| | (cgha:description?, |
| | (cgha:context\| |
| | cgha:object)*)> |
| | <!ATTLIST cgha:context |
| | name CDATA #REQUIRED |
| | map (yes\|no) ′no′> |
| C8 | <!ELEMENT cgha:object |
| | (cgha:description?, |
| | (cgha:init*, |
| | (cgha:context\| |
| | cgha:object)*))> |
| | <!ATTLIST cgha:object |
| | name CDATA #IMPLIED |
| | type CDATA #REQUIRED |
| | map (yes\|no) ′no′> |
| D | <!--Software Load Model--> |
| D1 | <!ELEMENT cgha:softwareLoad |
| | (cgha:description?, |
| | cgha:import*, |
| | cgha:cluster, |
| | cgha:componentLoad*)> |
| | <!ATTLIST cgha:softwareLoad |
| | name CDATA #REQUIRED |
| | version CDATA #REQUIRED> |
| D2 | <!ELEMENT cgha:cluster |
| | (cgha:description?, |
| | cgha:provide*, |
| | cgha:mib)> |
| | <!ATTLIST cgha:cluster |
| | version CDATA #REQUIRED> |
| D3 | <!ELEMENT cgha:componentLoad |
| | (cgha:description?, |
| | cgha:init*)> |
| | <!ATTLIST cgha:componentLoad |
| | type CDATA #REQUIRED |
| | version CDATA #REQUIRED> |
| E | <!--Configuration Update Model--> |
| E1 | <!ELEMENT cgha:configurationUpdate |
| | (cgha:description?, |
| | cgha:import*, |
| | cgha:softwareLoadDefinition, |
| | cgha:clusterConfiguration?, |
| | (cgha:typeConfiguration\| |
| | cgha:instanceConfiguration\| |
| | cgha:assignmentConfiguration\| |
| | cgha:removeInstance\| |
| | cgha:removeAssignment)*)> |
| | <!ATTLIST cgha:configurationUpdate |
| | name CDATA #REQUIRED |
| | version CDATA #REQUIRED> |
| E2 | <!ELEMENT cgha:softwareLoadDefinition |
| | (cgha:description?)> |
| | <!ATTLIST cgha:softwareLoadDefinition |
| | name CDATA #REQUIRED |
| | version CDATA #REQUIRED> |
| E3 | <!ELEMENT cgha:clusterConfiguration |
| | (cgha:description?, |
| | cgha:init*)> |
| E4 | <!ELEMENT cgha:typeConfiguration |
| | (cgha:description?, |
| | cgha:init*)> |
| | <!ATTLIST cgha:typeConfiguration |
| | type CDATA #REQUIRED> |
| E5 | <!ELEMENT cgha:instanceConfiguration |
| | (cgha:description?, |
| | cgha:sapConfiguration*)> |
| | <!ATTLIST cgha:instanceConfiguration |
| | name CDATA #REQUIRED |
| | type CDATA #REQUIRED> |
| E6 | <!ELEMENT cgha:assignmentConfiguration |
| | (cgha:description?, |
| | cgha:sapConfiguration*)> |
| | <!ATTLIST cgha:assignmentConfiguration |
| | name CDATA #REQUIRED |
| | type CDATA #REQUIRED> |
| E7 | <!ELEMENT cgha:sapConfiguration |
| | (cgha:description?, |
| | cgha:init*)> |
| | <!ATTLIST cgha:sapConfiguration |
| | name CDATA #REQUIRED> |
| E8 | <!ELEMENT cgha:removeInstance |
| | (cgha:description?)> |
| | <!ATTLIST cgha:removeInstance |
| | name CDATA #REQUIRED> |
| E9 | <!ELEMENT cgha:removeAssignment |
| | (cgha:description?)> |
| | <!ATTLIST cgha:removeAssignment |
| | name CDATA #REQUIRED> |
| F | <!--Platform Update Model--> |
| F1 | <!ELEMENT cgha:platformUpdate |
| | (cgha:description?, |
| | cgha:import*, |
| | cgha:currentLoadDefinition?, |
| | cgha:softwareLoadDefinition, |
| | cgha:configurationUpdateDefinition*)> |
| | <!ATTLIST cgha:platformUpdate |
| | name CDATA #REQUIRED |
| | version CDATA #REQUIRED |
| | configuration (load\|update) ′update′> |
| F2 | <!ELEMENT cgha:currentLoadDefinition |
| | (cgha:description?)> |
| | <!ATTLIST cgha:currentLoadDefinition |
| | version CDATA #REQUIRED> |
| F3 | <!ELEMENT cgha:configurationUpdateDefinition |
| | (cgha:description?)> |
| | <!ATTLIST cgha:configurationUpdateDefinition |
| | name CDATA #REQUIRED |
| | version CDATA #REQUIRED> |
| F4 | <!ELEMENT cgha:currentLoad |
| | (cgha:import*, |
| | cgha:currentCluster, |
| | (cgha:currentType \| |
| | cgha:currentInstance \| |
| | cgha:currentAssignment)*)> |
| | <!ATTLIST cgha:currentLoad |
| | version CDATA #REQUIRED |
| | platformUpdateName CDATA #REQUIRED |
| | platformUpdateVersion CDATA #REQUIRED |
| | softwareLoadName CDATA #REQUIRED |
| | softwareLoadVersion CDATA #REQUIRED> |
| F5 | <!ELEMENT cgha:currentCluster |
| | (cgha:provide*, |
| | cgha:mib)> |
| | <!ATTLIST cgha:currentCluster |
| | version CDATA #REQUIRED |
| | updateLevel CDATA #REQUIRED> |
| F6 | <!ELEMENT cgha:currentType |
| | (cgha:init*)> |
| | <!ATTLIST cgha:currentType |
| | type CDATA #REQUIRED |
| | version CDATA #REQUIRED |
| | updateLevel CDATA #REQUIRED> |
| F7 | <!ELEMENT cgha:currentInstance |
| | (cgha:sapConfiguration*)> |
| | <!ATTLIST cgha:currentInstance |
| | name CDATA #REQUIRED |
| | type CDATA #REQUIRED |
| | updateLevel CDATA #REQUIRED> |
| F8 | <!ELEMENT cgha:currentAssignment |
| | (cgha:sapConfiguration*)> |
| | <!ATTLIST cgha:currentAssignment |
| | name CDATA #REQUIRED |
| | type CDATA #REQUIRED |
| | updateLevel CDATA #REQUIRED> |

Exhibit Eh2—Tables Describing Elements of the DTD

In each table, the upper leftmost cell repeats the label of the element being described, as it appears in the DTD of Exhibit Eh1. The upper rightmost cell repeats the name of the element in the DTD. The next rows discuss attributes, if any. One or more last rows (single column) may recite the sub-elements, if any, and may also include notes.

| A3 | cgha:package |
|---|---|
| name | Specifies the package identifier. |
| | By convention, the name of a package begins with the reversed |
| | DNS name of the organization that created or controls the package. |
| | That organization can then organize the namespace |
| | of its packages according to its own requirements. |

Sub-elements:
* An optional list of imported files, using cgha:import.
Files that can be imported are files that specify a cgha:package.
* A list of type definitions, from the above set of type definitions.

| B1 | cgha:interface |
|---|---|
| type | Specifies the identifier of the currently defined interface. |
| version | Specifies the version of the interface, a positive integer. |
| leaf | Specifies inheritance. If the leaf attribute is set to “yes”, no other interface |
| | may inherit from this one. The default value of this attribute is “no”. |
| native | Specifies whether code is generated by compilation of the currently defined |
| | interface. If the native attribute is set to “yes”, no code is generated. The |
| | default value of this attribute is “no”. This mechanism allows the smooth |
| | integration of code, developed with specific semantics, into the global model. |
| singleton | Makes it possible to associate a procedural model with each SAP. A singleton |
| | interface can only be accessed by requiring a reference to the SAP that contains |
| | an instance of it. Therefore, only one object per SAP can be an instance of a |
| | singleton interface. If the singleton attribute is set to “yes”, the interface is |
| | a singleton interface. The default value of this attribute is “no”. |

Sub-elements:
* An optional inheritance field (cgha:inherit).
* An optional list of constants (cgha:constant).
* An optional list of attributes and/or operations (cgha:attribute and/or
cgha:operation).
* An optional list of event types (cgha:publish). All the event types that might be published
by an object implementing the currently defined interface must be present in the list.

| B2 | cgha:inherit |
|---|---|
| type | Specifies the fully qualified type name of the base interface from |
| | which the currently specified interface inherits. |
| version | Specifies the version of the base interface. |

Note: An interface with the corresponding type and version
must have been previously defined.

| B3 | cgha:constant |
|---|---|
| name | Specifies the identifier of the constant. |
| type | Specifies the type of the constant. This type must be a simple type. |
| value | Specifies the value of the constant. The value must be compatible |
| | with the type of the constant. |

Sub-elements: none

| B4 | cgha:attribute |
|---|---|
| name | Specifies the identifier of the interface attribute. |
| type | Specifies the type of the interface attribute: either a simple type or one of |
| | the following types: a structure, an enumeration, a reference, an object |
| | reference. For all types which are not simple types, the type attribute |
| | specifies the fully qualified type name. |
| version | Specifies the version of the attribute type (optional). |
| array | Specifies whether the attribute is an array. If the attribute is set to “yes”, |
| | the attribute is an array. The default value of this attribute is “no”. |
| map | Specifies whether the attribute is a map. If the map attribute is set to |
| | “yes”, the attribute is a map. The default value of this attribute is “no”. |
| mode | Specifies the read/write permissions for accessing the attribute from the |
| | perspective of the interface client. The default permissions are read and |
| | write (RW). If the permissions are set to read (R) no write access is |
| | provided to the client. |
| configuration | Specifies whether the attribute is configuration information. The default |
| | value for the configuration attribute is “no”. Configuration |
| | attributes are stored in the Cluster Configuration Repository (LDAP). |
| | Configuration attributes must be initialized. The initialization is done |
| | using cgha:init elements. This initialization can be done at interface |
| | definition level, at component definition level, at software load definition |
| | level or at configuration update level. The attribute type defined by the |
| | type and version attributes must have been previously defined. |

Sub-elements:
* an optional list of initial values (cgha:init)

| B5 | cgha:init |
|---|---|
| name | Specifies the identifier of the object being initialized. This attribute must be set |
| | when initializing a specific object in the initialization of a MIB. |
| member | Specifies the member of a structure being initialized. This attribute must be set |
| | when initializing a specific member in the initialization of a structure. |
| reference | Identifies the referenced object or component. For a referenced object, the |
| | reference attribute is set to object. For a referenced component, the reference |
| | attribute is set to instance or assignment depending on the scope of the component. |
| | This information enables the value attribute to be interpreted correctly |
| | when reference and object reference type attributes are initialized. |
| attribute | Specifies which attribute is being initialized. This attribute must be set when |
| | initializing a specific attribute of an object. |
| key | Specifies the key of the item being initialized. This must be set when initializing |
| | a specific item in an array of items or in a map of items. For a map of items, its |
| | value can be any string. For an array of items, its value must be an integer value. |
| value | Specifies the value of a simple type attribute or member (leaf in the initialization |
| | tree). The value must be compatible with the type of the attribute or member. |
| final | Controls the initialization semantics |

Sub-elements: none

| B6 | cgha:operation |
|---|---|
| name | Specifies the identifier of the operation. |
| mode | Specifies the semantics of the operation. Two modes can be |
| | specified: synchronous operation, specified using rpc, and |
| | one-way operation, specified using oneway. Synchronous |
| | operation means that the caller of the operation waits for |
| | it to complete before proceeding. One-way operation means that |
| | the caller of the operation does not wait for it to complete before |
| | proceeding. The default mode is rpc. |

Sub-elements:
* An optional request description (cgha:request). When it is defined, this
element specifies the parameters sent from the caller to the callee.
* An optional reply description (cgha:reply). When it is defined, this
element specifies the parameters replied by the callee to the caller.
* An optional list of exceptions that can be raised (cgha:raise).

| B9 | cgha:parameter |
|---|---|
| name | Specifies the identifier of the parameter. |
| type | Specifies the type of the parameter: simple type, structure |
| | type or enumeration type. For structures and enumerations, |
| | the type attribute specifies the fully qualified type name |
| | of that type. |
| version | Specifies the version of the parameter type (optional) |
| array | Specifies whether the parameter is an array. If the array attribute |
| | is set to “yes”, the parameter is an array. The default value of |
| | this attribute is “no”. |

Sub-elements: none

| | |
|---|---|
| B10 | cgha:structure |
| type | Specifies the identifier of the currently defined structure. |
| version | Specifies the optional version of the structure. |

Sub-element:
* A list of members that defines the members of the structure
(cgha:member). This list cannot be empty.

| B11 | cgha:member |
|---|---|
| name | Specifies the identifier of the member. |
| type | Specifies the type of the member, which can be either a |
| | simple type or one of the following types: structure ; |
| | enumeration ; object reference ; reference for all types |
| | which are not simple types. The type attribute is |
| | the fully qualified type name of that type. |
| version | Specifies the version of the member type (optional) |
| array | Specifies whether the member is an array. If the array attribute |
| | is set to “yes”, the member is an array. The default |
| | value of this attribute is “no”. |
| map | Specifies whether a member of a structure is a map. If the map |
| | attribute is set to “yes”, the member is a map. The default |
| | value of this attribute is “no”. Note that the value of the |
| | map attribute must be set to “no” for members of |
| | exceptions and events. The type defined by the type and |
| | version attributes must have been previously defined. |

| B12 | cgha:enumeration |
|---|---|
| type | Specifies the identifier of the currently defined enumeration. |
| version | Specifies the version of the enumeration (optional). |

Sub-element: none

| B13 | cgha:enumeration |
|---|---|
| name | Specifies the identifier of the enumeration value. In the same |
| | enumeration it is not possible to have different enumeration values |
| | with the same identifier. |
| value | Specifies the value of the enumeration value. It must be different |
| | from every other value in the same enumeration. If this attribute is |
| | not defined, the value of the enumeration value is generated auto- |
| | matically. |

| B14 | cgha:objectReference |
|---|---|
| type | Specifies the identifier of the object reference. |
| version | Specifies the version of the object reference. |
| referencedObjectType | Specifies the fully qualified type name of the |
| | object pointed to by the reference. |
| referencedObjectVersion | Specifies the version of the referenced ob- |
| | ject. This attribute must be a positive integer. |

Sub-elements: none

| B15 | cgha:reference |
|---|---|
| type | Specifies the identifier of the reference. |

Sub-element: none

| B16 | cgha:raise |
|---|---|
| type | Specifies the fully qualified type name of the exception. If it is a |
| | structure or an enumeration, the type attribute is the fully qual- |
| | ified type name of that type. |
| version | Specifies the version of the exception (optional). |

Sub-elements: none

| B17 | cgha:exception |
|---|---|
| type | Specifies the identifier of the currently defined exception. |
| version | Specifies the version of the exceptional (optional). |

Sub-element:
*An optional list of members. This list defines the members of the exception (cgha:member).

| B18 | cgha:publish |
|---|---|
| type | Specifies the fully qualified type name of the event. |
| version | Specifies the version of the event. |

| B19 | cgha:event |
|---|---|
| type | Specifies the identifier of the event. |
| version | Specifies the version of the event. |

Sub-elements:
*An optional list of members (cgha:member). This list defines the members of the event.

| C1 | cgha:component |
|---|---|
| type | Specifies the identifier of the currently defined component. |
| version | Specifies the version of the component. |

Sub-elements:
*An optional list of interfaces used in the component, specified by means of cgha:use elements. All the interface types that are used by the component must be included in this list.
*The component type configuration, defined using the cgha:type element.
*An optional list of SAP definitions.

| C2 | cgha:use |
|---|---|
| type | Specifies the fully qualified type name of the interface that |
| | is used by the component. This type must be an interface |
| | type. |
| minVersion | Specifies the oldest version of the interface that is used (this |
| | corresponds to the version with the lowest version number). |
| maxVersion | Specifies the most recent version of the interface that is |
| | used (this corresponds to the version with the highest ver- |
| | sion number). This attribute must be greater than or equal to |
| | the minVersion attribute. |

| C3 | cgha:type |
|---|---|
| No attribute | |

Sub-elements:
An optional list of provided interfaces. The cgha:provide element
defines the interfaces, including the versions that is used to define
the component type configuration. It is only possible to provide
interfaces without operations and with solely configuration attribu-
tes.
A MIB. The cgha:mib element defines the MIB that is associated with
the component type configuration. To be able to create objects
implementing an interface in the MIB, the interface must be declared
in the list of provided interfaces. If multiple versions of an
interface are provided, the configuration is defined by the most
recent interface (that is, the interface with the highest version
number).

| C4 | cgha:sap |
|---|---|
| name | Specifies the identifier of the SAP. |
| scope | Specifies the scope of the SAP with respect to |
| | the HA behavior of the component. The instance |
| | scope binds the SAP to the component instance |
| | life cycle. The assignment scope binds |
| | the SAP to the component assignment life cycle. |
| access | Specifies if the SAP is visible to the OMC |
| | through the Management Agent. This attribute |
| | can only take one of two values: management |
| | or cluster. If access is set to management, |
| | the SAP is visible to the OMC. If access is |
| | set to cluster, the SAP is not visible to the |
| | OMC. In both cases, the SAP is visible within |
| | the cluster. |

Sub-elements:
An optional list of provided interfaces. The cgha:provide element
defines the interface, including the versions that are provided
through the currently defined SAP.
An optional MIB. The cgha:mib element defines the MIB that is
associated with the SAP. To be able to create objects implementing
an interface in the MIB, the interface must be declared in the
list of provided interfaces. If multiple versions of an interface
are provided, the object implementing this interface must support
all these versions. However, if multiple versions of an interface
are provided, the configuration is defined by the most recent
interface (the interface with the highest version number).

| C5 | cgha:provide |
|---|---|
| type | Specifies the fully qualified type name of the |
| | interface. This type must be an interface type. |
| minVersion | Specifies the oldest version of the interface |
| | that is used (this corresponds to the version |
| | with the lowest version number). |
| maxVersion | Specifies the most recent version of the |
| | interface that is used (this corresponds to |
| | the version with the highest version number). |
| | This attribute must be greater than or equal |
| | to the minVersion attribute. |

Sub-element: None

| C6 | cgha:mib |
|---|---|
| No attribute | |

Sub-elements:
An optional list of contexts or objects (cgha:context, cgha:object).

| C7 | cgha:context |
|---|---|
| name | Specifies the identifier of the naming context. |
| map | Specifies whether or not the element defines |
| | a map of contexts. If the attribute is set |
| | to “yes”, the element defines a map of |
| | contexts. In this case, each context is |
| | identified in the map by a unique key. New |
| | instances can be created at runtime. |

Sub-element:
An optional list of contexts or objects (cgha:context, cgha:object).

| C8 | cgha:object |
|---|---|
| name | Specifies the identifier of the object. In a |
| | MIB contained in a SAP, it is possible to |
| | associate at most one unnamed object, which |
| | is an instance of a singleton interface. |
| | An unnamed object has no name attribute |
| | specified and must appear directly within |
| | the cgha:mib element, not within a contained |
| | cgha:context. Furthermore, it is not possible |
| | to have named objects that are instances of a |
| | singleton interface. In all other cases, the |
| | objects must be named. |
| type | Specifies the fully qualified type name of |
| | the interface that the object implements. |
| | This interface must be provided in the element |
| | containing the MIB. The configuration is |
| | defined by the most recent version provided, |
| | that is the version with the highest version |
| | number. |
| map | Specifies whether the element defines a map of |
| | objects. If the map attribute is set to “yes”, |
| | the element defines a map of objects. In this |
| | case, each object is identified in the map by a |
| | unique key. New instances can be created at |
| | runtime. |

Sub-elements:
An optional list of init values (cgha:init). This list, when defined,
specifies the value of the attributes of the interface implemented
by the object.
An optional list of contexts or objects (cgha:context, cgha:object).
This list, when defined, specifies the contexts and objects that are
nested within the currently defined object.

| D1 | cgha:softwareLoad |
|---|---|
| name | Specifies the identifier of the software load. |
| version | Specifies the version of the software load. |

Sub-elements:
An optional list of imported files (using the cgha:import element).
A cluster configuration definition (using the cgha:cluster element).
An optional list of component loads (cgha:componentLoad). A component
load identifies a component and supports initialization of
configuration attributes of objects contained in the component
type configuration MIB. This initialisation is used, for example,
to select the packages that are required for a specific software
load. A software load cannot contain two different versions of the
same component type.

| D2 | cgha:cluster |
|---|---|
| version | Specifies the version of the cluster |
| | configuration definition. |

Sub-elements:
An optional list of provided interfaces. The cgha:provide element
defines the interface, including the versions that are used to
defined the cluster configuration. It is only possible to have
interfaces without operations and with only configuration
attributes (configuration set to “yes”).
A MIB. The cgha:mib element defines the MIB that is associated
with the cluster configuration. To be able to create objects
implementing an interface in the MIB, the interface must be
declared in the list of provided interfaces. The version of
the interface used to instantiate objects in the MIB is the
most recent version of the interface that is provided, that
is the version with the highest version number.

| D3 | cgha:componentLoad |
|---|---|
| type | Specifies the fully qualified type name of |
| | the component. |
| version | Specifies the version of the component. |

Sub-element:
An optional list of configuration values that, when defined using
cgha:init, specify the values of the attributes of the objects
that are configured.

| E1 | cgha:configurationUpdate |
|---|---|
| name | Specifies the identifier of the configuration |
| | update. |
| version | Specifies the version of the configuration update. |

Sub-elements:
An optional list of imported files (cgha:import).
The software load definition. The cgha:softwareLoadDefinition element
identifies the software load on which the configuration is applied.
The optional cluster configuration initialization
(cgha:clusterConfiguration).
A list of component configuration information:
cgha:typeConfiguration
cgha:instanceConfiguration
cgha:assignmentConfiguration
cgha:removeInstance
cgha:removeAssignment

| E2 | cgha:softwareLoadDefinition |
|---|---|
| name | Specifies the identifier of the software load. |
| version | Specifies the version of the software load. |

| E3 | cgha:clusterConfiguration |
|---|---|
| No attribute | |

Sub-element:
An optional list of configuration values that, when defined
using cgha:init, specify the values of the attributes of the
objects that are configured.

| E4 | cgha:typeConfiguration |
|---|---|
| type | Specifies the fully qualified type name of the |
| | component that is initialized. This component |
| | type must be part of the associated software load. |

Sub-element:
An optional list of configuration values that, when defined
using cgha:init, specify the values of the attributes of the
objects that are configured.

| E5 | cgha:instanceConfiguration |
|---|---|
| name | Specifies the identifier of the instance. |
| type | Specifies the fully qualified type name of the |
| | component that is initialized. This component |
| | type must be part of the associated software |
| | load. It is not necessary to specify the version |
| | of the component, because it is not possible to |
| | have multiple versions of the same component |
| | in a software load. |

Sub-elements:
An optional list of SAP configuration (using the cgha:sap-
Configuration element). In an instance configuration, it is
only possible to configure SAPs that have an instance scope

| E6 | cgha:assignmentConfiguration |
|---|---|
| name | Specifies the identifier of the assignment. |
| type | Specifies the fully qualified type name of the |
| | component that is initialized. This component |
| | type must be part of the associated software load. |

Sub-elements:
An optional list of SAP configuration (using the cgha:sap-
Configuration element).

| E7 | cgha:sapConfiguration |
|---|---|
| name | Specifies the identifier of the SAP that is initialized. |

Sub-elements:
An optional list of configuration values that, when defined
using cgha:init, specify the values of the attributes of
the objects that are configured.

| E8 | cgha:removeInstance |
|---|---|
| name | Specifies the identifier of the instance to be removed. |

Sub-element: none

| E9 | cgha:removeAssignment |
|---|---|
| name | Specifies the identifier of the assignment to be removed. |

Sub-element: none

| F1 | cgha:platformUpdate |
|---|---|
| name | Specifies the identifier of the platform update. |
| version | Specifies the version of the platform update. |
| configuration | Specifies whether the platform update configuration |
| | is completely new configuration (the configuration |
| | attribute is set to load) or an update of the |
| | existing configuration (the configuration attribute |
| | is set to update). |

Sub-elements:
An optional list of imported files (cgha:import).
An optional cgha:currentLoadDefinition element, which identifies
the current load that is part of the platform update.
An optional cgha:softwareLoadDefinition element, which identifies
the software load that is part of the Platform Update.
An optional list of cgha:configurationUpdateDefinition elements
which identify the configuration updates that are part of the
platform update.

| F2 | cgha:currentLoadDefinition |
|---|---|
| version | Specifies the version of the current load. |

| F3 | cgha:configurationUpdateDefinition |
|---|---|
| name | Specifies the identifier of the configuration update. |
| version | Specifies the version of the configuration update. |

| F4 | cgha:currentLoad |
|---|---|
| version | Specifies the version of the current load. |
| platformUpdateName | Specifies the identifier of the current |
| | platform update. |
| platformUpdateVersion | Specifies the version of the current platform |
| | update. |
| softwareLoadName | Specifies the identifier of the current |
| | software load. |
| softwareLoadVersion | Specifies the version of the current software |
| | load. |

Sub-elements:
An optional list of imported files, using the cgha:import element.
These files contain the definition of the component types that are
used in the current load and the definition of interfaces that are
used in the cluster definition.
A specification of the version and update level of the cluster
configuration of the current load (cgha:currentCluster).
An optional list specifying the type, the version and the update
level of each component of the current load (cgha:currentType).
An optional list specifying the name, type and the update level of
each instance of the current load (cgha:currentInstance).
An optional list specifying the name, type and the update level of
each assignment of the current load (cgha:currentAssignment).

| F5 | cgha:currentCluster |
|---|---|
| version | Specifies the version of the cluster configuration |
| | definition. |
| updateLevel | Specifies the update level of the cluster |
| | configuration. |

Sub-elements:
An optional list of provided interfaces. The cgha:provide element
defines the interface, including the versions used to defined the
cluster configuration. It is only possible to have interfaces
without operations and with solely configuration attributes
(configuration set to yes).
A MIB. The cgha:mib element defines the MIB that is associated with
the cluster configuration. To be able to create objects implementing
an interface in the MIB, the interface must be declared in the list
of provided interfaces. The version of the interface used to
instantiate objects in the MIB is the most recent version of the
interface that is provided, that is the version with the highest
version number.

| F6 | cgha:currentType |
|---|---|
| type | Specifies the fully qualified type name of the |
| | component. Each component type specified must |
| | have been previously defined and imported. |
| version | Specifies the version of the component. |
| updateLevel | Specifies the update level of the component |
| | configuration. |

Sub-elements:
An optional list of cgha:init elements used to specify the intial
values of attributes.

| F7 | cgha:currentInstance |
|---|---|
| name | Specifies the identifier of the instance. |
| type | Specifies the fully qualified type name of the |
| | component type associated with the instance. |
| updateLevel | Specifies the update level of the instance |
| | configuration. |

Sub-element:
An optional list of SAP configuration (defined using the cgha:sap-
Configuration element).

| F8 | cgha:currentAssignment |
|---|---|
| name | Specifies the identifier of the assignment. |
| type | Specifies the fully qualified type name of |
| | the component type associated with the assignment. |
| updateLevel | Specifies the update level of the assignment |
| | configuration. |

Sub-elements:
An optional list of SAP configuration (defined using the cgha:sap-
Configuration element).

TABLE Eh2-1

| Identif. | ELEMENT | versionMin | versionMax |
|---|---|---|---|
| C2 | cgha:use | Requ. | Requ. |
| C5 | cgha:provide | Requ. | Requ. |

TABLE Eh2-2

| Identif. | ELEMENT | Version | UpdateLevel |
|---|---|---|---|
| B1 | cgha:interface | Required | |
| B2 | cgha:inherit | Required | |
| B4 | cgha:attribute | Optional | |
| B9 | cgha:parameter | Optional | |
| B10 | cgha:structure | Optional | |
| B11 | cgha:member | Optional | |
| B12 | cgha:enumeration | Optional | |
| B14 | cgha:objectReference | Required | |
| B16 | cgha:raise | Optional | |
| B17 | cgha:exception | Optional | |
| B18 | cgha:publish | Required | |
| B19 | cgha:event | Required | |
| C1 | cgha:component | Required | |
| D1 | cgha:softwareLoad | Required | |
| D2 | cgha:cluster | Required | |
| D3 | cgha:componentLoad | Required | |
| E1 | cgha:configurationUpdate | Required | |
| E2 | cgha:softwareLoadDefinition | Required | |
| F1 | cgha:platformUpdate | Required | Required |
| F2 | cgha:currentLoadDefinition | Required | Required |
| F3 | cgha:configurationUpdateDefinition | Required | Required |
| F4 | cgha:currentLoad | Required | Required |
| F5 | cgha:currentCluster | Required | Required |
| F6 | cgha:currentType | Required | Required |
| F7 | cgha:currentInstance | — | Required |
| F8 | cgha:currentAssignment | — | Required |

Exhibit Eh3—Description of CGHA-ML

CGHA-ML is an example of an XML-based operational modeling language.

Eh3.0—XML

Generally, the XML syntax is defined in the XML specification available from W3C at http://www.w3.org/TR. The basic markup principle of XML is as follows:

consider the character string “TITLE” (hereinafter termed an identifier),

in an corresponding XML document, what is between “<TITLE>” and “</TITLE>” is an “element”,

other data may be used to define what an element like “<TITLE>” may contain (including other nested elements, also called “sub-elements”), what attributes it may have. These other data may be separate, i.e. contained in a Document Type Definition (DTD), or have other formats, e.g. the one known as “XML schemas”.

In XML, a DTD follows the same markup principle as XML itself, however with slightly different syntax rules, and reserved words like #PCDATA. The DTD expressions are enclosed between “<!XXXXX” and “>”, where “XXXXX” is a DTD keyword, e.g. “ELEMENT”, and the rest is a name, followed with one or more other arguments or “sub-elements”. The expressions are case-sensitive. The DTD provides a formal definition of the elements with <!ELEMENT . . . >. Each ELEMENT may also have attributes, defined with the syntax <!ATTLIST . . . >). This defines the relationship among the data elements. An <!ENTITY # . . . > clause may be used to build a parameter entity for internal use in the DTD. Finally, comments are enclosed between “<!-” and “—>” markups.

Thus, the syntax of all elements of an OMSL may be defined in a DTD, a detailed example of which appears in Exhibit Eh1.

The main features of the exemplary DTD of will now be commented.

The labels added in the left column for each identifier of Exhibit Eh1 are used in this description and in the tables of Exhibit Eh2.

It will be appreciated that, in a DTD, many elements are interrelated, and may not be commented in all occurrences.

Eh3.1—Generic Constructs

The exemplary document type definition or DTD has generic constructs, used in common to all models.

Elements are characterized by an identifier. An identifier is a string of characters, which should be formed in accordance with specific rules (including naming rules). The identifiers of the DTD will now be considered in more detail.

At A1, the DTD has a cgha:description element, which may be used to provide a plain text description of the element in which it is located. Many elements in the DTD may have an optional description using cgha:description a sub-element. This will not be further commented.

An OMSL may be organized in independent documents, implemented as files in an underlying file system.

At label B5, the DTD has a cgha:init element which may be used to specify the initial values of attributes. The cgha:init element may also contain an optional list of other cgha:init elements; the list of initialization elements may be used to navigate into the contents of a “plural” entity, for example to initialize the members of a structure.

The usage of cgha:init, i.e. the initialization, may be done at multiple levels: interface definition level, component definition level, software load definition level, configuration update definition level. By default (final attribute set to “no”), it is possible to later overwrite the initialization. Setting final to yes at a given level in the sequence of processing:interface definition level/component definition level/software load definition level/configuration update definition level will prohibit later overwriting. Such a scheme builds a hierarchy of initializations. For example, a default value might be assigned to an attribute in the definition of the interface. This value might be overwritten in the definition of the component providing the interface, and this value might finally be updated in the configuration. If the final attribute is set to “yes”, the value cannot be overwritten thereafter.

An OMSL may provide defined types, which may be organized in packages, e.g. simple types and also new types. Simple types may include all or part of the usual “system” types of software entities, e.g. Boolean, Byte, Short, Int, Long, Float, Double, String, UnsignedByte, UnsignedShort, UnsignedInt, UnsignedLong.

These simple types may further be used in plural types, here:

structure (B10), having members (B11);

enumeration (B12), having values called enum Values (B13).

Interface, used to specify services and managed objects provided by a component; e.g. cgha:interface

object reference, used to define references to objects, e.g. cgha:objectReference

Reference, used to define references to component instances or assignments, e.g. cgha:reference

Exception, used to specify exceptions that can be raised during invocations of operations, e.g. cgha:exception

Event, used to specify events in the OMSL, that are published by the software (platform and applications) running on the network element, e.g. cgha: event

Component, used to specify a component that is deployed on the platform, e.g. cgha:component

Each defined type is characterized by its type identifier and by the sub-elements it contains. The type identifier is defined by the type attribute of the element, and may be formed in accordance with specific naming rules. The exemplary DTD supports a single namespace for defined types. Thus, parsers may be used to check that type identifiers are unique within a software load model, that is, that no type definition overwrites another type definition.

When it is necessary to refer to a type from within another package, a fully qualified type name may be used, e.g. in the form of a concatenation of the package identifier and the type identifier.

The types may contain nested sub-elements, e.g. as defined in the exemplary DTD, while distinguishing whether these are optional, or required.

Types of an OMSL may be defined in a package e.g. by means of the cgha:package element, which appears at A3 in the DTD. Thus, a given cgha: package is related to its own set of type definitions. In the exemplary CGHA-ML, the set comprises the following type definitions: cgha:interface, cgha:structure, cgha:objectReference, cgha:reference, cgha:enumeration, cgha:exception, cgha:event, cgha:component.

Each cgha:package may be specified as an independent file that may not contain anything other than that cgha:package element. The same package may be defined in more than one cgha:package element. The package is made up of all the types defined in all the cgha:package elements with that package name. Every type in a given package must have a different name (identifier) from every other type in the package.

Eh3.2—Interface Model

The interface model of the OMSL will now be described, with the exemplary syntax and semantics of each element which may be used in it.

The cgha: interface element (at B1 in the DTD) may be used to specify the functionality provided by a component and to define the types of the objects that are instantiated in MIBs (Management Information Bases).

An OMSL may allow interfaces to be specialized, using inheritance, in order to add functionality. The cgha: inherit element (B2) may be used to designate a base interface, if any, that the currently specified interface (then called the derived interface) inherits from. The ancestors of a derived interface are its base interface and the ancestors of that base interface. Only single inheritance is supported in the exemplary embodiment.

The cgha: constant element (B3) is used to define constants in the scope of an interface.

The cgha: attribute element (B4) defines the attributes that are part of an interface. An attribute is a field of the interface that holds data values. In the exemplary embodiment, versioning is supported at the interface definition level. It may be supported at the attribute definition level as well.

The cgha: operation element (B6) defines the operations that are part of an interface specification. Several possibilities exist:

in the example, a oneway operation should not contain a reply description. It is also possible to define a oneway operation that contains no request parameters.

it is possible to define an rpc operation that contains reply parameters without having request parameters. It is also possible to define an rpc operation that contains no request parameters and no reply parameters.

exceptions can be triggered in order to provide out-of-band error support.

The cgha: request element (B7) defines the request part of an operation. It may contain a list of one or more parameters (cgha:parameter; B9). This list, when defined, specifies the parameters associated with the request.

The cgha:reply element (B8) defines the reply part of an operation. It contains a list of one or more parameters (cgha:parameter; B9), which specifies the parameters associated with the reply.

The cgha:structure element (B10) is used to define structures. The cgha:member element (B11) may be used to specify the members of structures, events and exceptions.

The cgha:enumeration element (B12) is used to specify an enumeration type. It may contain a list of enumeration values, which specifies the possible values of the enumeration. Each member of the list may be specified using the cgha:enumValue element (B13). In the example, the values associated with an enumeration are of type Int.

The cgha:objectReference element (B14) is used to define references to objects. In the example:

the data related to a cgha:objectReference element may be initialized by means of the cgha:init element, with the reference attribute of the cgha:init element being set to object.

an object reference may be used as a type of a configuration attribute, only when configuration is set to “yes”. Thus, the cgha:object Reference element only supports references to objects that are in the same MIB as that containing the cgha:object Reference element itself.

The cgha: reference element (B15) is used to define simple references to component instances or assignments. (In the examples, the references are dot-separated names; however, LDAP-like references may be used as well.

In the example:

data related to a cgha:reference element may be initialized using the cgha:init element.

if the referenced component is an instance, the reference attribute of the cgha:init element may be set to instance.

if the referenced component is an assignment, the reference attribute of the cgha:init element is set to assignment.

a reference may be used as a type of a configuration attribute only when configuration is set to “yes”.

For both the objectReference and the reference, dot-separated names are used in the example; however, other notations may be used as well, e.g. LDAP-like references.

The cgha:raise element (B16) should be used to specify the exceptions that might be raised during the invocation of an operation. The cgha: exception element (B17) is used to define an exception that can be generated during the invocation of an operation.

The cgha: publish element (B18) is used to specify the events that might be published by objects implementing the currently defined interface.

The cgha: event element (B19) may be used to specify the events that are handled by the network element software using the event mechanism of the underlying Software Platform. For members of events, the value of the map attribute should be set to “no”.

Eh3.3—Component Model

The Component model of the OMSL will now be described, with the exemplary syntax and semantics of each element which may be used in it.

The cgha: component element (C1 in the DTD) may be used to define a component type. This definition may include the interfaces that are provided or used by the component, the events that are published by the component and the MIBs of the component.

The component type configuration is initialized to the proper values and partially finalized in order to avoid later overwriting. In the example, up to four SAPs (Service Access Points) may be defined in the component:

an instancemanagement SAP providing access to component instance management.

an assignmentManagement SAP providing access to component assignment management.

a log SAP providing log services.

a control SAP providing control of the log manager.

The cgha:use element (C2) may be used to declare the versions of an interface that are used by a component. The cgha:type element (C3) may be used to define a component type configuration. The cgha:sap element (C4) may be used to define a service access point (SAP) in a component. The cgha:provide element (C5) may be used to declare the versions of an interface that are provided through a SAP.

The cgha:mib element (C6) defines a hierarchical naming tree describing the containment hierarchy of objects. It consists of a number of objects associated with the leaves and nexus of the naming tree. The cgha:mib element is used to define the MIB associated with its container. In the example, the cgha:mib element should always be contained within one of the following elements: cgha: sap, cgha: type, cgha: cluster

In the example, the name space provided by the MIB is local to its container (a SAP if the MIB is associated with a SAP, a component type if the MIB is associated with a component type, a cluster if the MIB is associated with the cluster). This means that the MIB itself does not need to be identified, and therefore does not have a name attribute. Each object is uniquely defined in a MIB by its full name, which describes the location of the object in the name space of the MIB. In other words, the MIB may provide the root of the naming context.

The cgha:context element (C7) is used to define a new naming context in the MIB. The period character (.) may be used as the separator to concatenate names of the naming context tree into a single full name inside a MIB. In a given naming context, two different items (context or object) should not have the same identifier.

The cgha:object element (C8) is used to declare an object inside a specific naming context of a MIB. Each object instantiates an already defined interface. The period character (.) is used as the separator to concatenate the full name of the naming context and the name of the object in order to obtain the full name of the object inside the MIB.

Eh3.4—Software Load Model

The Software Load model of the OMSL will now be described, with the exemplary syntax and semantics of each element which may be used in it.

The cgha: softwareLoad element (D1) is used to specify a software load. In the exemplary embodiment, each cgha: softwareLoad element should be specified in an independent file.

The cgha:cluster element (D2) may be used to define the cluster configuration MIB.

The cgha:componentLoad element (D3) may be used to identify the components that are part of the software load. It supports initialization of configuration attributes of objects contained in the component type configuration MIB. This initialization may be used, for example, to select the OS (e.g. Solaris) packages that are required for a specific software load. The parser of the OMSL should ensure the consistency between the initialization clauses and the MIB.

Eh3.5—Configuration Update Model

The cgha:configurationUpdate element (E1) is used to specify a configuration update. Each such element should be specified in an independent file.

When creating an instance or an assignment, the instance configuration or the assignment configuration should be used. The instance or assignment is referred to in the cluster configuration MIB.

The cgha:softwareLoadDefinition element (E2) may be used to specify the software load configured in the configuration update or platform update.

The cgha:clusterConfiguration element (E3) may be used to initialize configuration attributes of objects contained in the cluster configuration MIB. The parser should ensure the consistency between the initialization clauses and the MIB.

The cgha:typeConfiguration element (E4) may be used to initialize configuration attributes of objects contained in the component type configuration MIB. The parser should ensure the consistency between the initialization clauses and the MIB.

The cgha:instanceConfiguration element (E5) may be used to configure an instance of a component.

The cgha:assignmentConfiguration element (E6) may be used to configure an assignment. In an assignment configuration, it is only possible to configure SAPs that have an assignment scope.

The cgha:sapConfiguration element (E7) may be used to initialize configuration attributes in the MIB associated with the SAP. The parser should ensure the consistency between the initialization clauses and the MIB.

The cgha:removeInstance element (E8) may be used to remove an instance that has been created previously. The cgha:removeAssignment element (E9) may be used to remove an assignment that has been created previously.

Eh3.6—Platform Update Model

The cgha:platformUpdate element (F1) may be used to specify a platform update. Each such element must be specified in an independent file. The software load defined in each configuration update should be the same as that defined in the platform update.

The OMSL parser may check that all attributes with a configuration attribute set to “yes” are initialized. The granularity of the configuration update may be the MIB. This means that if a MIB is created or modified, all the configuration attributes of that MIB must be initialized in one or more cgha:configurationUpdate elements. As indicated, a MM can be created or modified, using the instanceConfiguration, assignmentConfiguration, type-Configuration or clusterConfiguration elements.

Therefore in the case of an update of an existing configuration (configuration attribute set to update), all the configuration attributes of all the MIBs that have been updated must be initialized.

In the case of a completely new configuration (configuration attribute set to load), all the configuration attributes of all the MIBs that are defined in the software load should be initialized. These MIBs are the instance MIBs, the assignment MIBs, the component type configuration MIBs, and the cluster configuration MIB.

The cgha:currentLoadDefinition element (F2) maybe used to specify the current load that is used in the platform update.

The cgha:configurationUpdateDefinition element (F3) may be used to specify the configuration update that is used in the platform update.

The elements labelled F4, F5, F6, F7, F8 are be generated by the Software Factory toolchain for its own use:

The cgha:currentLoad element (F4) may be used to specify in an independent file the current load of a Network Element:component types, component instances, component assignments, and the cluster definition.

The cgha:currentCluster element (F5) may be used to specify the version and the update level of cluster configuration.

The cgha:currentType element (F6) may be used to configure the component type configuration MIB.

The cgha:currentInstance element (F7) may be used to specify each instance of a current load. The cgha:currentInstance

The cgha:currentAssignment element (F8) maybe used to specify each assignment of a current load.

Exhibit Eh4 - Exemplary CGHA-ML code

Eh4 - 1 - attributes of the ComponentDescriptor interface
<cgha:package name=“com.sun.cgha.types”>
<cgha:interface type=“ComponentDescriptor” version=“1”>
<cgha:attribute name=“componentCategory”
type=“com.sun.cgha.types.ComponentCategory”
mode=“R” configuration=“yes” />
<cgha:attribute name=“availabilityDescriptor”
type=“com.sun.cgha.types.AvailabilityDescriptor”
mode=“R” configuration=“yes” />
<cgha:attribute name=“packagingDescriptor”
type=“com.sun.cgha.types.PackagingDescriptor”
array=“yes” mode=“R” configuration=“yes” />
</cgha:interface>
</cgha:package>
Eh4-2:
<cgha:enumeration type=“ComponentCategory”>
<cgha:enumValue name=“PROXY” value=“0” />
<cgha:enumValue name=“PROXIED” value=“1” />
<cgha:enumValue name=“STANDALONE” value=“2” />
</cgha:enumeration>
Eh4-3
<cgha:enumeration type=“RedundancyModel”>
<cgha:enumValue name=“HOT_RESTART” value=“0” />
<cgha:enumValue name=“NON_HA” value=“1” />
<cgha:enumValue name=“HA_2N” value=“2” />
<cgha:enumValue name=“HA_N_PLUS_1” value=“3” />
</cgha:enumeration>
Eh4-4
<cgha:structure type=“AvailabilityDescriptor”>
<cgha:member name=“redundancyModel”
type=“com.sun.cgha.types.RedundancyModel” />
<cgha:member name=“restartable” type=“Boolean” />
<cgha:member name=“switchOverEscalationCount” type=“Int” />
<cgha:member name=“switchOverEscalationTimeWindow” type=“Int” />
<cgha:member name=“crimRequestResponseTimeOut” type=“Int” />
</cgha:structure>
Eh4-5
<cgha:structure type=“CreationDescriptor”>
<cgha:member name=“timeOut” type=“Int” />
<cgha:member name=“binaryPath” type=“String” />
<cgha:member name=“terminationTimeOut” type=“Int” />
<cgha:member name=“userId” type=“Long” />
<cgha:member name=“groupId” type=“Long” />
</cgha:structure>
Eh4-6
<cgha:enumeration type=“PackageType”>
<cgha:enumValue name=“DOCUMENTATION” value=“0” />
<cgha:enumValue name=“DEVELOPMENT” value=“1” />
<cgha:enumValue name=“RUNTIME” value=“2” />
</cgha:enumeration>
<cgha:structure type=“PackagingDescriptor”>
<cgha:member name=“platform” type=“String” />
<cgha:member name=“os” type=“String” />
<cgha:member name=“type” type=“com.sun.cgha.types.PackageType” />
<cgha:member name=“packageNames” type=“String” array=“yes” />
</cgha:structure>
<cgha:structure type=“DeploymentDescriptor”>
<cgha:member name=“platform” type=“String” />
<cgha:member name=“os” type=“String” />
</cgha:structure>
EH4-10
<cgha:package name=“com.sun.cgha.types”
xmlns:cgha=“http://www.sun.com/CGHA”>
<cgha:import href=“/com/sun/cgha/types/ComponentDescriptor.1.xml” />
<cgha: interface type=“SoftwareComponentDescriptor” version=“1”>
<cgha:inherit type=“com.sun.cgha.types.ComponentDescriptor”
version=“1” />
<cgha:attribute name=“creationDescriptor”
type=“com.sun.cgha.types.CreationDescriptor”
mode=“R” configuration=“yes”>
<cgha:init member=“userId” value=“0” />
<cgha:init member=“groupId” value=“0” />
</cgha:attribute>
<cgha:attribute name=“deploymentDescriptor”
type=“com.sun.cgha.types.DeploymentDescriptor”
array=“yes” mode=“R” configuration=“yes” />
</cgha:interface>
</cgha:package>
Eh4-11
<cgha:package name=“com.sun.cgha.types”
xmlns:cgha=“http://www.sun.com/CGHA”>
<cgha:import href=“/com/sun/cgha/types/ComponentDescriptor.1.xml” />
<cgha:interface type=“HardwareComponentDescriptor” version=“1”>
<cgha:inherit type=“com.sun.cgha.types.ComponentDescriptor”
version=“1” />
</cgha:interface>
</cgha:package>
EH4-20
EH4-20-A
<!--Component type description-->
<cgha:import
href=“/com/sun/cgha/types/SoftwareComponentDescriptor.1.xml” />
<cgha:component type=“SoftwareComponentExample” version=“1”>
<cgha:description>
. . .
</cgha:description>
<cgha:type>
<cgha:provide type=“com.sun.cgha.types.SoftwareComponentDescriptor”
minVersion=“1” maxVersion=“1”/>
. . .
EH4-20-B
<cgha:mib>
<cgha:object name=“componentDescriptor”
type=“com.sun.cgha.types.SoftwareComponentDescriptor”>
. . . (initialization)
Eh4-20-C
<cgha:init attribute=“componentCategory”
value=“STANDALONE” final=“yes” />
. . .
EH4-20-D
<cgha:init attribute=“availabilityDescriptor” final=“yes”>
<cgha:init member=“redundancyModel” value=“HA_2N” />
<cgha:init member=“restartable” value=“FALSE” />
<cgha:init member=“switchOverEscalationCount” value=“0” />
<cgha:init member=“switchOverEscalationTimeWindow” value=“1” />
<cgha:init member=“crimRequestResponseTimeOut” value=“1” />
</cgha:init>
. . .
Eh4-20-E
<cgha:init attribute=“creationDescriptor” final=“yes”>
<cgha:init member=“timeOut” value=“1” />
<cgha:init member=“binaryPath” value=“ . . . ” />
<cgha:init member=“terminationTimeOut” value=“1” />
<cgha:init member=“userId” value=“106573” />
<cgha:init member=“groupId” value=“55” />
</cgha:init>
. . .
Eh4-20-F
<cgha:init attribute=“packagingDescriptor”>
<cgha:init key=“0”>
<cgha:init member=“platform” value=“common” />
<cgha:init member=“os” value=“common” />
<cgha:init member=“type” value=“RUNTIME” />
<cgha:init member=“packageNames”>
<cgha:init key=“0” value=“PKGCOM1” />
</cgha:init>
</cgha:init>
<cgha:init key=“1”>
<cgha:init member=“platform” value=“SPARC” />
<cgha:init member=“os” value=“Solaris” />
<cgha:init member=“type” value=“RUNTIME” />
<cgha:init member=“packageNames”>
<cgha:init key=“0” value=“PKGSOL1” />
<cgha:init key=“1” value=“PKGSOL2” />
</cgha:init>
</cgha:init>
<cgha:init key=“2”>
<cgha:init member=“platform” value=“SPARC” />
<cgha:init member=“os” value=“ChorusOS” />
<cgha:init member=“type” value=“RUNTIME” />
<cgha:init member=“packageNames”>
<cgha:init key=“0” value=“PKGCHO1” />
<cgha:init key=“1” value=“PKGCHO2” />
</cgha:init>
</cgha:init>
</cgha:init>
. . .
Eh4-21 - How to Use the instanceManagement SAP
<cgha:sap name=“instanceManagement” scope=“instance”>
<cgha:description>
This SAP gives access to the mandatory MIB that
must be associated with each component instance.
</cgha:description>
<cgha:provide type=“com.sun.cgha.types.management.Instance”
minVersion=“1” maxVersion=“1” />
<cgha:mib>
<cgha:object type=“com.sun.cgha.types.management.Instance”>
</cgha:object>
</cgha:mib>
</cgha:sap>
</cgha:component>
</cgha:package>
Eh4-30
<cgha:package name=“com.sun.cgha.types.management”
xmlns:cgha=“http://www.sun.com/CGHA”>
. . .
<cgha:enumeration type=“UsageState”>
<cgha:enumValue name=“IDLE” value=“0” />
<cgha:enumValue name=“ACTIVE” value=“1” />
<cgha:enumValue naMe=“BUSY” value=“2” />
</cgha:enumeration>
<cgha: interface type=“Assignment” version=“1” singleton=“yes”>
<cgha:attribute name=“usage”
type=“com.sun.cgha.types.management.UsageState”
mode=“R” />
</cgha:interface>
. . .
</cgha:package>
EH4-31 - How to use the assignmentManagement SAP
<!--Generic management types-->
<cgha:import href=“/com/sun/cgha/types/management/Assignment.1.xml” />
<cgha:component type=“SoftwareComponentExample” version=“1”>
. . .
<cgha:sap name=“assignmentManagement” scope=“assignment”>
<cgha:description>
This SAP provides access to the MO associated with assignments.
</cgha:description>
. . .
<cgha:provide type=“com.sun.cgha.types.management.Assignment”
minVersion=“1” maxVersion=“1” />
<cgha:mib>
<cgha:object type=“com.sun.cgha.types.Assignment”>
<cgha:description>
The usage state of a component.
</cgha:description>
</cgha:object>
</cgha:mib>
</cgha:sap>
. . .
</cgha:component>

Exhibit Eh5—Tables related to the MIBs and SAPs

TABLE Eh5-1
The Component Type Configuration MIB

| | |
|---|---|
| Mandatory | componentDescriptor |
| object name | |
| Related | com.sun.cgha.types.ComponentSoftwareDescriptor |
| object type | or |
| | com.sun.cgha.types.ComponentHardwareDescriptor |
| | Both of these types inherit from: |
| | com.sun.cgha.types.ComponentDescriptor |
| Attributes | com.sun.cgha.types.ComponentDescriptor: |
| (and type) | componentCategory (enum type). |
| | availabilityDescriptor (structure). |
| | packagingDescriptor (array of structures). |
| | com.sun.cgha.types.SoftwareComponentDescriptor: |
| | creationDescriptor (structure). |
| | deploymentDescriptor (array of structures). |
| | com.sun.cgha.types.HardwareComponent Descriptor. |
| | No specific attributes found. |

TABLE Eh5-2
The instanceManagement SAP and its MIB

| | |
|---|---|
| Mandatory | (None: singleton interface) |
| object name | |
| Related | com.sun.cgha.types.management.Instance |
| object type | |
| Attributes | (optional) |
| (and type) | |
| Corresponding | instanceManagement |
| mandatory SAP | |

TABLE Eh5-3
The assignmentManagement SAP and its MIB

| | |
|---|---|
| Mandatory object name | (None: singleton interface) |
| Related object type | com.sun.cgha.types.management.Assignment |
| Attributes (and type) | usage (enum type). |
| | This is runtime information exposed to |
| | remote clients. |
| Corresponding | assignmentManagement |
| mandatory SAP | |

TABLE Eh5-4
Attributes of the ComponentDescriptor Interface Type

| Attribute | Description |
|---|---|
| componentCategory | Provides configuration type information |
| | required by the CRIM. |
| availabilityDescriptor | Provides availability information required |
| | by the CRIM: |
| | The redundancy model of the component. |
| | The switch-over escalation count and |
| | time window. |
| | The time out for a component to respond |
| | to a CRIM request. |
| | Definition of whether the component is |
| | restartable or not. |
| packagingDescriptor | Provides packaging description required |
| | by the SLBT (via the ml2swload tool). |

Exhibit Eh6—Mapping from CGHA-ML-Exemplary Tables

TABLE Eh6-1
Mapping CGHA-ML Name Tokens to Java MBeans

| CGHA-ML | CGHA-ML | |
|---|---|---|
| Construct | Identifier | Mapping to Java MBeans |
| Package | thispackage | com.sun.thispackage |
| Type | ThisClass | ThisClass |
| Operation | thisMethod | thisMethod |
| (Generated | | ThisClass.ThisMethodReply |
| return type) | | |
| Attribute | thisAttribute | getThisAttribute |
| with read | | |
| access | | |
| Attribute | thisAttribute | setThisAttribute |
| with write | | |
| access | | |
| Constant | THIS_CONSTANT | THIS_CONSTANT |
| Enumeration | ENUM_VALUE | ENUM_VALUE |
| value | | |

TABLE EH6-2
Mapping CGHA-ML Name Tokens to RPC and C

| CGHA-ML | CGHA-ML | |
|---|---|---|
| Construct | Identifier | Mapping to RPC and C |
| Package | thispackage | (not mapped) |
| Type | ThisClass | this_class (prefix) |
| Operation | thisMethod | this_class_this_method |
| (Generated | | this_class_this_method_reply |
| return type) | | |
| Attribute | thisAttribute | this_class_get_this_attribute |
| with read | | |
| access | | |
| Attribute | thisAttribute | this_class_set_this_attribute |
| with write | | |
| access | | |
| Constant | THIS_CONSTANT | THIS_CONSTANT |
| Enumeration | ENUM_VALUE | ENUM_VALUE |
| value | | |

TABLE Eh6-3
Mapping CGHA-ML Name Tokens to LDAP

| CGHA-ML | CGHA-ML | |
|---|---|---|
| Construct | Identifier | Mapping to LDAP |
| Package | thispackage | com-sun- |
| | | thispackage |
| Type | ThisClass | com-sun-this- |
| | | package-ThisClass |
| Attribute | thisAttr | com-sun-this-package- |
| | | ThisClass-n-thisAttr (*) |

(*) n is the version number

Exhibit Eh7

Eh7-0 - LDAP layout
software load <−− software load definition

version

dn

platform update <−− platform update definition

version

table

cluster <−− cluster configuration

version

update level

mib

types

component type <−− component type configuration

version

update level

mib

...
instances

component instance <−− component instance configuration

sap

version

update level

mib

...
...
assignments

component assignment <−− component assignment configuration

sap

version

update level

mib

...
...
Eh7- O - LDAP object classes
Eh7-O1 (cgha-attribute--oc)
dn: cn=schema
changetype: modify
add: attributetypes
attributetypes: ( cgha-attribute-name-oid
NAME ‘cgha-attribute-name’
SYNTAX 1.3.6.1.4.1.1466.115.121.1.15 # Directory String
SINGLE-VALUE )
dn: cn=schema
changetype: modify
add: objectclasses
objectclasses: ( cgha-attribute--oc-oid
NAME ‘cgha-attribute--oc’
SUP top
MUST ( cgha-attribute-name ) )
Eh7-O2 (cgha-member--oc)
dn: cn=schema
changetype: modify
add: attributetypes
attributetypes: ( cgha-member-name-oid
NAME ‘cgha-member-name’
SYNTAX 1.3.6.1.4.1.1466.115.121.1.15
SINGLE-VALUE )
dn: cn=schema
changetype: modify
add: objectclasses
objectclasses: ( cgha-member--oc-oid
NAME ‘cgha-member--oc’
SUP top
MUST ( cgha-member-name ) )
Eh7-O3 (cgha-element--oc)
dn: cn=schema
changetype: modify
add: attributetypes
attributetypes: ( cgha-key-oid
NAME ‘cgha-key’
SYNTAX 1.3.6.1.4.1.1466.115.121.1.15
SINGLE-VALUE )
dn: cn=schema
changetype: modify
add: objectclasses
objectclasses: ( cgha-element--oc-oid
NAME ‘cgha-element--oc’
SUP top MUST ( cgha-key ) )
Eh7-O4 (cgha-structure--oc)
dn: cn=schema
changetype: modify
add: attributetypes
attributetypes: ( cgha-structure-type-oid
NAME ‘cgha-structure-type’
SYNTAX 1.3.6.1.4.1.1466.115.121.1.26 # IA5 String
SINGLE-VALUE)
dn: cn=schema
changetype: modify
add: attributetypes
attributetypes: ( cgha-structure-version-oid
NAME ‘cgha-structure-version’
SYNTAX 1.3.6.1.4.1.1466.115.121.1.26 # IA5 String
SINGLE-VALUE )
dn: cn=schema
changetype: modify
add: objectclasses
objectclasses: ( cgha-structure--oc-oid
NAME ‘cgha-structure--oc’
SOP top
MUST ( cgha-structure-type )
MAY ( cgha-structure-version ) )
Eh7-O5 (cgha-object-reference--oc)
dn: cn=schema
changetype: modify
add: attributetypes
attributetypes: ( cgha-object-reference-type-oid
NAME ‘cgha-object-reference-type’
SYNTAX 1.3.6.1.4.1.1466.115.121.1.26 # IA5 String
SINGLE-VALUE )
dn: cn=schema
changetype: modify
add: attributetypes
attributetypes: ( cgha-object-reference-version-oid
NAME ‘cgha-object-reference-version’
SYNTAX 1.3.6.1.4.1.1466.115.121.1.26 # IA5 String
SINGLE-VALUE )
dn: cn=schema
changetype: modify
add: attributetypes
attributetypes: ( cgha-object-reference-mib-dn-oid
NAME ‘cgha-object-reference-mib-dn’
SYNTAX 1.3.6.1.4.1.1466.115.121.1.26 # IA5 String
SINGLE-VALUE )
dn: cn=schema
changetype: modify
add: attributetypes
attributetypes: ( cgha-object-reference-full-name-oid
NAME ‘cgha-object-reference-full-name’
SYNTAX 1.3.6.1.4.1.1466.115.121.1.26 # IA5 String
SINGLE-VALUE)
dn: cn=schema
changetype: modify
add: objectclasses
objectclasses: ( cgha-object-reference--oc-oid
NAME ‘cgha-object-reference--oc’
SUP top
MUST ( cgha-object-reference-type $
cgha-cgha-object-reference-version $
cgha-cgha-object-reference-mib-dn $
cgha-cgha-object-reference-full-name ) )
Eh7-O6 (cgha-reference--oc)
dn: cn=schema
changetype: modify
add: attributetypes
attributetypes: ( cgha-reference-type-oid
NAME ‘cgha-reference-type’
SYNTAX 1.3.6.1.4.1.1466.115.121.1.26 # IA5 String
SINGLE-VALUE )
dn: cn=schema
changetype: modify
add: attributetypes
attributetypes: ( cgha-reference-dn-oid
NAME ‘cgha-reference-dn’
SYNTAX 1.3.6.1.4.1.1466.115.121.1.26 # IA5 String
SINGLE-VALUE )
dn: cn=schema
changetype: modify
add: objectclasses
objectclasses: ( cgha-reference--oc-oid
NAME ‘cgha-reference--oc’
SUP top
MUST ( cgha-reference-type $
cgha-reference-dn ) )
Eh7-O7 (cgha-object--oc)
dn: cn=schema
changetype: modify
add: attributetypes
attributetypes: ( cgha-object-name-oid
NAME ‘cgha-object-name’
SYNTAX 1.3.6.1.4.1.1466.115.121.1.15 # Directory String
SINGLE-VALUE )
dn: cn=schema
changetype: modify
add: objectclasses
objectclasses: ( cgha-object--oc-oid
NAME ‘cgha-object--oc’
SUP top
MUST ( cgha-object-name ) )
Eh7-O8 (cgha-interface--oc)
dn: cn=schema
changetype: modify
add: attributetypes
attributetypes: ( cgha-interface-type-oid
NAME ‘cgha-interface-type’
SYNTAX 1.3.6.1.4.1.1466.115.121.1.26 # IA5 String
SINGLE-VALUE )
dn: cn=schema
changetype: modify
add: attributetypes
attributetypes: ( cgha-interface-version-oid
NAME ‘cgha-interface-version’
SYNTAX 1.3.6.1.4.1.1466.115.121.1.26 # IA5 String
SINGLE-VALUE )
dn: cn=schema
changetype: modify
add: objectclasses
objectclasses: ( cgha-interface--oc-oid
NAME ‘cgha-interface--oc’
SUP top
MUST ( cgha-interface-type $ cgha-interface-version ) )
Eh7-O9 (cgha-context--oc)
dn: cn=schema
changetype: modify
add: attributetypes
attributetypes: ( cgha-context-name-oid
NAME ‘cgha-context-name’
SYNTAX 1.3.6.1.4.1.1466.115.121.1.15 # Directory String
SINGLE-VALUE )
dn: cn=schema
changetype: modify
add: objectclasses
objectclasses: ( cgha-context--oc-oid
NAME ‘cgha-context--oc’
SUP top
MUST ( cgha-context-name ) )
Eh7-O10 (cgha-cluster-version--oc)
dn: cn=schema
changetype: modify
add: attributetypes
attributetypes: ( cgha-cluster-version-oid
NAME ‘cgha-cluster-version’
SYNTAX 1.3.6.1.4.1.1466.115.121.1.15 # Directory String
SINGLE-VALUE )
dn: cn=schema
changetype: modify
add: objectclasses
objectclasses: ( cgha-cluster-version--oc-oid
NAME ‘cgha-cluster-version--oc’
SUP top
MUST ( cgha-cluster-version ) )
Eh7-O11 (cgha-cluster-update-level--oc)
dn: cn=schema
changetype: modify
add: attributetypes
attributetypes: ( cgha-cluster-update-level-oid
NAME ‘cgha-cluster-update-level’
SYNTAX 1.3.6.1.4.1.1466.115.121.1.15 # Directory String
SINGLE-VALUE )
dn: cn=schema
changetype: modify
add: objectclasses
objectclasses: ( cgha-cluster-update-level--oc-oid
NAME ‘cgha-cluster-update-level--oc’
SUP top
MUST ( cgha-cluster-update-level ) )
Eh7-O12 (cgha-component-type--oc)
dn: cn=schema
changetype: modify
add: attributetypes
attributetypes: ( cgha-component-type-oid
NAME ‘cgha-component-type’
SYNTAX 1.3.6.1.4.1.1466.115.121.1.15 # Directory String
SINGLE-VALUE )
dn: cn=schema
changetype: modify
add: objectclasses
objectclasses: ( cgha-component-type--oc-oid
NAME ‘cgha-component-type--oc’
SUP top
MUST ( cgha-component-type ) )
Eh7-O13 (component-type-version--oc)
dn: cn=schema
changetype: modify
add: attributetypes
attributetypes: ( cgha-component-type-version-oid
NAME ‘cgha-component-type-version’
SYNTAX 1.3.6.1.4.1.1466.115.121.1.15 # Directory String
SINGLE-VALUE )
dn: cn=schema
changetype: modify
add: objectclasses
objectclasses: ( cgha-component-type-version--oc-oid
NAME ‘cgha-component-type-version--oc’
SUP top
MUST ( cgha-component-type-version ) )
Eh7-O14 (cgha-component-type-update-level--oc)
dn: cn=schema
changetype: modify
add: attributetypes
attributetypes: ( cgha-component-type-update-level-oid
NAME ‘cgha-component-type-update-level’
SYNTAX 1.3.6.1.4.1.1466.115.121.1.15 # Directory String
SINGLE-VALUE )
dn: cn=schema
changetype: modify
add: objectclasses
objectclasses: ( cgha-component-type-update-level--oc-oid
NAME ‘cgha-component-type-update-level--oc’
SUP top
MUST ( cgha-component-type-update-level ) )
Eh7-O15 (cgha-component-instance-name--oc)
dn: cn=schema
changetype: modify
add: attributetypes
attributetypes: ( cgha-component-instance-name-oid
NAME ‘cgha-component-instance-name’
SYNTAX 1.3.6.1.4.1.1466.115.121.1.15 # Directory String
SINGLE-VALUE )
dn: cn=schema
changetype: modify
add: objectclasses
objectclasses: ( cgha-component-instance-name--oc-oid
NAME ‘cgha-component-instance-name--oc’
SUP top
MUST ( cgha-component-instance-name $
cgha-component-type ) )
Eh7-O16 (cgha-component-instance-update-level--oc)
dn: cn=schema
changetype: modify
add: attributetypes
attributetypes: ( cgha-component-instance-update-level-oid
NAME ‘cgha-component-instance-update-level’
SYNTAX 1.3.6.1.4.1.1466.115.121.1.15 # Directory String
SINGLE-VALUE )
dn: cn=schema
changetype: modify
add: objectclasses
objectclasses: ( cgha-component-instance-update-level--oc-oid
NAME ‘cgha-component-instance-update-level--oc’
SUP top
MUST ( cgha-component-instance-update-level ) )
Eh7-O17 (cgha-component-assignment-name--oc)
dn: cn=schema
changetype: modify
add: attributetypes
attributetypes: ( cgha-component-assignment-name-oid
NAME ‘cgha-component-assignment-name’
SYNTAX 1.3.6.1.4.1.1466.115.121.1.15 # Directory String
SINGLE-VALUE )
dn: cn=schema
changetype: modify
add: objectclasses
objectclasses: ( cgha-component-assignment-name--oc-oid
NAME ‘cgha-component-assignment-name--oc’
SUP top
MUST ( cgha-component-assignment-name $
cgha-component-type ) )
Eh7-O18 (cgha-component-assignment-update-level--oc)
dn: cn=schema
changetype: modify
add: attributetypes
attributetypes: ( cgha-component-assignment-update-level-oid
NAME ‘cgha-component-assignment-update-level’
SYNTAX 1.3.6.1.4.1.1466.115.121.1.15 # Directory String
SINGLE-VALUE )
dn: cn=schema
changetype: modify
add: objectclasses
objectclasses: ( cgha-component-assignment-update-level--oc-oid
NAME ‘cgha-component-assignment-update-level--oc’
SUP top
MUST ( cgha-component-assignment-update-level ) )
Eh7-O19 (cgha-sap-name--oc)
dn: cn=schema
changetype: modify
add: attributetypes
attributetypes: ( cgha-sap-name-oid
NAME ‘cgha-sap-name’
SYNTAX 1.3.6.1.4.1.1466.115.121.1.15 # Directory String
SINGLE-VALUE )
dn: cn=schema
changetype: modify
add: attributetypes
attributetypes: ( cgha-sap-access-oid
NAME ‘cgha-sap-access’
SYNTAX 1.3.6.1.4.1.1466.115.121.1.15 # Directory String
SINGLE-VALUE )
dn: cn=schema
changetype: modify
add: objectclasses
objectclasses: ( cgha-sap-name--oc-oid
NAME ‘cgha-sap-name--oc’
SUP top
MUST ( cgha-sap-name $
cgha-sap-access ) )
Eh7-O20 (cgha-platform-update-version--oc)
dn: cn=schema
changetype: modify
add: attributetypes
attributetypes: ( cgha-platform-update-version-oid
NAME ‘cgha-platform-update-version’
SYNTAX 1.3.6.1.4.1.1466.115.121.1.15 # Directory String
SINGLE-VALUE)
dn: cn=schema
changetype: modify
add: objectclasses
objectclasses: ( cgha-platform-update-version--oc-oid
NAME ‘cgha-platform-update-version--oc’
SUP top
MUST ( cgha-platform-update-version ) )
Eh7-O21 (cgha-update-level--oc)
dn: cn=schema
changetype: modify
add: attributetypes
attributetypes: ( cgha-update-level-oid
NAME ‘cgha-update-level’
SYNTAX 1.3.6.1.4.1.1466.115.121.1.12 # DN
SINGLE-VALUE )
dn: cn=schema
changetype: modify
add: attributetypes
attributetypes: ( cgha-updated-oid
NAME ‘cgha-updated’
SYNTAX 1.3.6.1.4.1.1466.115.121.1.26 # IA5 String
SINGLE-VALUE )
dn: cn=schema
changetype: modify
add: attributetypes
attributetypes: ( cgha-update-level-dn-oid
NAME ‘cgha-update-level-dn’
SYNTAX 1.3.6.1.4.1.1466.115.121.1.12 # DN
SINGLE-VALUE )
dn: cn=schema
changetype: modify
add: objectclasses
objectclasses: ( cgha-update-level--oc-oid
NAME ‘cgha-update-level--oc’
SUP top
MUST ( cgha-update-level
$ cgha-update-level-dn
$ cgha-updated ) )
Eh7-O22 (cgha-software-load-version--oc)
dn: cn=schema
changetype: modify
add: attributetypes
attributetypes: ( cgha-software-load-version-oid
NAME ‘cgha-software-load-version’
SYNTAX 1.3.6.1.4.1.1466.115.121.1.15
SINGLE-VALUE )
dn: cn=schema
changetype: modify
add: attributetypes
attributetypes: ( cgha-platform-update-dn-oid
NAME ‘cgha-platform-update-dn’
SYNTAX 1.3.6.1.4.1.1466.115.121.1.12 # DN
SINGLE-VALUE )
dn: cn=schema
changetype: modify
add: objectclasses
objectclasses: ( cgha-software-load-version--oc-oid
NAME ‘cgha-software-load-version--oc’
SUP top MUST ( cgha-software-load-version
$ cgha-platform-update-dn ) )

Exhibit Eh8—Tables Related to LDAP Mapping

TABLE Eh8-T0

| LDAP Syntax | LDAP Code | Definition |
|---|---|---|
| IA5 String | 1.3.6.1.4.1.1466.115.121.1.26 | values are |
| | | case sensitive |
| Directory String | 1.3.6.1.4.1.1466.115.121.1.15 | values are not |
| | | case sensitive |
| Distinguished | 1.3.6.1.4.1.1466.115.121.1.12 | values are DNs |
| Name | | |

TABLE Eh8-T11

| | OMSL Attribute types | LDAP |
|---|---|---|
| 1 | Simple | LDAP attribute |
| 2 | Simple (array) | LDAP attribute designating an object class |
| | array items | sub-entries instantiating the object class |
| 3 | Enum | LDAP attribute designating an object |
| | | class + instance(s) of that object class |
| 4 | Structure | See table Eh8-T12 |

TABLE Eh8-T12

| | OMSL | LDAP |
|---|---|---|
| 1 | cgha:interface | LDAP object class |
| | | (named along id-mapping rules) |
| | attributes | see table Eh8-T11 |
| 2 | cgha:member | |
| | simple | LDAP attribute |
| | others | see table Eh8-T11 |
| 3 | cgha:structure | LDAP object class |
| | | (named along id-mapping rules) |
| | structure members | see cgha:member |
| 4 | cgha:objectReference | LDAP object class |
| | | (named along id-mapping rules) |
| 5 | cgha:reference | LDAP object class |
| | | (named along id-mapping rules) |

Exhibit Eh9

Eh9-A
<cgha:package name=“com.sun.cgha.container.bootServer”>
<cgha:component type=“BootServer” version=“1”>
<cgha:type>
<cgha:mib>
<cgha:object name=“componentDescriptor”
type=“com.sun.cgha.types.SoftwareComponentDescriptor”>
<cgha:init .../>
...
</cgha:object>
</cgha:mib>
</cgha:type>
</cgha:component>
</cgha:package>
Eh9-B
dn: cgha-object-name=componentDescriptor,
cgha-component-type-update-level=1,
cgha-component-type-version=1,
cgha-component-type=com.sun.cgha.container.bootServer.BootServer,
ou=types, o=cgha_root

What is claimed is:

1. A computer system comprising:
a plurality of groups of data in a common software language, wherein each group of data comprises;
a first group of data modeling a plurality of components and a plurality of interactions between said plurality of components;
a second group of data modeling a software load of said plurality of components and said plurality of interactions between said plurality of components; and
a first software code interacting with said plurality of groups of data for qualifying said second subset of data as defining a valid combination of said plurality of components.

2. The computer system according to claim 1, wherein said first group of data comprises:
a first subset of data for modeling said plurality of interactions; and
a second subset of data for modeling said plurality of components.

3. The computer system according to claim 1, wherein said first group of data comprises:
a first subset of data for modeling software components; and
a second subset of data for modeling hardware components.

4. The computer system according to claim 1, wherein said first software code interacts with said plurality of groups of data utilizing a first set of predefined rules.

5. The computer system according to claim 4, wherein:
said first group of data comprising version-identifying data for said plurality of interactions and version range identifying data related to said plurality of components; and
each of said first set of predefined rules comprise the version of a particular interaction lying within said version range of a first component and a second component cooperating through said particular interaction.

6. The computer system according to claim 5, wherein said first group of data defines a plurality of direction interaction, wherein each direction interaction is between a server component providing one of said plurality of interfaces and a client component utilizing said one of said plurality of interfaces.

7. The computer system according to claim 6, wherein:
said first set of data comprises generic “provide” and “use” entities each having a version range identifying attribute, with instance of said “provide” and “use” entities attached to said server component and client component with values of said version range identifying attribute, respectively; and
said first predefined rules comprise:
initially verifying that said first group of data comprise an interaction for each version value in each instantiated version range; and
for a given pair of sever component and client component, verifying that the intersection of their respective “provide” and “use” version ranges is not nil.

8. The computer system according to claim 1:
wherein said plurality of groups for data comprise a plurality of generic entities for said plurality of components, said plurality of interactions and a software load;
wherein said entities comprise predefined numbers; and
wherein said first group of data and said second group of data utilizes such generic entities for representing said plurality of components, said plurality of interactions and said software load.

9. The computer system according to claim 1, wherein said plurality of generic entities comprise attributes and sub-entities.

10. The computer system according to claim 1, wherein said plurality of groups of data are stored in accordance with a tree structure.

11. The computer system according to claim 1, wherein said plurality of groups of data further comprises a third group of data modeling configuration values for loading a software load as defined in said second group of data.

12. The computer system according to claim 11, further comprising a second software code, wherein said second software code interacts with said third group of data for verifying that said third group of data define a set of required configuration values.

13. The computer system according to claim 12, wherein:
said plurality of groups of data comprise generic entities for interactions, with a configuration attribute having an attribute statement; and
said second software code reverts to said first group of data for determining said configuration attribute.

14. The computer system according to claim 13, wherein:
said group of data also comprises generic entities for components, software load and configuration values;
said generic entities having a configuration value attribute;
said first, second and third group of data comprise instances of said generic entities for representing said components, said software load and said configuration values; and
said second software code reverts from said third group of data through said second group of data to said first group of data, for determining whether a configuration value is present.

15. The computer system according to claim 13, wherein:
said generic entities each comprise a final configuration attribute for at least one of said components, said interactions and said software load; and
said second software code is responsive to finding an attribute value qualified as final, and nevertheless finding an attribute value downstream in the sense: interaction, component, software load, configuration value for entering an error processing mode.

16. The computer system according to claim 11, further comprising:
said plurality of groups of data further comprises:
a fourth set of data comprising platform update data for designating a configuration update having an update level; and
a thirds software code determines if a transition to said configuration update is authorized.

17. The computer system according to claim 16, wherein said third software code further determines if a rollback from said configuration update is authorized.

18. The computer system according to claim 16, wherein said plurality of groups of data further comprises a current load.

19. The computer system according to claim 18, wherein said current load is at least partially represented in the form of directory data.

20. The computer system according to claim 16, further comprising a fourth software code for implementing a new configuration value in a platform based on said plurality of groups of data.

21. The computer system according to claim 16, wherein said fourth data further comprises a new software load.

22. The computer system according to claim 21, further comprising a fifth software code, capable of building a software load image implementing said new software load based on said plurality of groups of data and on a package file.

23. The computer system according to claim 1, further comprising a sixth software code capable of indicating a state of a component from said plurality of groups of data in response to a request.

24. The computer system according to claim 23, further comprising a management service code utilizing said sixth software code.

25. The computer system according to claim 24, wherein said management service code comprises local management service code.

26. The computer system according to claim 24, wherein said management service code comprises a management agent enabling remove management.

27. The computer system according to claim 1,
wherein said plurality of groups of data is defined from generic entities and from predefined instances of said generic entities;
wherein said group of data is represented in a tree structure; and
wherein said tree structure includes a system section comprising said generic entities and said predefined instance of such generic entities.

28. The computer system according to claim 1, wherein said first group of data comprises data associated with referencing instances and component assignments.

29. The computer system according to claim 1, wherein said common software language is a markup language.

30. A method of modeling a computer system, comprising:
generating a plurality of sets of data comprising;
a first set of data for modeling a plurality of components;
a second set of data for modeling a plurality of interactions between said plurality of components;
a third set of data for modeling a plurality of software loads as a function of said first and second set of data; and
qualifying said third set of data as defining a valid combination of said plurality of components.

31. The method according to claim 30, wherein said first set of data comprises:
a first subset of data for modeling software components of said plurality of components; and
a second subset of data for modeling hardware components of said plurality of components.

32. The method according to claim 30, wherein said qualifying said third set of data is based upon a first set of predefined rules.

33. The method according to claim 32, wherein:
said first set of data comprises a version range identifying data for each of said plurality of components;
said second set of data comprises a version identifying data for each of said plurality of interactions; and
each of said first set of predefined rules comprises a version of a particular interaction lying within the version range of a first and a second one of said plurality of component cooperating through said particular interaction.

34. The method according to claim 30, wherein:
said plurality of sets of data comprises a plurality of generic entities for said plurality of components, said plurality of interactions and said plurality of software loads;
said generic entities comprise predefined numbers; and
said plurality of set of data utilize said generic entities for representing said plurality of components, said plurality of interactions and said plurality of software loads.

35. A computer-readable medium containing a plurality of instructions which when executed cause a computing device to implement a method of modeling a computer system, comprising:
generating a searchable tree data structure comprising;
a first set of data for modeling a plurality of components;
a second set of data for modeling a plurality of interactions between said plurality of components;
a third set of data for modeling a plurality of software loads as a function of said first and second set of data; and
qualifying said third set of data as defining a valid combination of said plurality of components.

36. The computer-readable medium according to claim 35, wherein generating said tree data structure further comprises a fourth set of data for modeling configuration values for loading a plurality of software as a function of said third set of data.

37. The computer-readable medium according to claim 35, further comprising:
said generating said searchable tree data structure further comprises a fourth set of data comprising platform configuration update data; and
determining if a transition to a particular update level is authorized as a function of said fourth set of data.

38. The computer-readable medium according to claim 37, further comprising determining if a rollback from said particular update level is authorized as a function of said fourth set of data.

39. The computer-readable medium according to claim 35, further comprising determining a state of a particular component as a function of said searchable tree data structure.
